(19) United States
(12) Patent Application Publication
(10) Pub. No.: US 2026/0062994 A1
(43) Pub. Date: Mar. 5, 2026

(54) MOTORIZED WINDOW TREATMENT WITH SMART HEMBAR

(71) Applicant: Lutron Technology Company LLC, Coopersburg, PA (US)

(72) Inventors: Edward J. Blair, Telford, PA (US); John H. Bull, Slatington, PA (US); Stuart W. DeJonge, Riegelsville, PA (US); Jeremy M. Fallis, Jr., Bethlehem, PA (US); Charles Fiebig, Frenchtown, NJ (US); David A. Kirby, Zionsville, PA (US); Galen Edgar Knode, Macungie, PA (US); Brent Protzman, Easton, PA (US)

(73) Assignee: Lutron Technology Company LLC, Coopersburg, PA (US)

(21) Appl. No.: 19/319,639

(22) Filed: Sep. 4, 2025

Related U.S. Application Data
(60) Provisional application No. 63/690,710, filed on Sep. 4, 2024.
(60) Provisional application No. 63/693,430, filed on Sep. 11, 2024.

(51) Int. Cl. E06B 9/68; E06B 9/42; G05D 3/12; H02J 7/35

(52) U.S. Cl. CPC E06B 9/68; E06B 9/42; G05D 3/12; E06B 2009/6827; H02J 7/35

(57) ABSTRACT

A motorized window treatment may include one or more mounting brackets and a window treatment assembly supported by the one or more mounting brackets. The window treatment assembly may include a covering material that is operable between a raised position and a lowered position. The window treatment assembly may include a bottom bar comprising an energy storage element. The motorized window treatment may include a motor drive unit comprising a motor configured to rotate to adjust the covering material between the raised position and the lowered position. The motorized window treatment may include a dock configured to be electrically coupled to the motor drive unit. The bottom bar may be configured to be positioned adjacent to the dock when the covering material is in the raised position, such that the energy storage element is configured to charge through the dock and the motor drive unit.

### CROSS-REFERENCE TO RELATED APPLICATIONS

This application claims the benefit of Provisional U.S. Patent Application No. 63/690,710, filed Sep. 4, 2024, and Provisional U.S. Patent Application No. 63/693,430, filed Sep. 11, 2024, the entire disclosures of which are hereby incorporated by reference herein in their entireties.

### BACKGROUND

A window treatment may be mounted in front of one or more windows, for example to prevent sunlight from entering a space and/or to provide privacy. Window treatments may include, for example, roller shades, roman shades, venetian blinds, or draperies. A roller shade may include a flexible shade fabric wound onto an elongated roller tube. Such a roller shade may include a weighted hembar located at a lower end of the shade fabric. The hembar may cause the shade fabric to hang in front of one or more windows over which the roller shade is mounted.

A window treatment may be mounted to a structure surrounding a window, such as a window frame. Such a window treatment may include at least one bracket, for example two brackets at opposed ends thereof. The brackets may be configured to operably support a roller tube, such that the flexible material may be raised and lowered. For example, the brackets may be configured to support respective ends of the roller tube. The brackets may be attached to a structure, such as a wall, ceiling, window frame, or other structure. Such a window treatment may be motorized.

### SUMMARY

A motorized window treatment may include one or more mounting bracket (e.g., first and second mounting brackets), which may be configured to be mounted to a structure. The motorized window treatment may include a window treatment assembly supported by the one or more mounting bracket. The window treatment assembly may include a covering material that extends from a top end to a bottom end and is operable between a raised position and a lowered position. The window treatment assembly may include a bottom bar attached to the bottom end of the covering material. The bottom bar may include an energy storage element. The motorized window treatment may include a motor drive unit comprising a motor configured to rotate to adjust the covering material between the raised position and the lowered position. The motorized window treatment may include a dock configured to be electrically coupled to the motor drive unit. The dock may be supported by the first mounting bracket. For example, the first mounting bracket may comprise the dock. The bottom bar may be configured to be positioned adjacent to the dock when the covering material is in the raised position, such that the energy storage element is configured to charge through the dock and the motor drive unit.

The motor drive unit may include a power source. The power source may be configured to charge the energy storage element through the dock. The dock may include a first pair of electrical contacts and/or the bottom bar may include a second pair of electrical contacts. The first pair of electrical contacts may be configured to be electrically connected to the second pair of electrical contacts, for example when the covering material is in the raised position. The motor drive unit may include a control circuit.

The control circuit may be configured to determine to charge the energy storage element and/or to control the motor to adjust the covering material to the raised position to locate the bottom bar adjacent to the dock when the control circuit determines to charge the energy storage element. The control circuit may be configured to determine to charge the energy storage element based on a predetermined schedule. For example, the predetermined schedule may be configured to charge the bottom bar weekly. The control circuit may be configured to determine to charge the energy storage element when a magnitude of a storage voltage of the energy storage element is less than a threshold.

The bottom bar may include a first wireless communication circuit and/or the motor drive unit may include a second wireless communication circuit. The first wireless communication circuit may be configured to send a message to the second wireless communication circuit. The message may indicate a storage voltage of the energy storage element. For example, the message may indicate that the storage voltage of the energy storage element is less than the threshold when the storage voltage of the energy storage element is less than a first threshold. The control circuit may be configured to determine to charge the energy storage element based on the indication of the storage voltage of the energy storage element.

The motorized window treatment may include a sensor. The sensor may be configured to measure a light level and/or transmit, to a control circuit, a message indicating the measured light level. The control circuit may be configured to determine to control the motor to adjust the covering material to the raised position to locate the bottom bar adjacent to the dock based on the message indicating the measured light level, for example based on the measured light level being less than a threshold light level. The control circuit may be configured to determine whether sunlight is shining on a façade on which the motorized window treatment is installed. The control circuit may be configured to determine to charge the energy storage element based on a determination that sunlight is not shining on the façade on which the motorized window treatment is installed. For example, the control circuit may be configured to determine to charge the energy storage element based on a determination that sunlight is not shining on the façade on which the motorized window treatment is installed by determining a time of day.

The motorized drive unit comprises a communication circuit. The control circuit may be configured to receive an indication of the time of day from a server via the communication circuit. The motor drive unit may include a timeclock. The control circuit may be configured to receive an indication of the time of day from the timeclock. The control circuit may be configured to receive weather information, for example from a server (e.g., internet) via the communication circuit. The control circuit may determine to charge the energy storage element based on the weather information. For example, the control circuit may be configured to determine to charge the energy storage element based on the weather information indicating that it is cloudy. The sensor (e.g., of the bottom bar) may be configured to determine the weather information.

Additionally, or alternatively, the sensor may be configured to determine solar data. The control circuit may be configured to determine to charge the energy storage element based on the solar data. For example, the solar data may include one or more of a storage voltage of the energy storage element and/or a magnitude of a photovoltaic output voltage of a solar cell. The control circuit may be configured to determine to charge the energy storage element based on the magnitude of a photovoltaic output voltage of the solar cell. The bottom bar may include a (e.g., first) communication circuit which may be configured to send messages to a (e.g., second) communication circuit in the motor drive unit. The (e.g., first) communication circuit may be configured to send and/or receive messages (e.g., solar data) to the (e.g., second) communication circuit when the storage voltage of the energy storage element is less than a threshold (e.g., voltage).

The control circuit may be configured to determine to charge the energy storage element based on a schedule. The control circuit may be configured to adjust the schedule based on one or more of the transmitted messages from and/or to the (e.g., bottom bar) communication circuit. One or more of the messages may comprise an indication of at least one of a storage voltage of the energy storage element or a light level associated with the bottom bar. The control circuit may be configured to adjust the schedule based on one or more of the transmitted messages based on the indication of the at least one of a storage voltage of the energy storage element or a light level associated with the bottom bar and based on at least one of a threshold storage voltage or a threshold light level.

The motor drive unit may include a memory in communication with the control circuit. The control circuit may be configured to store the indication of the at least one of a storage voltage of the energy storage element or a light level associated with the bottom bar along with a time stamp associated with a time at which the indication of the at least one of solar data or the light level associated with the bottom bar. The control circuit may be configured to determine a position of the covering material associated with the time stamp, and/or to store the position associated with the time stamp in the memory.

The control circuit (e.g., of the bottom bar) may be configured to determine the time stamp associated with the time at which the indication of the at least one of the solar data or the light level associated with the bottom bar is collected, and/or to store the time stamp and the indication of the least one of the solar data or the light level in a memory (e.g., of the bottom bar).

A sensor may be configured to detect an occupancy condition or a vacancy condition in the space. A communication circuit may be configured to transmit and/or receive an indication of the occupancy condition or the vacancy condition. The control circuit may be configured to determine to charge the energy storage element based on the indication of the occupancy condition or the vacancy condition, for example on the vacancy condition.

The motor drive unit may include a (e.g., second) energy storage element. The (e.g., second) energy storage element may charge the (e.g., first) energy storage element using energy stored in the (e.g., second) energy storage element. The control circuit may determine to use the energy stored in the (e.g., second) energy storage element to charge the (e.g., first) energy storage element, for example when a magnitude of the energy stored in the second energy storage element is greater than a magnitude of energy stored in the first energy storage element. Additionally, or alternatively, the control circuit may be configured to charge the energy storage element using a power source. For example, the power source may comprise an alternating current power source or a direct current power source.

A bottom bar (e.g., of the motorized window treatment) may comprise a first end and a second end. The motorized window treatment may include a sensor, for example comprised in the bottom bar. The sensor (e.g., of the motorized window treatment) may be configured to determine whether a (e.g., first) position of the first end exceeds a threshold distance from a (e.g., second) position of the second end. The motor drive unit (e.g., control circuit) may be configured to adjust the covering material based on the determination of whether the (e.g., first) position of the first end exceeds the threshold distance from the (e.g., second) position of the second end. The sensor may include one or more of an accelerometer or a gyroscope.

The motor drive unit (e.g., control circuit) may be configured to adjust the covering material when the (e.g., first) position of the first end exceeds the threshold distance from the (e.g., second) position of the second end such that, after adjusting the covering material, the (e.g., first) position of the first end does not exceed the threshold distance from the (e.g., second) position of the second end. The bottom bar may include a communication circuit in communication with the sensor. The motor drive unit may include a communication circuit. The communication circuit of the bottom bar may be configured to transmit a message, to the communication circuit of the motor drive unit. The message may include an indication of the (e.g., first) position of the first end and/or of the (e.g., second) position of the second end.

The motorized window treatment may include a communication circuit and a sensor. The sensor may be configured to determine a light level. For example, the sensor may comprise a photosensor. The communication circuit may be configured to transmit a message to a system controller. The message may include an indication of the determined light level. The light level may include a first light level. The communication circuit may be configured to receive, from the system controller, an indication of a second light level associated with a space in which the motorized window treatment is installed. The communication circuit may be configured to transmit the message to the system controller based on the first light level exceeding a threshold value different than the second light level.

The motor drive unit (e.g., control circuit) may be configured to adjust a position of the covering material based on at least one of the first light level or the second light level. The sensor may be configured to determine a color temperature. The communication circuit may be configured to transmit a message, to the system controller, comprising an indication of the determined (e.g., first) color temperature. The communication circuit may be configured to receive, from the system controller, an indication of a second color temperature associated with a space in which the motorized window treatment is installed. The communication circuit may be configured to transmit the message to the system controller based on the first color temperature exceeding a threshold value different than the second color temperature.

Finally, although the Summary is drafted from the perspective of an apparatus, such as a motorized treatment (e.g., a motorized window treatment) and/or a system controller, the concepts described herein may be captured as a method that is performed by one or more apparatuses and/or as one or more computer-readable storage medium that are located on one or more apparatuses.

### BRIEF DESCRIPTION OF THE DRAWINGS

FIG. 1 is a diagram of an example load control system.

FIG. 2 is a perspective view of an example motorized window treatment.

FIG. 3 is another perspective view of the motorized window treatment of FIG. 2.

FIG. 4 is another perspective view of the motorized window treatment of FIG. 2.

FIG. 5 is an exploded view of the motorized window treatment of FIG. 2.

FIG. 6 is a right-side cross-section view of the motorized window treatment of FIG. 2.

FIG. 7 is another right-side cross-section view of the motorized window treatment of FIG. 2.

FIG. 8 is a front perspective view of another example motorized window treatment.

FIG. 9 is a rear perspective view of the motorized window treatment of FIG. 8.

FIG. 10 is a front perspective view of the motorized window treatment of FIG. 8.

FIG. 11 is a rear perspective view of the motorized window treatment of FIG. 8.

FIG. 12 is a left-side view of the window treatment assembly of FIG. 8 detached from first and second mounting brackets.

FIG. 13 is a perspective view of an example of the motor drive unit of FIG. 8.

FIG. 14 is a partial enlarged perspective view of the motor drive unit of FIG. 8.

FIG. 15 is a simplified block diagram of a motorized window treatment control system for controlling a motorized window treatment.

FIG. 16 is a flowchart of an example procedure for adjusting a present position of a covering material of a motorized window treatment.

FIG. 17A-17H are flowcharts of example procedures for determining when to dock and charge a bottom bar of a motorized window treatment.

FIG. 18 is a flowchart of an example procedure for docking and charging a bottom bar of a motorized window treatment.

FIG. 19 is a flowchart of an example procedure for adjusting a present position of a covering material of a motorized window treatment in response to a solar power being received by one or more solar cells of the motorized window treatment.

FIGS. 20 and 21 are flowcharts of example procedures for collecting solar data for a motorized window treatment when a motor drive unit is configured to communicate with a bottom bar module via a wireless communication link.

FIGS. 22-25 are flowcharts of example procedures for collecting solar data for a motorized window treatment when a motor drive unit is configured to communicate with a bottom bar module via a wired communication link when a bottom bar of the motorized window treatment is docked.

### DETAILED DESCRIPTION

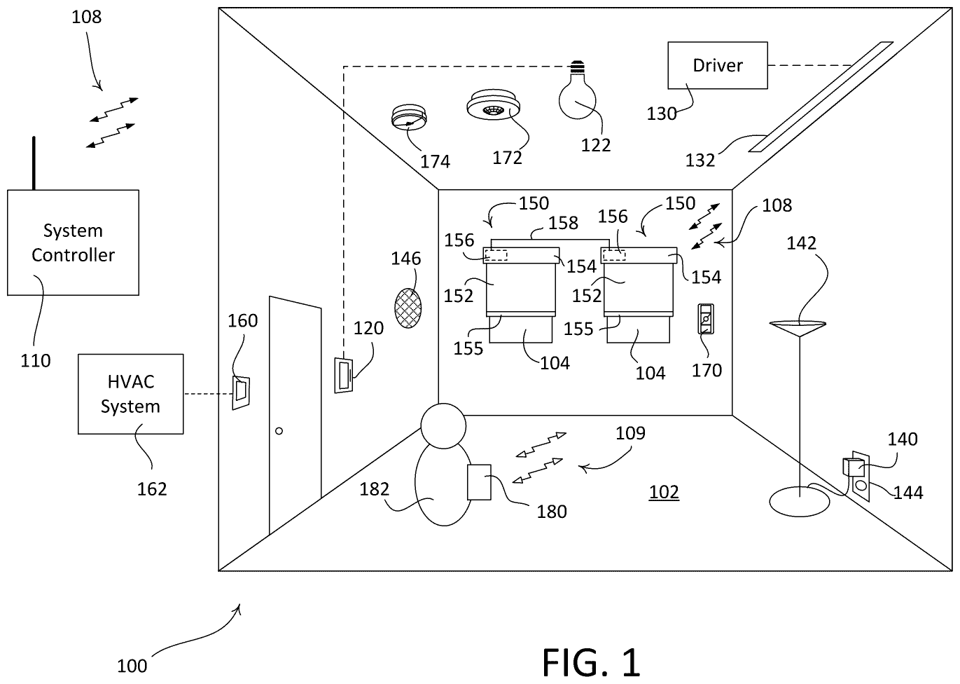

FIG. 1 is a diagram of an example load control system 100 for controlling an amount of power delivered from a power source (not shown), such as an alternating-current (AC) power source or a direct-current (DC) power source, to one or more electrical loads. The load control system 100 may be installed in a room 102 of a building. The load control system 100 may comprise a plurality of control devices configured to communicate with each other by transmitting and receiving messages (e.g., digital messages) via wireless signals, e.g., radio-frequency (RF) signals 108. Alternatively, or additionally, the load control system 100 may comprise a wired digital communication link coupled to one or more of the control devices to provide for communication between the control devices. The control devices of the load control system 100 may comprise a number of control-source devices (e.g., input devices operable to transmit messages in response to user inputs, occupancy and/or vacancy conditions, changes in measured light intensity, etc.) and a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) configured to communicate messages to and from the control devices (e.g., the control-source devices and/or the control-target devices). For example, the system controller 110 may be configured to receive messages from the control-source devices and transmit messages to the control-target devices in response to the messages received from the control-source devices.

The load control system 100 may comprise one or more load control devices, such as a dimmer switch 120 (e.g., a control-target device) for controlling a lighting load 122. The dimmer switch 120 may be configured to control an amount of power delivered from the AC power source to the lighting load to adjust an intensity level and/or a color (e.g., a color temperature) of the lighting load. The dimmer switch 120 may be adapted to be wall-mounted in a standard electrical wallbox. The dimmer switch 120 may also comprise a tabletop or plug-in load control device. The dimmer switch 120 may comprise a toggle actuator (e.g., a button) and an intensity adjustment actuator (e.g., a rocker switch). Actuations (e.g., successive actuations) of the toggle actuator may toggle (e.g., turn off and on) the lighting load 122. Actuations of an upper portion or a lower portion of the intensity adjustment actuator may respectively increase or decrease the amount of power delivered to the lighting load 122 and thus increase or decrease the intensity of the receptive lighting load from a minimum intensity (e.g., approximately 1%) to a maximum intensity (e.g., approximately 100%). The dimmer switch 120 may comprise a plurality of visual indicators, e.g., light-emitting diodes (LEDs), which are arranged in a linear array and are illuminated to provide feedback of the intensity of the lighting load 122. Examples of wall-mounted dimmer switches are described in greater detail in U.S. Pat. No. 9,679,696, issue Jun. 13, 2017, entitled WIRELESS LOAD CONTROL DEVICE, the entire disclosure of which is hereby incorporated by reference.

The dimmer switch 120 may be configured to wirelessly receive messages via the RF signals 108 (and/or via a wired digital communication link) (e.g., from the system controller 110) and to control the lighting load 122 in response to the received messages. Examples of dimmer switches and other control devices configured to transmit and receive messages are described in greater detail in U.S. Pat. No. 10,041,292, issued Aug. 7, 2018, entitled LOW-POWER RADIO-FREQUENCY RECEIVER, and U.S. Pat. No. 10,271,407, issued Apr. 23, 2019, entitled LOAD CONTROL DEVICE HAVING INTERNET CONNECTIVITY, the entire disclosures of which are hereby incorporated by reference.

The load control system 100 may comprise one or more remotely-located load control devices, such as a light-emitting diode (LED) driver 130 (e.g., a control-target device) for driving an LED light source 132 (e.g., an LED light engine). The LED driver 130 may be located, for example, in or adjacent to the lighting fixture of the LED light source 132. The LED driver 130 may be configured to receive messages via the RF signals 108 (and/or via a wired digital communication link) (e.g., from the system controller 110) and to control the LED light source 132 in response to the received messages. The LED driver 130 may be configured to adjust the color temperature of the LED light source 132 in response to the received messages. The load control system 100 may further comprise other types of remotely-located load control devices, such as, for example, electronic dimming ballasts for driving fluorescent lamps.

The load control system 100 may comprise a plug-in load control device 140 (e.g., a control-target device) for controlling a plug-in electrical load, e.g., a plug-in lighting load (e.g., such as a floor lamp 142 or a table lamp) and/or an appliance (e.g., such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108 (and/or via a wired digital communication link) (e.g., from the system controller 110) and to turn on and off or adjust the intensity of the floor lamp 142 in response to the received messages. Alternatively or additionally, the load control system 100 may comprise controllable receptacles (e.g., control-target devices) for controlling plug-in electrical loads plugged into the receptacles. The load control system 100 may comprise one or more load control devices or appliances that are able to directly receive the wireless signals 108, for example, from the system controller 110, such as a speaker 146 (e.g., part of an audio/visual or intercom system), which is able to generate audible sounds, such as alarms, music, intercom functionality, etc.

The load control system 100 may comprise one or more daylight control devices, e.g., motorized window treatments 150 (e.g., control-target devices) (also referred to herein as motorized treatments, or treatments), such as motorized roller shades, for controlling the amount of daylight entering the room 102. Each motorized window treatment 150 may comprise a covering material 152 (e.g., a window treatment fabric, or treatment, or treatment fabric) hanging from a roller tube 154 in front of a respective window 104 with a respective bottom bar 155 connected to a bottom end of the respective covering material 152. The covering material 152 may be wound around and unwound from the roller tube 154 for respectively raising and lowering the covering material 152. Each motorized window treatment 150 may further comprise a motor drive unit 156 located inside of the roller tube 154, for example, and having a motor for rotating the roller tube 154 to raise and lower the covering material 152 for controlling the amount of daylight entering the room 102. The motor drive units 156 may be configured to adjust a present position P_{PRES} of the respective covering material 152 between a raised position P_{RAISED} (e.g., a fully-raised position and/or a fully-open position) and a lowered position P_{LOWERED} (e.g., a fully-lowered position and/or a fully-closed position).

The motor drive units 156 of the motorized window treatments 150 may each be configured to communicate (e.g., transmit and/or receive) messages via the RF signals 108 and/or via a wired digital communication link. For example, the motor drive units 156 of the motorized window treatments 150 may each be configured to receive messages (e.g., from the system controller 110) and adjust the present position P_{PRES} of the respective covering material 152 in response to the received messages. The motor drive unit 156 of each of the motorized window treatments 150 may be battery-powered or may be coupled to an external alternating-current (AC) or direct-current (DC) power source. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Examples of battery-powered motorized window treatments are described in greater detail in U.S. Pat. No. 10,494,864, issued Dec. 3, 2019, entitled MOTORIZED WINDOW TREATMENT, the entire disclosure of which is hereby incorporated by reference.

The motor drive units 156 of the respective motorized window treatments 150 may be configured to rotate the respective roller tubes 154 at a respective rotational speed to move the covering materials 152 (e.g., bottom ends of the covering materials) at the same linear speed, such that the positions of the covering materials 152 may remained aligned even when the diameters of the respective roller tubes 154 are different (e.g., particularly when the motorized window treatment 150 are mounted adjacent to each other as shown in FIG. 1). For example, if the diameters of the respective roller tubes 154 are the same, the motor drive units 156 of the respective motorized window treatments 150 may rotate their respective roller tubes 154 at the same rotational speed to move the covering materials 152 (e.g., bottom ends of the covering materials) at the same linear speed. However, if diameters of the respective roller tubes 154 are different, the motor drive units 156 may rotate their respective roller tubes 154 at a rotational speed that is based on the diameter of their respective roller tube 154 to move the respective covering materials 152 (e.g., bottom ends of the covering materials) at the same linear speed. The linear speed of the covering material 152 of a motorized window treatments 150 may refer to the speed at which the bottom end of the covering material moves (e.g., vertically) toward or away from the roller tube 154. The linear speed v of the covering material 152 each of the motorized window treatments 150 may be a function of the rotational speed w and the diameter d of the roller tube 154, e.g.,

$$v = 1 / 2 \cdot d \cdot ω .$$

Each of the motor drive units 156 of the motorized window treatments 150 may take into account the diameter d of the respective roller tube 154 and control the rotational speed w of the respective motor, such that the linear speed v of the covering material 152 of each of the motorized window treatments 150 may be the same.

Each of the motor drive units 156 may also take into account an amount of the respective covering material 152 wrapped around each of the roller tubes 154 when determining the rotational speed @ at which to rotate the respective motor such that the linear speed v of the covering material 152 of each of the motorized window treatments 150 may be the same. For example, the linear speed v of the covering material 152 each of the motorized window treatments 150 may be a function of the rotational speed w, the diameter d of the roller tube 154, a thickness t of the covering material 152, and a number N of full rotations of the covering material 152 that are presently wound around the roller tube 154, e.g.,

$$v = 1 / 2 \cdot [ d + ( 2 \cdot t \cdot N ) ] \cdot ω .$$

Each of the motor drive units 156 may update the number N of full rotations of the covering material 152 that are wound around the roller tube 154 as the roller tube 154 is rotated to move the covering material 152 between the raised position P_{RAISED} and the lowered position P_{LOWERED}. Each of the motor drive units 156 may adjust the rotational speed w of the respective roller tube 156 such that the linear speed v of the covering material may be constant between the raised position P_{RAISED} and the lowered position P_{LOWERED} (e.g., the rotational speed ω is not constant between the raised position P_{RAISED} and the lowered position P_{LOWERED} and is a function of the number N of full rotations of the covering material 152 that are presently wound around the roller tube 154). Examples of motor drive units configured to the rotational speed of a motor while taking into account the diameter of the roller tube 154 and the amount of the covering material 152 wrapped around each of the roller tube 154 are described in greater detail in U.S. Pat. No. 7,281,565, issue Oct. 16, 2007, entitled SYSTEM FOR CONTROLLING ROLLER TUBE ROTATIONAL SPEED FOR CONSTANT LINEAR SHADE SPEED, the entire disclosure of which is hereby incorporated by reference.

Each of the motorized window treatments 150 may comprise one or more solar cells (e.g., photovoltaic cells) (not shown). For example, the one or more solar cells may be located on headrails and/or housings of the motorized window treatments 150, covering material 152, bottom bar 155, although other locations are possible, such as located on a support structure to which the motorized window treatment is secured. The motorized window treatments 150, for example the motor drive units 156, may each comprise an energy storage element configured to charge from the one or more solar cells for producing a storage voltage across the energy storage element. The motor drive units 156 may each be configured to drive the respective motor from the storage voltage produced across the energy storage element in the respective motorized window treatment/motor drive unit. One will appreciate that the energy storage element of a motorized window treatment 150 need not be part of the motor drive unit 156 and may located at some other portion of the motorized window treatment or externally thereto. For discussions purposes only, the energy storage element of a motorized window treatment will be described as being part of the motor drive unit. One will also appreciate that the energy storage element of the motor drive unit need not charge from the one or more solar cells and/or may charge from another source, or may not be rechargeable, e.g., the energy storage element may be one or more DC batteries.

The motor drive units 156 of one or more of the motorized window treatments 150 may be coupled together via a power bus 158 (e.g., a DC power bus). The motor drive units 156 of the one or more motorized window treatments 150 may be configured to charge the energy storage elements of the motor drive unit 156 of one or more of the other motorized window treatments 150 via the power bus 158. The power bus 158 may be electrically coupled to the motor drive units 156 in a daisy-chain configuration (e.g., with the motor drive units 156 coupled in parallel). The power bus 158 may comprise two electrical conductors (e.g., wires) across which the storage voltage of the energy storage element of the motor drive unit 156 of one or more of the motorized window treatments 150 may be coupled for charging the energy storage elements of the motor drive units 156 of the one or more other motorized window treatments 150, for example.

The motor drive units 156 of the motorized window treatments 150 may each be configured to learn the magnitudes of the storage voltages of the energy storage elements of the other motor drive units 156. For example, the motor drive units 156 may each periodically transmit a message including an indication of the magnitude of the storage voltage of the respective energy storage element (e.g., via the RF signals 108 and/or via a wired digital communication link). Each of the motor drive units 156 may be configured to determine whether or not to charge the respective energy storage elements of the other motorized window treatments 150 in response to the magnitude of the storage voltage of its energy storage element as well as the magnitudes of the storage voltages of the energy storages elements of the other motorized window treatments 154 received in the messages (e.g., via the RF signals 108).

As an example, when the one or more solar cells of a particular motorized window treatment 150 (e.g., one or more solar cells on a respective bottom bar 155) are not able to receive solar power as efficiently as the solar cells of the other motorized window treatments 150, the motor drive unit 156 of that motorized window treatment 150 may not be able to properly drive its motor to move the covering material 152. The motor drive units 156 of the one or more motorized window treatments 150 may each be configured to charge the energy storage elements of one or more of the other motorized window treatments 150 in response to determining that the one or more of the other motorized window treatments needs to be charged.

The motor drive units 156 may be configured to control the respective covering materials 152 to the raised position P_{RAISED} to allow an energy storage element in the bottom bar 155, for example, to charge from the energy storage element of the respective motor drive unit 156. The bottom bar 155 may include a communication circuit configured to send a message, for example, to a communication circuit in the motor drive unit 156 (although it may be located at different location within the motorized window treatment) that is connected directly or indirectly to a control circuit of the motor drive unit 156, for example. For example, the communication circuit and/or a control circuit of the bottom bar 155 may determine a charge of the energy storage element of the bottom bar and send a message (e.g., to the communication circuit of the motor drive unit 156) based on a charge of the energy storage element of the bottom bar 155, such that the control circuit of the motor drive unit 156, for example, may determine when to charge the energy storage element of the bottom bar 155 based on the charge of the energy storage element of the bottom bar 155. The control circuit of the motor drive unit 156 may be configured to dock the bottom bar 155 as further described herein in response to determining to charge the energy storage element of the bottom bar 155, such that the control circuit of the motor drive unit 156 may charge the energy storage element of the bottom bar 155 using energy from a power source and/or the energy storage element of the motor drive unit 156 when the bottom bar 155 is docked.

Additionally or alternatively, the bottom bar 155 may include a sensor circuit configured to detect/indicate a light level, such as a daylight level outside the window that the motorized window treatment 150 is covering and/or an ambient light level inside the space in which the motorized window treatment 150 is located. The sensor circuit may comprise one or more orientation detection sensors, such as an accelerometer and/or a gyroscope. In other examples, the sensor circuit may comprise an occupancy detection circuit configured to detect when the space in which the motorized window treatment 150 is installed is occupied and/or vacant. The sensor circuit and/or a control circuit of the bottom bar may send a message via communication circuit of the bottom bar to the control circuit of the motor drive unit 156 for example, such that the motor drive unit 156 may determine to charge and/or move a position of the bottom bar based on the message.

The load control system 100 may comprise one or more temperature control devices, e.g., a thermostat 160 (e.g., a control-target device) for controlling a room temperature in the room 102. The thermostat 160 may be coupled to a heating, ventilation, and air conditioning (HVAC) system 162 via a control link (e.g., an analog control link or a wired digital communication link). The thermostat 160 may be configured to wirelessly communicate messages with a controller of the HVAC system 162. The thermostat 160 may comprise a temperature sensor for measuring the room temperature of the room 102 and may control the HVAC system 162 to adjust the temperature in the room to a setpoint temperature. The load control system 100 may comprise one or more wireless temperature sensors (not shown) located in the room 102 for measuring the room temperatures. For example, the thermostat 160 and the wireless temperature sensors may be battery-powered. The HVAC system 162 may be configured to turn a compressor on and off for cooling the room 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the room 102.

The load control system 100 may comprise one or more input devices (e.g., control-source devices), such as a remote control device 170, an occupancy sensor 172, and/or a daylight sensor 174. The input devices may be fixed or movable input devices. The remote control device 170, the occupancy sensor 172, and/or the daylight sensor 174 may be wired or wireless control devices (e.g., RF transmitters) configured to transmit messages, such as messages via the RF signals 108 for example, to the system controller 110 (e.g., directly to the system controller). The system controller 110 may be configured to transmit one or more messages to the load control devices (e.g., the dimmer switch 120, the LED driver 130, the plug-in load control device 140, the motorized window treatments 150, and/or the thermostat 160) in response to the messages received from the remote control device 170, the occupancy sensor 172, and/or the daylight sensor 174. The remote control device 170, the occupancy sensor 172, and/or the daylight sensor 174 may also and/or alternatively be configured to transmit messages directly to the dimmer switch 120, the LED driver 130, the plug-in load control device 140, the motorized window treatments 150, and the temperature control device 160.

The remote control device 170 may be configured to transmit messages to the system controller 110 and/or a control-target device via the RF signals 108 in response to an actuation of one or more buttons of the remote control device. For example, the remote control device 170 may be battery-powered. Examples of remote control devices are described in greater detail in U.S. Pat. No. 9,361,790, issued Jun. 7, 2016, entitled REMOTE CONTROL FOR A WIRELESS LOAD CONTROL SYSTEM, and U.S. Pat. No. 9,633,557, issued Apr. 25, 2017, entitled BATTERY-POWERED RETROFIT REMOTE CONTROL DEVICE, the entire disclosures of which are hereby incorporated by reference.

The occupancy sensor 172 may be configured to detect occupancy and vacancy conditions in the room 102 (e.g., the room in which the occupancy sensors are mounted). For example, the occupancy sensor 172 may be battery-powered. The occupancy sensor 172 may transmit digital messages to the system controller 110 and/or a control-target device via the RF signals 108 or wired communications in response to detecting the occupancy or vacancy conditions. The system controller 110 may be configured to control load control devices (e.g., the dimmer switch 120, the LED driver 130, and/or the motorized window treatments 152) in response to receiving an occupied command and a vacant command from the occupancy sensor 172. In addition, the load control devices may be responsive to an occupied command and a vacant command received directly from the occupancy sensor 172. Examples of RF load control systems having occupancy and vacancy sensors are described in greater detail in U.S. Pat. No. 8,009,042, issued Aug. 30, 2011, entitled RADIO-FREQUENCY LIGHTING CONTROL SYSTEM WITH OCCUPANCY SENSING, the entire disclosure of which is hereby incorporated by reference.

The daylight sensor 174 may be configured to measure a total light intensity in the room 102 (e.g., the room in which the daylight sensor is installed). For example, the daylight sensor 174 may be battery-powered. The daylight sensor 174 may transmit digital messages (e.g., including the measured light intensity) to the system controller 110 via the RF signals 108 or wired communications for controlling the intensities of the lighting load 122 and/or the LED light source 132 in response to the measured light intensity. The system controller 110 may be configured to control the load control devices (e.g., the dimmer switch 120, the LED driver 130, and/or the motorized window treatments 152) in response to receiving a message including the measured light intensity from the daylight sensor 174. In addition, the load control devices may be responsive to a message including the measured light intensity received directly from the daylight sensor 174. Examples of RF load control systems having daylight sensors are described in greater detail in U.S. Pat. No. 8,451,116, issued May 28, 2013, entitled WIRELESS BATTERY-POWERED DAYLIGHT SENSOR, the entire disclosure of which is hereby incorporated by reference.

Each of the input devices (e.g., the system controller 110, the remote control device 170, the occupancy sensor 172, and/or the daylight sensor 174) may be configured to transmit a message to the load control devices (e.g., the dimmer switch 120, the LED driver 130, the plug-in load control device 140, the motorized window treatments 150, and/or the thermostat 160) multiple times during a transmission event. For example, each of the messages of a transmission event may include the same command for controlling one or more of the load control devices. The input devices may be configured to transmit the messages periodically (e.g., at a transmission period T_{TX}) during the transmission event. The load control devices that are battery-powered (e.g., the motorized window treatments 150) may be configured to periodically wake up from a sleep state (e.g., at a wake-up period T_{WAKE-UP}) to determine if one of the multiple messages of the transmission event is being transmitted. The transmission period T_{TX} and the wake-up period T_{WAKE-UP} may be sized such that each of the load control devices (e.g., the motorized window treatments 150) may not receive each of the multiple messages of the transmission event, but such that most of the load control devices may have received at least one of the messages when a predetermined number of the multiple messages of the transmission event have been transmitted. Each of the motorized window treatments may wait until the predetermined number of the multiple messages of the transmission event have been transmitted before responding to the command. For example, the motorized window treatments may begin adjusting the present positions P_{PRES} of the respective covering materials at a time (e.g., a coordinated action time) that is based on the time at which the predetermined number of the multiple messages of the transmission event have been transmitted (e.g., immediately following when the predetermined number of the multiple messages of the transmission event have been transmitted).

The system controller 110 may be configured to be coupled to a network, such as a wireless or wired local area network (LAN), e.g., for access to the Internet. The system controller 110 may be wirelessly connected to the network. The system controller 110 may be coupled to the network via a network communication bus (e.g., an Ethernet communication link). The system controller 110 may be configured to communicate via the network with one or more network devices, e.g., a user device such as mobile device 180, such as, a personal computing device and/or a wearable wireless device. The mobile device 180 may be located on an occupant 182, for example, may be attached to the occupant's body or clothing or may be held by the occupant. The mobile device 180 may be characterized by a unique identifier (e.g., a serial number or address stored in memory) that uniquely identifies the mobile device 180 and thus the occupant 182. Examples of personal computing devices may include a smart phone, a laptop, and/or a tablet device. Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.). For example, the system controller 110 may be configured to receive a message comprising an indication of a color temperature and/or to adjust the color temperature of the one or more lighting loads 122 based on the indication of the color temperature. The system controller 110 may receive the indication of the color temperature from a window treatment 150 (e.g., a communication circuit of the window treatment). For example, a bottom bar of the window treatment may include a sensor (e.g., photosensor) which may be configured to determine the (e.g., indication of) color temperature (e.g., at the window treatment 150).

The mobile device 180 may be configured to transmit digital messages via RF signals 109 to the system controller 110 and/or the load control devices, for example, in one or more Internet Protocol packets. For example, the mobile device 180 may be configured to transmit digital messages to the system controller 110 over the LAN and/or via the Internet. The mobile device 180 may be configured to transmit digital messages over the internet to an external service, and then the digital messages may be received by the system controller 110. The load control system 100 may comprise other types of network devices coupled to the network, such as a desktop personal computer (PC), a wireless-communication-capable television, or any other suitable Internet-Protocol-enabled device.

The operation of the load control system 100 may be programmed and configured using, for example, the mobile device 180 or other network device (e.g., when the mobile device is a personal computing device). The mobile device 180 may execute a graphical user interface (GUI) configuration software for allowing a user to program how the load control system 100 will operate. For example, the configuration software may run as a PC application or a web interface. The configuration software and/or the system controller 110 (e.g., via instructions from the configuration software) may generate a load control database that defines the operation of the load control system 100. For example, the load control database may include information regarding the operational settings of different load control devices of the load control system (e.g., the dimmer switch 120, the LED driver 130, the plug-in load control device 140, the motorized window treatments 150, and/or the thermostat 160). The load control database may comprise information regarding associations between the load control devices and the input devices (e.g., the remote control device 170, the occupancy sensor 172, and/or the daylight sensor 174). The load control database may comprise information regarding how the load control devices respond to inputs received from the input devices. Examples of configuration procedures for load control systems are described in greater detail in U.S. Pat. No. 10,027,127, issued Jul. 17, 2018, entitled COMMISSIONING LOAD CONTROL SYSTEMS, the entire disclosure of which is hereby incorporated by reference.

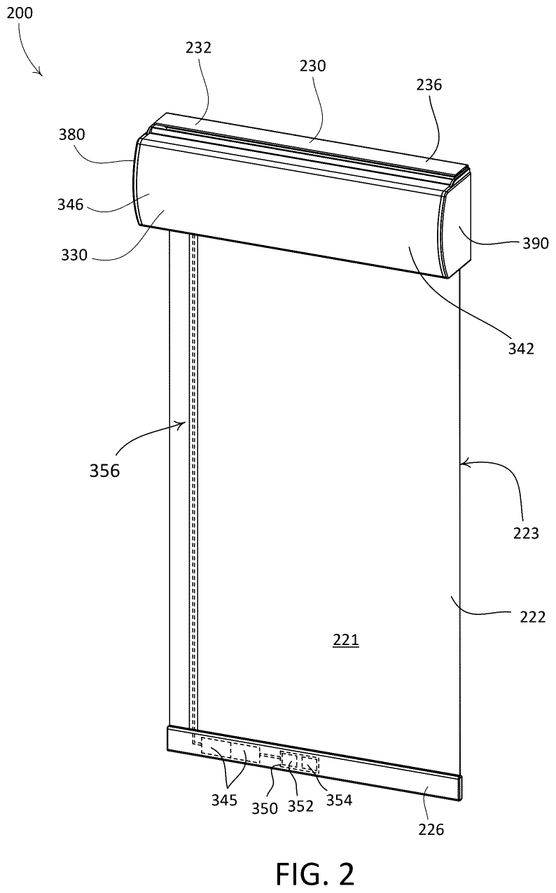

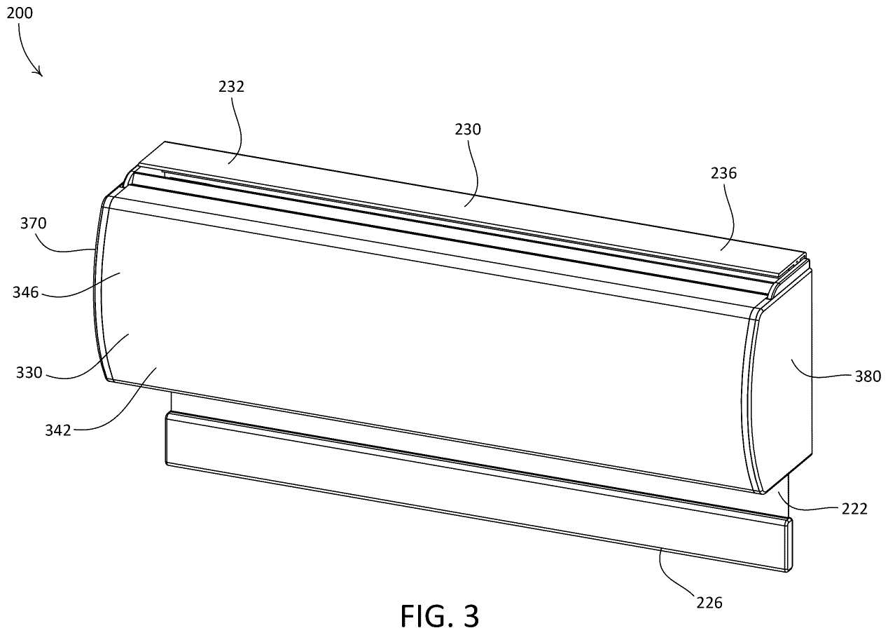

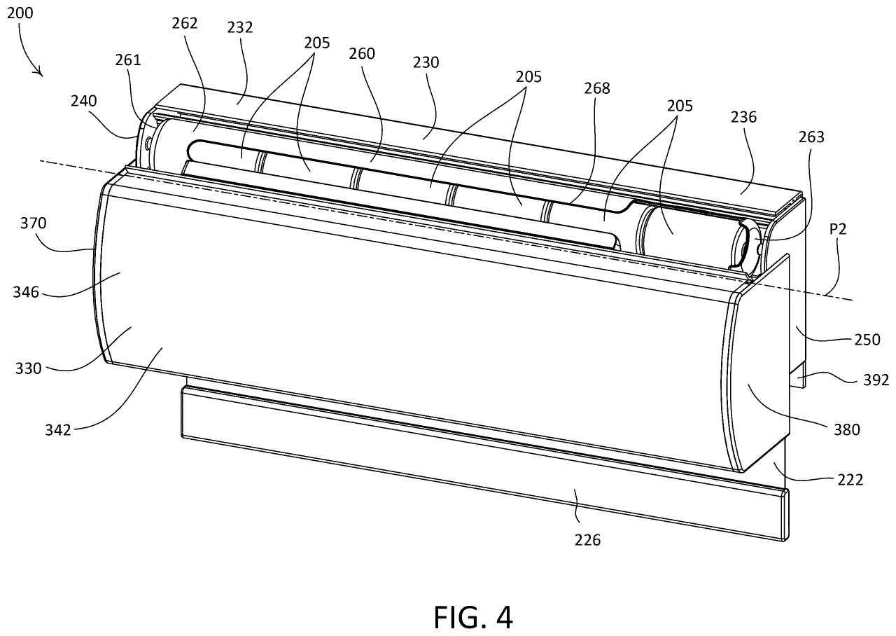

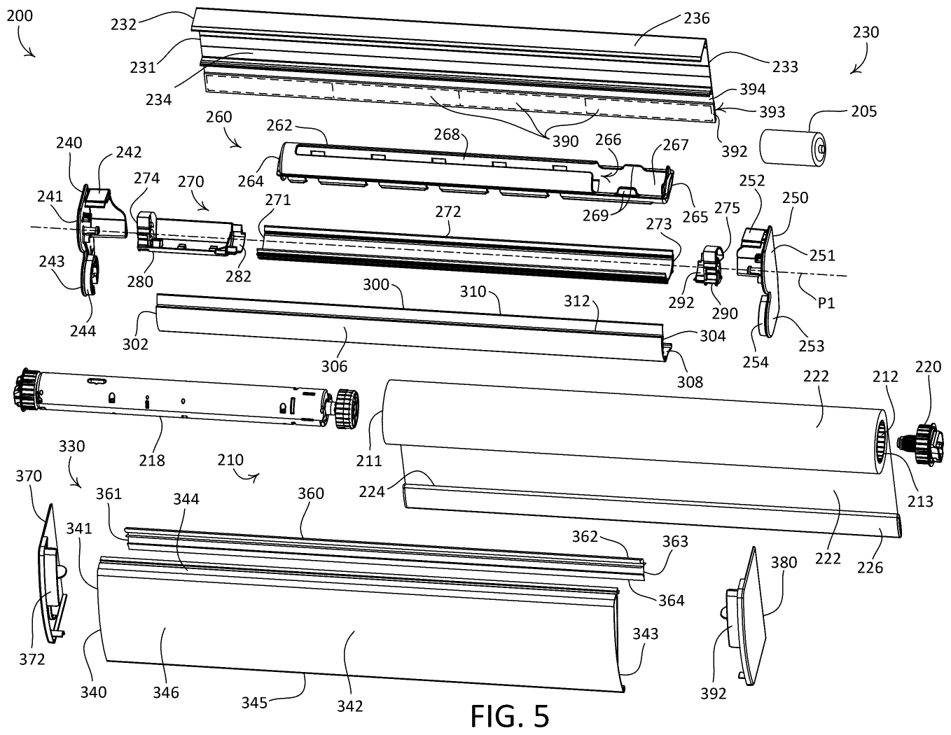

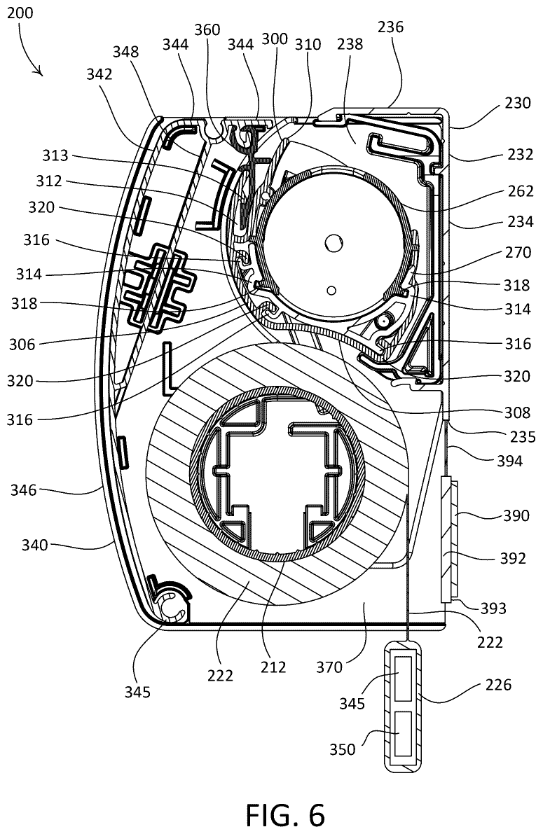

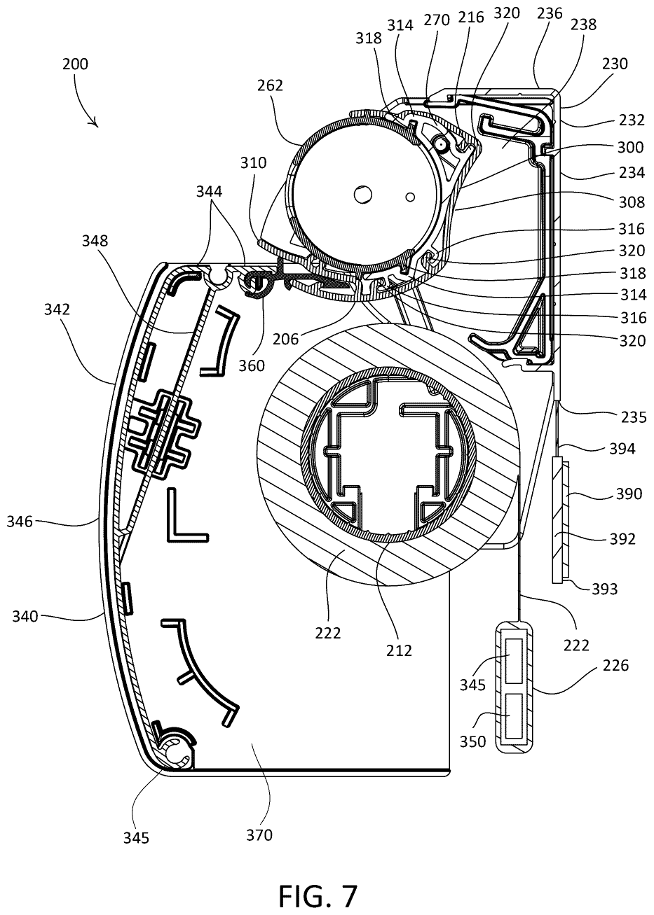

FIGS. 2-6 depict an example motorized window treatment 200, which may be deployed as one or more of the motorized window treatments 150 of the load control system 100. FIGS. 2-4 are perspective views of the motorized window treatment 200. FIG. 5 is an exploded view of the motorized window treatment 200. FIGS. 6 and 7 are right-side cross-section views of the motorized window treatment 200. The motorized window treatment 200 may be mounted to a structure that is proximate to the opening, such as a window frame, a wall, or other structure. The motorized window treatment 200 may include a window treatment assembly (e.g., a shade assembly 210), a housing 230, a battery compartment 260, and a fascia 330. The housing 230 may be configured to support the shade assembly 210 and the battery compartment 260. The housing 230 may be configured as a mounting structure and/or a support structure. The battery compartment 260 may be configured to retain one or more energy storage elements, such as one or more batteries 205. The batteries 205 may be, for example, D-cell (e.g., IEC R20) batteries. The battery compartment 260 may be configured to be operable between a closed position (e.g., as shown in FIG. 3) and an opened position (e.g., as shown in FIG. 4), such that one or more of the batteries 205 may be accessible when the battery compartment 260 is in the opened position. The motorized window treatment 200 may be configured such that the battery compartment 260 is mechanically bistable with respect to the opened and closed positions.

The shade assembly 210 may include a roller tube 212, a motor drive unit 218, an idler 220, a covering material 222 (e.g., a shade fabric), and a bottom bar 226 (e.g., a hembar). The roller tube 212 may define a cylindrical shape that is elongate between a first end 211 and a second end 213. The roller tube 212 may be hollow and open at the first and second ends 211, 213. The roller tube 212 may be configured to at least partially receive the motor drive unit 218, and to at least partially receive the idler 220. The roller tube 212 may be configured such that a portion of the motor drive unit 218 may be disposed in the first end 211, and such that a portion of the idler 220 may be disposed in the second end 213. The motor drive unit 218 may be operably coupled to the roller tube 212 when the motor drive unit 218 is disposed in the first end 211 of the roller tube 212, such that operation of the motor drive unit 218 causes the roller tube 212 to rotate. The motor drive unit 218 may include one or more energy storage elements configured to receive power from the batteries 205. For example, the energy storage elements of the motor drive unit 218 may comprise one or more of batteries (e.g., rechargeable batteries) and/or capacitors (e.g., supercapacitors).

The covering material 222 may define an upper end (not shown) that is attached to the roller tube 212, and an opposed lower end 224. The roller tube 212 may define a central, longitudinal axis, about which the roller tube 212 may rotate. Rotation of the roller tube 212 about the longitudinal axis, for example rotation caused by the motor drive unit 218, may cause the covering material 222 to wind onto, or to unwind from, the roller tube 212. In this regard, the motor drive unit 218 may adjust the covering material (e.g., the covering material 222), for instance between a raised position P_{RAISED} (e.g., a fully-raised position and/or a fully-open position as shown in FIG. 3) and a lowered position P_{LOWERED} (e.g., a fully-lowered position and/or a fully-closed position as shown in FIG. 2). The covering material 222 may be referred to as a motorized shade. Rotation of the roller tube 212 about the longitudinal axis in a first direction may cause the covering material 222 to unwind from the roller tube 212, for example as the covering material 222 is operated to the lowered position P_{LOWERED}. Rotation of the roller tube 212 about the longitudinal axis in a second direction that is opposite the first direction may cause the covering material 222 to wind onto the roller tube 212, for example as the covering material 222 is operated to the raised position P_{RAISED}. The covering material 222 may be made of any suitable material, or combination of materials. For example, the covering material 222 may be made from one or more of “scrim,” woven cloth, non-woven material, light-control film, screen, or mesh. The bottom bar 226 may be attached to the lower end 224 of the covering material 222, and may be weighted, such that the bottom bar 226 causes the covering material 222 to hang (e.g., vertically) in front of one or more windows.

The motor drive unit 218 may be configured to enable control of the rotation of the roller tube 212, for example by a user of the motorized window treatment 200. For example, a user of the motorized window treatment 200 may control the motor drive unit 218 such that the covering material 222 is moved to a desired position. The motor drive unit 218 may include a sensor that monitors a position of the roller tube 212. This may enable the motor drive unit 218 to track a position of the covering material 222 relative to respective upper and lower limits of the covering material 222. The upper and lower limits may be specified by an operator of the motorized window treatment 200, and may correspond to the raised position P_{RAISED} and the lowered position P_{LOWERED} of the covering material 222, respectively.

The motor drive unit 218 may be manually controlled (e.g., by actuating one or more buttons) and/or wirelessly controlled (e.g., using an infrared (IR) or radio frequency (RF) remote control unit), and/or controlled via wired communication. The motorized window treatment 200 may include communication circuit (e.g., for wired and/or wireless communications) that may be in the motor drive unit 218. The motorized window treatment 200 may include an antenna (not shown) that is configured to receive wireless signals (e.g., RF signals from a remote control device). The antenna may be in electrical communication with a wireless communication circuit (e.g., an RF transceiver) that may be in the motor drive unit 218 (e.g., via a control circuit or PCB), such that one or more wireless signals received from a remote control unit may cause the motor drive unit 218 to move the covering material 222 (e.g., between the raised position P_{RAISED} and the lowered position P_{LOWERED}). The antenna may be integrated with (e.g., pass through, be enclosed within, and/or be mounted to) one or more of the shade assembly 210, the housing 230, the battery compartment 260, or respective components thereof.

The housing 230 may include a rail 232, a first housing bracket 240, and a second housing bracket 250. The rail 232 may be elongate between a first end 231 and an opposed second end 233. The rail 232, the first housing bracket 240, and the second housing bracket 250 may be configured to attach to one another in an assembled configuration. For example, the first housing bracket 240 may be configured to be attached to the first end 231 of the rail 232, and the second housing bracket 250 may be configured to be attached to the second end 233 of the rail 232. The first housing bracket 240 may define an attachment member 242 that is configured to engage the first end 231 of the rail 232, and the second housing bracket 250 defines an attachment member 252 that is configured to engage the second end 233 of the rail 232.

One or more of the rail 232, the first housing bracket 240, or the second housing bracket 250, may be sized for mounting to a structure. For example, the rail 232 may be sized such that, with the first and second housing brackets 240, 250 attached to the rail 232, the rail 232 may be mounted to a structure in an opening (e.g., to a window frame). In such an example configuration, the rail 232 may define a length, for example as defined by the first and second ends 231, 233, such that the housing 230 may fit snugly in a window frame (e.g., with little clearance between the first and second housing brackets 240, 250 and adjacent structure of a window frame). This configuration may be referred to as an internal mount configuration. In another example, the rail 232 may be sized such that, with the first and second housing brackets 240, 250 attached to the rail 232, the rail 232 may be mounted to a structure above an opening (e.g., to a surface above a window). In such an example configuration, the rail 232 may define a length that is substantially equal to (e.g., slightly longer than) a width of the window opening. It should be appreciated, however, that the motorized window treatment 200 is not limited to these example mounting configurations.

The rail 232 may define any suitable shape. The rail 232 may include a rear wall 234 that may be configured to be mounted to a structure, and an upper wall 236 that extends outward from an upper edge of the rear wall 234 along a direction that is substantially perpendicular to the rear wall 234. The rail 232, the first housing bracket 240, and the second housing bracket 250, when in an assembled configuration, may define a cavity 238 (e.g., as shown in FIGS. 5 and 6). The shade assembly 210 and the battery compartment 260 may be disposed in the cavity 238, for example when the motorized window treatment 200 is in an assembled configuration (e.g., as shown in FIGS. 2 and 3).

The housing 230 may be configured to support one or both of the shade assembly 210 and the battery compartment 260. For example, the first and second housing brackets 240, 250 may be configured to support the shade assembly 210 and/or the battery compartment 260. The first and second housing brackets 240, 250 may be configured to support the shade assembly 210 and the battery compartment 260 such that the battery compartment 260 is located (e.g., is oriented) above the shade assembly 210 when the motorized window treatment 200 is mounted to a structure.

The first housing bracket 240 may define an upper portion 241 and a lower portion 243. The lower portion 243 may be configured to operably support the shade assembly 210, such that the covering material 222 may be moved (e.g., between the raised position P_{RAISED} and the lowered position P_{LOWERED}). For example, the lower portion 243 may define an attachment member 244 that is configured to receive a complementary attachment member of the motor drive unit 218. The upper portion 241 may be configured to operably support the support the battery compartment 260, such that the battery compartment 260 is operable to provide access to one or more batteries 205 when the motorized window treatment 200 is mounted to a structure, in an assembled configuration.

The second housing bracket 250 may define an upper portion 251 and a lower portion 253. The lower portion 253 may be configured to operably support the shade assembly 210, such that the covering material 222 may be moved (e.g., between the raised position P_{RAISED} and the lowered position P_{LOWERED}). For example, the lower portion 253 may define an attachment member 254 that is configured to receive a complementary attachment member of the idler 220. The upper portion 251 may be configured to operably support the battery compartment 260, such that the battery compartment 260 is operable to provide access to one or more batteries 205 when the motorized window treatment 200 is mounted to a structure, and is in an assembled configuration. For example, the upper portion 251 may define a post 256 that extends into the cavity 238 when the second housing bracket 250 is attached to second end 233 of the rail 232. The post 256 may be referred to as a second post. The post 256 may be configured to be received by the battery compartment 260, such that the battery compartment is pivotable (e.g., rotatable) about the post 256 between the closed position and the opened position. The upper portion 251 may further define a projection 258 that extends into the cavity 238 when the second housing bracket 250 is attached to the rail 232. The projection 258 may be configured to be received by the battery compartment 260, such that pivoting of the battery compartment 260 about the post 256 is limited.

When the first and second housing brackets 240, 250 are attached to the rail 232 (e.g., when the housing 230 is in an assembled configuration), the battery compartment 260 may pivot about a pivot axis P1 (e.g., as depicted in FIG. 5), for example between the opened and closed positions. The housing 230 may support the shade assembly 210 such that the shade assembly 210 remains in a static, supported position when the battery compartment 260 is operated between the opened and closed positions. For example, the first and second housing brackets 240, 250 may support the shade assembly 210 such that when the motorized window treatment 200 is in an assembled configuration and is mounted to a structure, the shade assembly 210 does not move relative to the structure when the battery compartment 260 is operated between the opened and closed positions. The housing 230 may be configured to be mounted to structure using one or more fasteners (e.g., one or more screws). For example, one or more of the rail 232, the first housing bracket 240, or the second housing bracket 250 may define one or more respective apertures that are configured to receive fasteners.

The battery compartment 260 may be configured to hold (e.g., to retain) one or more batteries 205. The battery compartment 260, when supported by the housing 230, may be operated between an opened position and a closed position, for example by causing the battery compartment 260 to pivot about the pivot axis P1. When the battery compartment 260 is in the closed position, the one or more batteries 205 held by the battery compartment 260 are concealed from view (e.g., as shown in FIG. 3). When the battery compartment 260 is in the opened position, the one or more batteries 205 held by the battery compartment 260 may be at least partially visible (e.g., as shown in FIG. 4), and are accessible, such that one or more batteries 205 may be removed from, or disposed into, the battery compartment 260. For example, when the battery compartment 260 is in the opened position, one or more batteries 205 may be removed from, or disposed into, the battery compartment 260 along a direction that is perpendicular to the longitudinal axis of the roller tube 212. In this regard, one or more batteries 205 held by the battery compartment 260 are accessible along a direction that is perpendicular to the longitudinal axis when the battery compartment 260 is in the opened position. In an example of mounting the motorized window treatment 200 to a structure, the motorized window treatment 200 may be mounted internally with respect to the frame of a window (e.g., inside the window frame of the window), for example in accordance with an internal mount configuration. When the motorized window treatment 200 is mounted inside of a window frame, the batteries 205 may be accessible within an area defined by a periphery of the window frame. The battery compartment 260 may be operated between the opened and closed positions when the motorized window treatment 200 is in an assembled configuration and is mounted to a structure.

The battery compartment 260 may be operated between closed and opened positions, regardless of what position the covering material 222 is in relative to the roller tube 212. For example, the battery compartment 260 may be operated between the opened and closed position when the covering material 222 is in the lowered position P_{LOWERED}, is in the raised position P_{RAISED}, or is in any intermediate position between the raised position P_{RAISED} and the lowered position P_{LOWERED}. Because the covering material 222 may remain in a static position while the battery compartment 260 is operated between the closed and opened positions, the motor drive unit 218 may properly maintain tracking information of the position of the covering material 222 while one or more batteries 205 are removed from the battery compartment 260 (e.g., while one or more batteries 205 are replaced). When the battery compartment 260 is operated from the closed position (e.g., as shown in FIG. 6) to the opened position (e.g., as shown in FIG. 7), the battery compartment 260 may pivot about the pivot axis P1, such that the battery compartment 260, and thus one or more batteries 205 retained by the battery compartment 260, may move away from (e.g., rotates away from) a plane defined by the covering material 222 (e.g., a plane defined by a portion of the covering material 222 that is unwound from the roller tube 212 and is hanging vertically). In this regard, when the battery compartment 260 is operated from the closed position to the opened position, the battery compartment 260 may move away from (e.g., rotate away from) a structure that the motorized window treatment 200 is mounted to (e.g., a window frame).

The battery compartment 260 may be elongate between a first end 261 and an opposed second end 263. The battery compartment 260 may be configured to hold one or more batteries 205, for example in a linear (e.g., coaxial) arrangement between the first and second ends 261, 263. The battery compartment 260 may be in electrical communication with (e.g., electrically coupled to) one or more electrical components of the motorized window treatment 200, for instance the motor drive unit 218, such that DC power from the one or more batteries 205 is delivered to the electrical components. For example, the battery compartment 260 may include respective electrical contacts disposed at the first and second ends 261, 263. The electrical contacts may be configured to abut corresponding terminals of a first battery 205 disposed at the first end 261, and of a last battery 205 disposed at the second end 263, so as to place the batteries 205 in electrical communication with one or more electrical components of the motorized window treatment 200. The electrical contacts may be placed in electrical communication with one or components of the motorized window treatment 200. For example, corresponding wires may connect the electrical contacts to the motor drive unit 218. The wires may be integrated with (e.g., pass through, be enclosed within, and/or be mounted to) one or more of the shade assembly 210, the housing 230, the battery compartment 260, or respective components thereof. For example, wires may be run from the electrical contacts, through the battery compartment 260 along the pivot axis P1, along a surface of the housing 230, into the shade assembly 210, and to the motor drive unit 218.

The battery compartment 260 may include a battery holder 262, a support 270, and a cover 300. The battery holder 262 may be configured to hold (e.g., to retain) one or more batteries 205 within the battery compartment 260. The battery holder 262, the support 270, and the cover 300 may be configured to be attached to one another, for example when the battery compartment 260 is in an assembled configuration. The antenna of the motorized window treatment 200 may be arranged on the cover 300 and may be in electrical communication with a wireless communication circuit in the motor drive unit 218, for example. For example, the antenna may comprise a monopole antenna (e.g., a wire). For example, the antenna may extend along a surface of the cover 300, along the pivot axis P1, into the shade assembly 210, and to the motor drive unit 218.

The battery holder 262 may be elongate between a first end 264 and an opposed second end 265. The battery holder 262 may define a cavity that is sized to receive one or more batteries 205. For example, the battery holder 262 may define a cylindrical channel 266 that is configured to receive one or more batteries 205 in a linear (e.g., coaxial) arrangement between the first and second ends 264, 265. The channel 266 may define a diameter that is slightly larger than an outer diameter of a battery 205, such that a battery 205 may move (e.g., slide) when disposed in the battery holder 262. The diameter of the channel 266 may be, for example, in the range of about 1.25 inches to about 1.38 inches, such as about 1.3 inches. The battery holder 262 may be made of any suitable material, such as plastic.

The battery holder 262, and thus the battery compartment 260, may be configured to retain six (6) D-cell (e.g., IEC R20) batteries in a head to tail, linear (e.g., coaxial) arrangement in the channel 266. The battery holder 262 may have a length (e.g., as defined by the first and second ends 264, 265) such that the batteries 205 are held in respective positions in the channel 266 when the battery holder 262 is filled with six batteries 205. The battery holder 262 may include respective electrical contacts disposed at the first and second ends 264, 265. One or more of the electrical contacts may be configured to press the corresponding terminals of the batteries 205 against one another, for example to maintain electrical communication among the batteries 205. It should be appreciated that the battery holder 262, and thus the battery compartment 260, is not limited to the illustrated number and size of batteries 205 or to the illustrated linear arrangement of batteries 205, and that the battery compartment 260 may be alternatively configured to hold more or fewer batteries of any size, in any suitable arrangement.

The battery holder 262 may define an opening through which a battery 205 may be removed from, or inserted into, the battery holder 262. For example, the battery holder 262 may define an access aperture 267 through which a battery 205 may be removed from, or inserted into, the channel 266. When the battery compartment 260 is in the closed position, the access aperture 267 may be disposed in the cavity 238 and hidden from view (e.g., as shown in FIG. 6). When the battery compartment 260 is in the opened position, the access aperture 267 may be external to the cavity 238 and accessible (e.g., as shown in FIG. 7), such that one or more batteries 205 may be disposed into, or removed from, the battery compartment 260. The access aperture 267 may be sized such that a battery 205 may be freely inserted through the access aperture 267 and into the battery holder 262 (e.g., with little or no resistance). The access aperture 267 may define a length, along an axial direction between the first and second ends 264, 265, that is slightly longer than a length of a battery 205 (e.g., as defined between the contacts of the battery 205), and may define a width that is slightly wider than an outer diameter of the battery 205. The access aperture 267 may be located near the second end 265 of the battery holder 262, and near the second end 263 of the battery compartment 260.

When a battery 205 is disposed into the channel 266 of the battery holder 262, the battery 205 may be moved (e.g., slid) between the first and second ends 264, 265 of the battery holder 262. In this regard, the battery holder 262 may be configured for slidable movement of a battery 205 between the first and second ends 264, 265. And more generally, the battery compartment 260 may be configured for slidable movement of a battery 205 between the first and second ends 261, 263. The battery holder 262 may be configured to allow movement of one or more batteries 205 between the first and second ends 264, 265 of the battery holder 262 while the motorized window treatment 200 is in an assembled configuration. For example, the battery holder 262 may define a slot 268 that is open to the access aperture 267, and that extends along the battery holder 262 toward the first end 264, in the axial direction. The slot 268 may define a width (e.g., between opposed edges of the slot 268 along a direction that is perpendicular to the axial direction) that is narrower than the outer diameter of a battery 205, but wide enough to allow an operator of the motorized window treatment 200 to slide a battery along the channel 266 between the first and second ends 264, 265 (e.g., using a finger disposed in the slot 268). The battery holder 262 may be configured to retain a battery 205 that is disposed in the channel 266 and located at the access aperture 267. For example, the battery holder 262 may define opposed, resilient retention tabs 269 that extend above the access aperture 267. The retention tabs 269 may follow the curvature of the battery holder 262. The retention tabs 269 may be configured to deflect out of the way when a battery 205 is inserted into the battery holder 262, and to resiliently return to respective substantially undeflected positions when the battery 205 is seated in the channel 266, such that the battery 205 is retained in the battery holder 262.

The support 270 may include a rail 272 that is elongate between a first end 271 and an opposed second end 273, a first support bracket 280, and a second support bracket 290. The rail 272, the first support bracket 280, and the second support bracket 290 may be configured to attach to one another in an assembled configuration. For example, the first support bracket 280 may be configured to be attached to the first end 271 of the rail 272, and the second support bracket 290 may be configured to be attached to the second end 273 of the rail 272. The first support bracket 280 may define an attachment member 282 that is configured to engage the first end 271 of the rail 272, and the second support bracket 290 may define an attachment member 292 that is configured to engage the second end 273 of the rail 272. The first support bracket 280 may define a first end 274 of the support 270, and the second support bracket 290 may define a second end 275 of the support 270. The first end 274 of the support 270 may coincide with the first end 261 of the battery compartment 260, and the second end 275 of the support 270 may coincide with the second end 263 of the battery compartment 260. The support 270 may be elongate between the first end 274 and the second end 275. The first and second ends 274, 275 of the support 270 may be configured to be attached to, and supported by, the housing 230, such that the support 270, and thus the battery compartment 260, is pivotable about the pivot axis P1.

The cover 300 may be elongate between a first end 302 and an opposed second end 304. The first end 302 may coincide with the first end 261 of the battery compartment 260, and second end 304 may coincide with the second end 263 of the battery compartment 260. The cover 300 includes a curved front wall 306, and a curved lower wall 308. The cover 300 may be configured to at least partially enclose the battery holder 262. For example, the front wall 306 and the lower wall 308 may at partially enclose the battery holder 262. The front wall 306 may define an upper edge 310, and defines a groove 312 that extends away from the upper edge 310. The front wall 306 may define a projection 313 that extends into the groove 312. When the battery compartment 260 is supported by the housing 230 and is in the closed position, the front wall 306 may exhibit convex curvature relative to the rear wall 234 of the housing 230, and the lower wall 308 may exhibit concave curvature relative to the upper wall 236 of the housing 230. The curvature of the lower wall 308 may be configured to follow that of the covering material 222 when the covering material 222 is in the raised position, such that the lower wall 308 does not interfere with operation of the shade assembly 210 (e.g., does not make contact with the roller tube 212 or material of the covering material 222 that is wound onto the roller tube 212).

The cover 300 may be configured to conceal the battery holder 262 and the support 270, and to at least partially conceal the cavity 238. For example, when the battery compartment 260 is in the closed position, the front wall 306 may conceal the battery holder 262, one or more batteries 205 disposed in the battery holder 262, and one or more portions of the cavity 238 and/or the housing 230 that may otherwise be visible if the cover 300 was absent. When the battery compartment 260 is in the closed position and the covering material 222 is lowered (e.g., to the lowered position P_{LOWERED}), the lower wall 308 may conceal the battery holder 262 and one or more portions of the cavity 238 and/or the housing 230 that may otherwise be visible if the cover 300 was absent. The cover 300 may be made of any suitable material, such as plastic. The cover 300 may be wrapped in a material (e.g., fabric), for instance to enhance the aesthetics of the cover 300.

The battery holder 262, the support 270, and the cover 300, may be configured to be attached to one another, for example when the battery compartment 260 is in an assembled configuration. The battery holder 262 may be attached to the support 270, and the cover 300 may be attached to the support 270. The battery holder 262, the support 270, and the cover 300 may define respective complementary attachment members (e.g., as shown in FIGS. 5 and 6). For example, the support 270 may define first attachment members 314 that are configured to engage complementary attachment members of the battery holder 262, and second attachment members 316 that are configured to engage with complementary attachment members of the cover 300. The battery holder 262 may define attachment members 318 that are configured to engage with the first attachment members 314 of the support 270. The cover 300 may define attachment members 320 that are configured to engage with the second attachment members 316 of the support 270. The attachment members 318 of the battery holder 262 may be configured as projections, and the first attachment members 314 of the support 270 may be configured as receptacles that are configured to receive and engage the projections. The attachment members 320 of the cover 300 and the second attachment members 316 of the support 270 may be respectively configured as complementary hooks that are configured to engage one another.

With the battery compartment 260 in the opened position, one or more batteries 205 may be replaced (e.g., if the batteries 205 are drained). A first one of the batteries 205 that is disposed at the access aperture 267 may be removed from the channel 266 by lifting the first one of the batteries 205 out of the channel 266 past the retention tabs 269. At the access aperture 267, one of the batteries 205 at a time may be removed from the battery compartment 260, and thus from the housing 230 of the motorized window treatment 200, without interfering with the housing 230, the roller tube 212, or the covering material 222. With the first one of the batteries 205 removed, a second one of the batteries 205 may be removed from the channel 266 by sliding the second one of the batteries 205 along the channel 266 toward the access aperture 267 (e.g., by using a finger disposed in the slot 268). When the second one of the batteries 205 reaches the access aperture 267, it may be removed from the channel 266. This process may be repeated for one or more additional batteries 205 (e.g., all six batteries 205). When a desired number of batteries 205 have been removed from the channel 266, one or more fresh batteries 205 (e.g., replacement batteries) may be disposed into the channel 266 past the retention tabs 269 and slid into position in the battery holder 262 (e.g., using the slot 268). When the battery holder 262 is filled with batteries 205, the battery compartment 260 may be operated from the opened position to the closed position.

The fascia 330 may be configured to conceal one or more components of the motorized window treatment 200, for instance when the battery compartment 260 is in the closed position. For example, the fascia 330 may be configured to be at rest in a raised (e.g., closed) position when the battery compartment 260 is in the closed position (e.g., as shown in FIG. 6). When the fascia 330 is in the raised position, the fascia 330 may conceal the roller tube 212, a portion of the covering material 222 that is wound onto the roller tube 212, the battery compartment 260, and one or more portions of the housing 230 when the battery compartment 260 is in the closed position. In this regard, the fascia 330 may be configured to at least partially conceal the cavity 238 when the battery compartment 260 is in the closed position.

The fascia 330 may be configured to move when with the battery compartment 260 is moved between the opened and closed positions, for instance such that the fascia 330 does not interfere with inserting batteries 205 into, or removing batteries 205 from, the battery compartment 260 when the battery compartment 260 is in the opened position. For example, the fascia 330 may be configured to move downward and away from the housing 230 as the battery compartment 260 is pivoted from the closed position to the opened position, such that the fascia 330 is at rest in a lowered (e.g., open) position when the battery compartment 260 is in the opened position (e.g., as shown in FIG. 7). As shown, when the fascia 330 is in the lowered position, the fascia 330 may be positioned such that the fascia 330 does not interfere with access to the battery compartment 260. In this regard, it may be said that the fascia 330 does not cover the battery compartment 260 when the fascia 330 is in the lowered position. Then the fascia 330 is in the lowered position, the fascia 330 may still conceal the roller tube 212, a portion of the covering material 222 (e.g., a portion of the covering material 222 that is wound onto the roller tube 212), and one or more portions of the housing 230. The fascia 330 may be operably attached to the battery compartment 260, such that the fascia 330 moves along with the battery compartment 260 when the battery compartment 260 is moved between the opened and closed positions. For example, the fascia 330 may be pivotally supported by the battery compartment 260, such that the fascia 330 may pivot from the conceal position to the expose position as the battery compartment 260 is operated from the closed position to the opened position, and may pivot from the lowered position to the raised position as the battery compartment 260 is operated from the opened position to the closed position.

The fascia 330 may be a two-part fascia that includes a cover portion that may be referred to as a cover 340, and a support portion that may be referred to as an arm 360. The cover 340 and the arm 360 may be configured to be operably coupled to one another such that the cover 340 and the arm 360 are capable of moving (e.g., rotating or pivoting) relative to one another. The cover 340 may be supported by the arm 360 such that the cover 340 is rotatable about a portion of the arm 360. The arm 360 may be configured to attach to the battery compartment 260 such that the arm 360 remains in a fixed orientation relative to the battery compartment 260 as the battery compartment 260 is operated between the closed and opened positions. In this regard, the fascia 330 may be supported by the battery compartment 260, for instance via the arm 360.

The cover 340 of the fascia 330 may be configured as a cover assembly that includes a cover body 342 that is elongate between a first end 341 and an opposed second end 343, a first end cap 370, and a second end cap 380. The cover body 342 may include an upper wall 344, a curved front wall 346 that extends from the upper wall 344 to a lower end 345, and a support wall 348 that extends from the upper wall 344 to the front wall 346. The front wall 346 may have a height (e.g., as defined from the upper wall 344 to the lower end 345) such that the lower end 345 extends below the roller tube 212 and the portion of the covering material 222 that is wound onto the roller tube 212 when the covering material 222 is in the raised position (e.g., as shown in FIG. 6). The first and second end caps 370, 380 may conform to the curvature of the front wall 346, and may be configured to cover the first and second housing brackets 240, 250, respectively, of the housing 230 when the battery compartment 260 is in the closed position.

The cover body 342, the first end cap 370, and the second end cap 380 may be configured to attach to one another in an assembled configuration. For example, the first end cap 370 may be configured to be attached to the first end 341 of the cover body 342, and the second end cap 380 may be configured to be attached to the second end 343 of the cover body 342. The first end cap 370 may define an attachment member 372 that is configured to engage the first end 341 of the cover body 342, and the second end cap 380 defines an attachment member 382 that is configured to engage the second end 343 of the cover body 342.

The arm 360 may be elongate between a first end 361 and an opposed second end 363. The arm 360 may have a length (e.g., as defined from the first end 361 to the second end 363) that is substantially the same as a corresponding length of the cover body 342 (e.g., as defined from the first end 341 to the second end 343). The arm 360 may comprise a body that extends from the first end 361 to the second end 363, and from an upper end 362 to a lower end 364. The arm 360 may be configured to attach to the battery compartment 260. For example, the arm 360 may define an attachment member 366 at the lower end 364 of the body. The attachment member 366 is configured to be disposed into, and engage within, the groove 312 of the cover 300 of the battery compartment 260, thereby attaching the arm 360 to the battery compartment 260. The attachment member 366 may have a wedge shape that defines a retaining edge 367 that is configured to abut the projection 313 in the groove 312. The attachment member 366 may be retained in position in the groove 312 by engagement between the retaining edge 367 and the projection 313.

The arm 360 may be configured such that when the arm 360 is attached to the battery compartment 260, the arm 360 may remain in a fixed orientation relative to the battery compartment 260, for instance as the battery compartment 260 is operated between the closed and opened positions. For example, the arm 360 may define one or more contact members 368 that extend from the body. The arm 360 may define two contact members 368 that are configured to maintain contact with the cover 300 when the arm 360 is attached to the battery compartment 260. Contact between one or more of the contact members 368 and the cover 300, between the attachment member 366 and the projection 213, and/or between one or more locations on the body of the arm 360 and corresponding locations on the cover 300 may operate to maintain the arm 360 in the illustrated fixed orientation relative to the battery compartment 260. The cover 340 and the arm 360 may be configured to be operably coupled to one another such that the cover 340 is pivotable about at least a portion of the arm 360. For example, the cover 340 and the arm 360 may define complementary connectors that are configured to interlock with each other, such that corresponding portions of the cover 340 and the arm 360 are rotatable relative to each other.

As shown in FIGS. 5-7, the motorized window treatment 200 may further comprise one or more solar cells 390 (e.g., photovoltaic cells). For example, the solar cells 390 may be mounted to a solar-cell support structure 392 (e.g., a plate) that may be supported by the rail 230. The solar cells 390 may be mounted to a rear side 393 of the solar-cell support structure 392, such that the solar cells 390 are facing the window that the covering material 222 of the motorized window treatment 200 is covering and are able to receive solar energy from outside the building (e.g., from the sun). Example locations of the solar cells 390 on the rear side 393 of the solar-cell support structure 392 may be identified by dashed lines in FIG. 5.

The solar cells 390 may be electrically connected to the motor drive unit 218, for example, for powering the motor drive unit 218. For example, the solar cells 390 may be electrically connected to the motor drive unit 218 via two or more electrical conductors (e.g., wires). The electrical conductors may extend through the solar cell support structure 392 and/or the attachment member, such that the electrical conductors connect the motor drive unit 218 to the solar cells 390. The solar cells 390 may be electrically connected (e.g., directly) to the energy storage elements that power the motor drive unit and that may be part of the motor drive unit. The solar cells 390 may be configured to provide power to the energy storage elements, which may provide power to the circuitry of the motor drive unit 218 including for example, one or more control circuits, communication circuits, the motor, etc., and/or to other circuitry not part of the motor drive unit.

The bottom bar 226 may include a bottom bar module 350 having one or more control circuits 352 and/or communication circuits (not shown) configured to receive power, for example from one or more energy storage elements 345. The energy storage elements 345 may comprise one or more of batteries (e.g., rechargeable batteries) and/or capacitors (e.g., supercapacitors). The energy storage elements 345 may be located inside of, on, and/or proximate to the bottom bar 226. The energy storage elements 345 may be in electrical communication with (e.g., electrically coupled to) one or more electrical components of the motorized window treatment 200, for example, the bottom bar module 350, such that power from the energy storage elements 345 is delivered to the electrical components.

The bottom bar module 350 may also comprise one or more sensor circuits 354. For example, the sensor circuit 354 of the bottom bar module 350 may comprise a photosensor and/or a solar cell (e.g., a photovoltaic cell) configured to generate a signal that indicates a light level, such as a daylight level outside the window that the motorized window treatment 200 is covering and/or an ambient light level inside the space in which the motorized window treatment 200 is located. In addition and/or alternatively, the sensor circuit 354 may comprise one or more orientation detection sensors, such as an accelerometer and/or a gyroscope. In other examples, the sensor circuit 354 may comprise additionally and/or alternatively an occupancy detection circuit configured to detect when the space in which the motorized window treatment 200 is installed is occupied and/or vacant.

The motor drive unit 218 may be configured to charge the energy storage element 345 of the bottom bar 226. For example, the covering material 222 of the motorized window treatment 200 may comprise an electrical connection, such as a wired bus 356, that allows for an electrical connection between the bottom bar 226 (e.g., the bottom bar module 350) and the motor drive unit 218, for example. The wired bus 356 may include one or more wires, that for example, are embedded within or secured externally to the covering material 222. In some examples, the wired bus 356 may be two wires that are embedded within tape that is secured to a front surface 221 of the covering material 222 and/or the rear surface 223 of the covering material 222. In other examples, the wired bus 356 may be wound through the fabric of the covering material 222, or the fabric of the covering material 222 may be conductive such that the fabric creates the wired bus 356.

The control circuit of the motor drive unit 218, for example, may be configured to charge the energy storage elements 345 of the bottom bar 226 using energy from the energy storage elements of the motor drive unit 218. The wired bus 356 of the covering material 222 may facilitate discharging of the energy storage elements of the motor drive unit 218 into the energy storage elements of the bottom bar 226. Further, the bottom bar module 350 may include a communication circuit that may allow the control circuit 352 of the bottom bar module 350 to communicate messages (e.g., digital messages) with a communication circuit of the motor drive unit 218, for example, via the wired bus 356. In some examples, the energy storage elements 345 of the bottom bar 226 may be configured to charge from a solar cell of the sensor circuit 354. One will appreciate that while a control circuit of the motor drive unit may be configured to charge the energy storage elements 345 of the bottom bar 226 using energy from the energy storage elements of the motor drive unit 218, for example, the motorized window treatment may include one or more other control circuits not part of the motor drive unit that may cause this energy transfer.

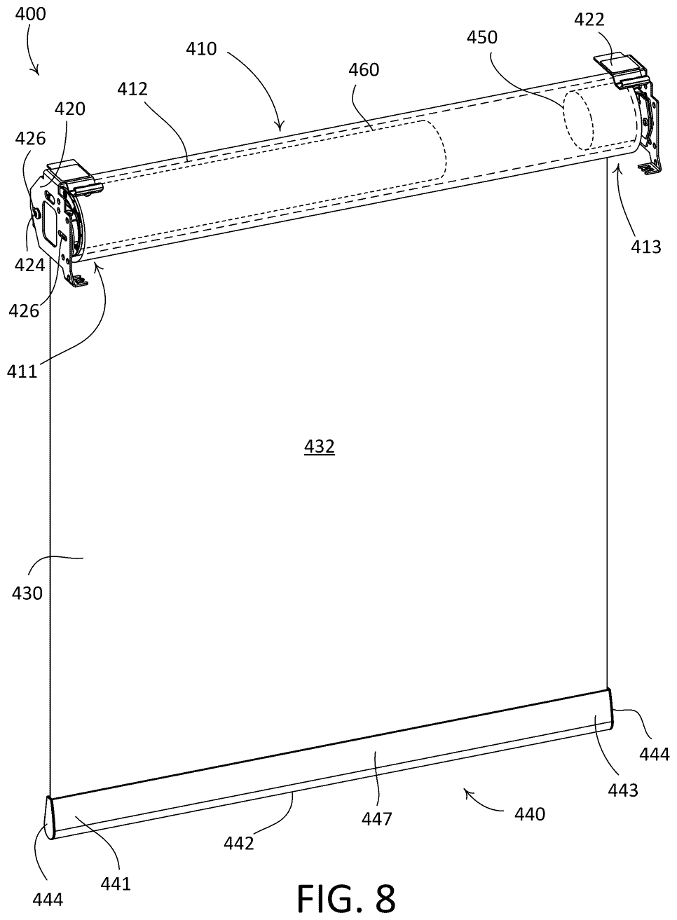

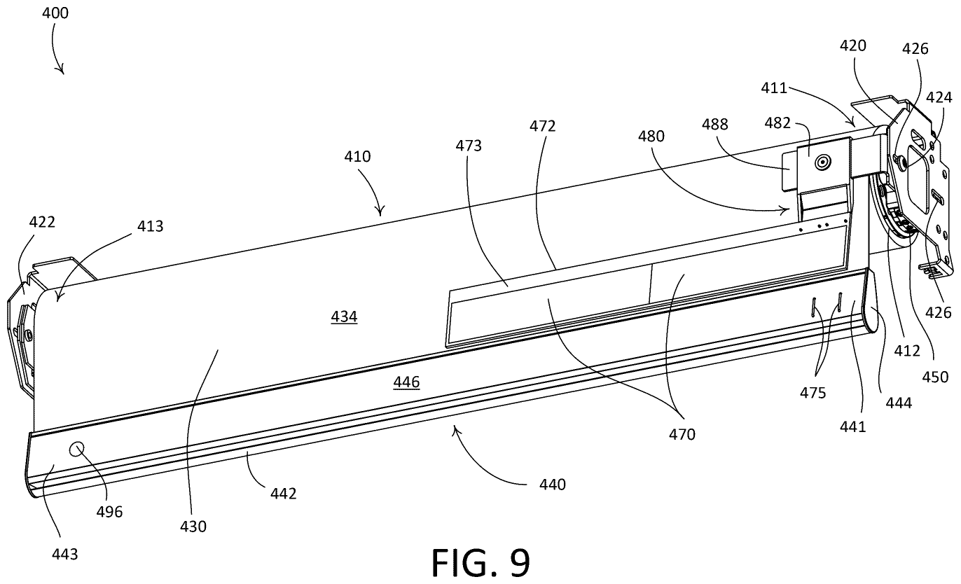

FIGS. 8-13 depict another example motorized window treatment 400, which may be deployed as one or more of the motorized window treatments 150 of the load control system 100. FIG. 8 is a front perspective view and FIG. 9 is a rear perspective view of the motorized window treatment 400. The motorized window treatment 400 may comprise a window treatment assembly 410 and one or more mounting brackets, such as first and second mounting brackets 420, 422. The first and second mounting brackets 420, 422 may be configured to be coupled to or otherwise mounted to a structure. For example, each of the first and second mounting brackets 420, 422 may be configured to be mounted to (e.g., attached to) a window frame, a wall, or other structure of a building, such that the motorized window treatment 400 may be mounted proximate to an opening (e.g., over the opening or in the opening), such as a window for example. The first and second mounting brackets 420, 422 may be configured to be mounted to a vertical structure (e.g., wall-mounted to a wall) and/or mounted to a horizontal structure (e.g., ceiling-mounted to a ceiling).

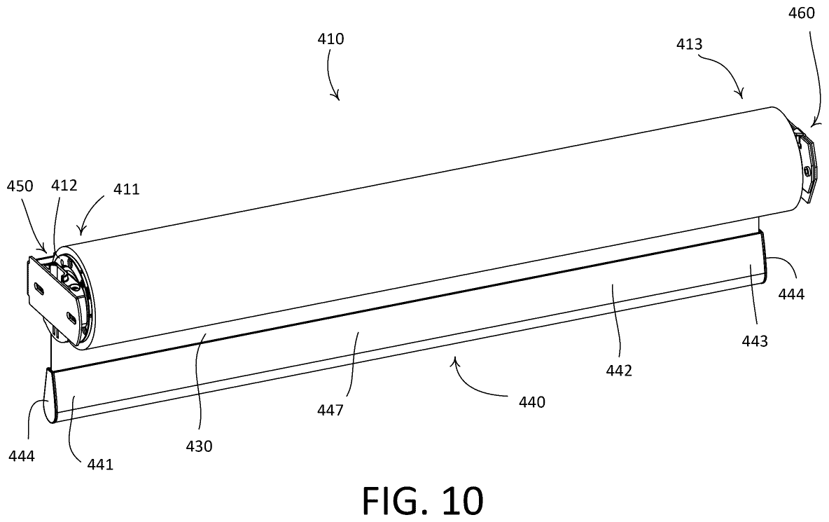

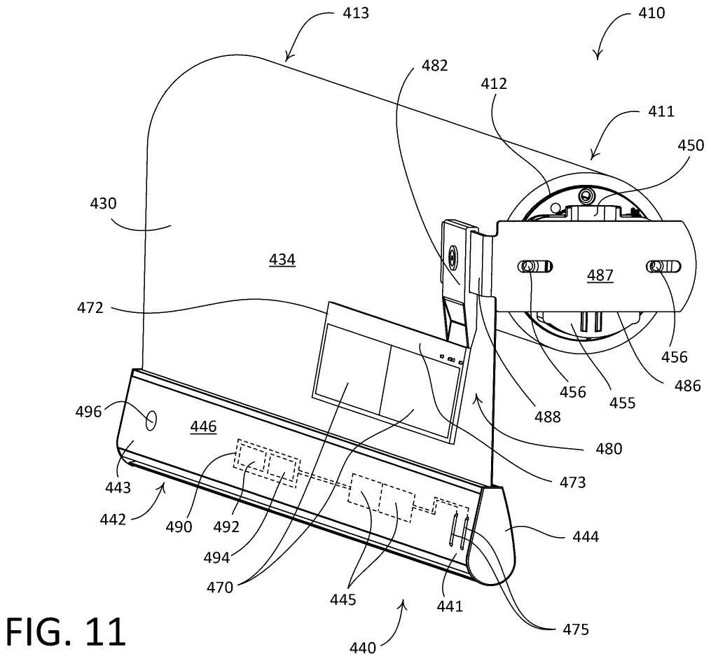

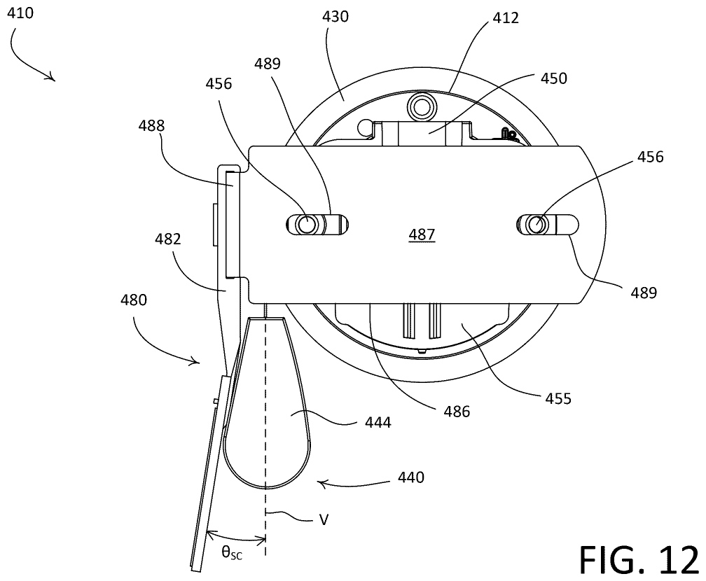

The window treatment assembly 410 may be coupled to (e.g., supported by) the first and second mounting bracket 420, 422. FIG. 10 is a front perspective view, FIG. 11 is a rear perspective view, and FIG. 12 is a left-side view of the window treatment assembly 410 detached from the first and second mounting brackets 420, 422. The window treatment assembly 410 may include a roller tube 412, a covering material 430 (e.g., a flexible material), a bottom bar 440 (e.g., a hembar), a motor drive unit 450 at a first end 411 of the roller tube 412, and an idler 460 at a second end 413 of the roller tube 412. The motor drive unit 450 may be coupled to (e.g., fixedly coupled to) the first mounting bracket 420 and be rotatably coupled to the roller tube 412 at the first end 411 of the roller tube 412. The idler 460 (FIG. 8) may be coupled to (e.g., fixedly coupled to) the second mounting bracket 422 and rotatably coupled to the roller tube 412 at the second end 413 of the roller tube 412. Other configurations of the motor drive unit 450 and idler 460 are possible. For example, the motor drive unit 450 may be located at the second end 413 of the roller tube 412 and the idler 460 may be located at the first end 411 of the roller tube 412.

The covering material 430 may be windingly attached to the roller tube 412. The covering material 430 may comprise a top end (not shown) attached to the roller tube 412 and a bottom end (not shown) attached to the bottom bar 440. The bottom bar 440 may comprise a housing 442 having first and second ends 441, 443. In some examples, the bottom end of the covering material 430 may be received within the housing 442 and secured to the bottom bar 440 inside the housing 442. The bottom bar 440 may also comprise, for example, end caps 444 connected to the first and second ends 441, 443 of the bottom bar 440. In addition, the bottom bar 440 (e.g., the housing 442) may be configured, for example weighted, to cause the covering material 430 to hang vertically. The housing 442 of the bottom bar 440 may comprise a rear surface 446 that may be oriented at an angle θ_{SC} from a vertical axis V (e.g., with respect to the covering material 430 as shown in FIG. 12). For example, the covering material 430 may be configured to cover the window that is proximate to the motorized window treatment 400. The covering material 430 may comprise a front surface 432 that faces the space in which the motorized window treatment 400 is mounted and a rear surface 434 that faces the window.

The roller tube 412 of the window treatment assembly 410 may operate as a rotational element of the motorized window treatment 400. The roller tube 412 of the window treatment assembly 410 may be rotatably mounted to (e.g., rotatably supported by) the first and second mounting brackets 420, 422. The first and second mounting brackets 420, 422 may extend from the structure to which the motorized window treatment 400 is mounted. The covering material 430 may be windingly attached to the roller tube 412, such that rotation of the roller tube 412 causes the covering material 430 to wind around or unwind from the roller tube 412. For example, rotation of the roller tube 412 may cause the covering material 430 (e.g., the bottom bar 440) to move between a raised position P_{RAISED} (e.g., a fully-raised position and/or a fully-open position as shown in FIG. 8) and a lowered position P_{LOWERED} (e.g., a fully-lowered position and/or a fully-closed position as shown in FIG. 9).

The covering material 430 may be any suitable material, or form any combination of materials. For example, the covering material 430 may be “scrim,” woven cloth, non-woven material, light-control film, screen, and/or mesh. The motorized window treatment 400 may be any type of window treatment. For example, the motorized window treatment 400 may be a roller shade as illustrated, a soft sheer shade, a drapery, a cellular shade, a Roman shade, or a Venetian blind. As shown, the covering material 430 may be a material suitable for use as a shade fabric, and may be alternatively referred to as a flexible material. The covering material 430 is not limited to shade fabric. For example, in accordance with an alternative implementation of the motorized window treatment 400 as a retractable projection screen, the covering material 430 may be a material suitable for displaying images projected onto the covering material. As a further example, motorized window treatment 400 may be a motorized outdoor treatment which may be referred to herein also a motorized window treatment, motorized treatment, treatment, etc. With all types of covering materials, the covering material 430 may have a bottom bar attached at a bottom end of the covering material 430.

The bottom bar 440 may include a bottom bar module 490 that includes one or more control circuits 492 and/or communication circuits (not shown) configured to receive power, for example from one or more energy storage elements 445 that may be located in, on, or proximate to the bottom bar. The energy storage elements 445 may include one or more of batteries (e.g., rechargeable batteries) and/or capacitors (e.g., supercapacitors). The energy storage elements 445 of the bottom bar 440 may be in electrical communication with (e.g., electrically coupled to) the bottom bar module 490, such that power from the one or more energy storage elements 445 is delivered to the bottom bar module 490.

The bottom bar module may also comprise one or more sensor circuits 494. For example, the sensor circuit 494 of the bottom bar module 490 may comprise a photosensor and/or a solar cell (e.g., a photovoltaic cell) configured to generate a signal that indicates a light level, such as a daylight level outside the window that the motorized window treatment 400 is covering and/or an ambient light level inside the space in which the motorized window treatment 400 is located. In addition and/or alternatively, the sensor circuit 494 may comprise one or more orientation detection sensors, such as an accelerometer and/or a gyroscope. In other and/or additional examples, the sensor circuit 494 may comprise an occupancy detection circuit configured to detect when the space in which the motorized window treatment 400 is installed is occupied and/or vacant.

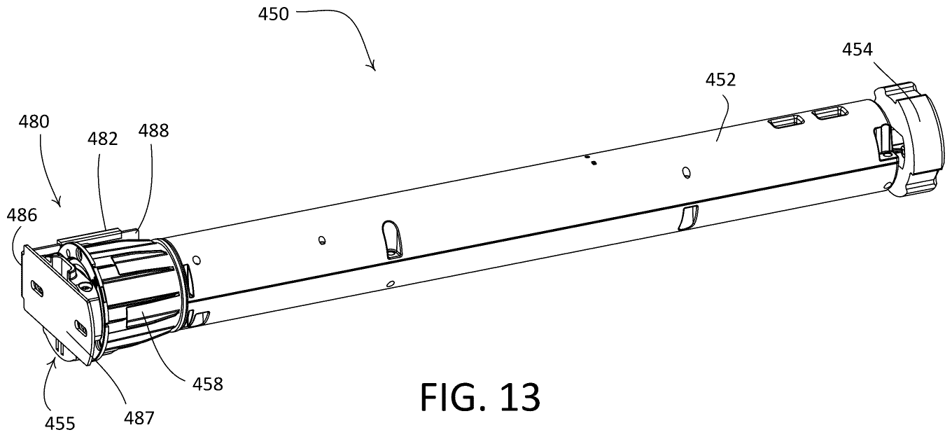

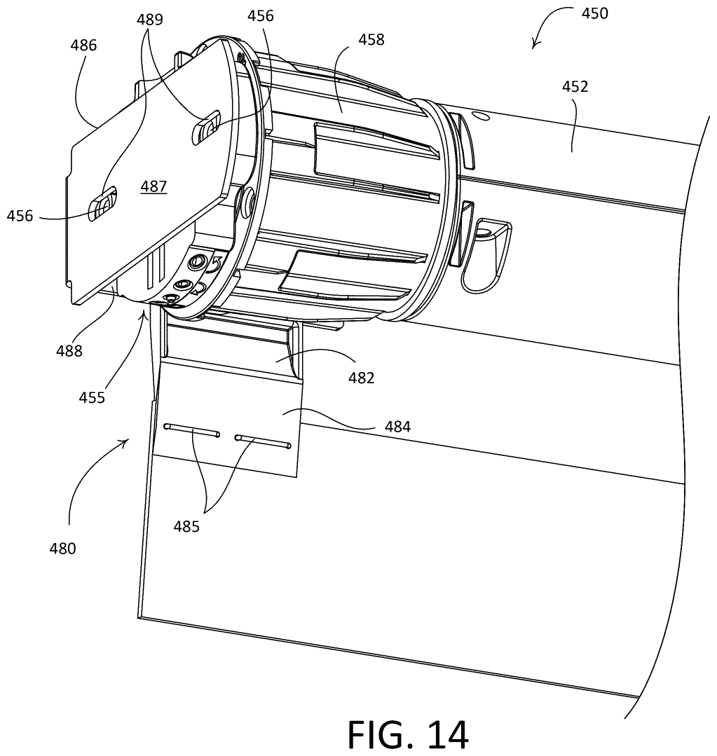

FIG. 13 is a perspective view of an example of the motor drive unit 460. FIG. 14 is a partial enlarged perspective view of the motor drive unit 460. The motor drive unit 460 may include an enclosure 452 for housing an internal motor (not shown) that may be coupled to a drive coupler 454. The drive coupler 454 may be notched about its outer periphery to facilitate engagement between the drive coupler 454 and an interior surface of the roller tube 412 in which the motor drive unit 460 is received. The motor drive unit 460 may be configured to rotate the drive coupler 454 for rotatably driving the roller tube 412. The motor drive unit 460 may further comprise an end portion 455 that may be coupled to (e.g., supported by) the first mounting bracket 420. For example, the end portion 455 may comprise one or more openings 456 that are configured to receive respective fasteners 424 (e.g., screws as shown in FIGS. 8 and 9). The fasteners 424 may also be received though respective openings 426 in the first and second mounting brackets 420, 422. In some examples, the end portion 455 of the motor drive unit 460 may comprise additional openings (not shown) configured to allow the window treatment assembly 410 to be mounted to other mounting brackets (e.g., other than the first and second mounting brackets 420, 422. The openings 456 and the additional openings may be sized and/or located to allow the window treatment assembly 410 to be mounted to multiple types of mounting brackets (e.g., the first and second mounting brackets 420, 422 as well as other mounting brackets). The motor drive unit 460 may comprise a bearing assembly 458, which may be located adjacent to the end portion 455 and may be rotatably coupled to the roller tube 412 at the first end 411 of the roller tube 412.

The motor drive unit 450 may be responsive to messages (e.g., digital messages) transmitted by an external device, such as a remote control device, via wired and/or wireless signals, such as radio-frequency (RF) signals. The motor drive unit 460 may comprise one or more communication circuits, such as a wireless communication circuit (e.g., an RF transceiver coupled to an antenna, an infrared (IR) receiver, etc.) and/or a wired communication circuit. For example, the antenna may be wrapped around the enclosure 452 of the motor drive unit 450 underneath the bearing assembly 458, although may be in other locations. The motor drive unit 450 may be configured to control the movement of the covering material 430 in response to a shade movement command received in messages from the remote control device. During a configuration procedure (e.g., an association procedure), the motor drive unit 450 may be associated with the remote control device, such that the motor drive unit 450 may be responsive to the messages transmitted by the remote control device (e.g., via wireless signals). Similarly, as described in more detail herein, the bottom bar 440 may include a communication circuit, such as a wireless communication circuit (e.g., an RF transceiver coupled to an antenna, an infrared (IR) receiver, etc.) and/or a wired communication circuit so that the bottom bar 440 may be configured to communication with the motor drive unit 450, for example.

As shown in FIGS. 9 and 11, the motorized window treatment 400 may comprise one or more solar cells 470 (e.g., photovoltaic cells). The solar cells 470 may be attached to a rear surface 473 of a solar-cell support structure 472 (e.g., a plate), such that the solar cells 470 face the window (e.g., that the covering material 430 wis configured to cover) and are able to receive solar energy from outside the building (e.g., from the sun). For example, the rear surface 473 of the solar-cell support structure 472 may be oriented at approximately the angle θ_{SC} from a vertical axis V (e.g., with respect to the covering material 230 as shown in FIG. 12), such that the solar cells 470 may be angled up (e.g., towards the sky to maximize the amount of sunlight that may shine on the solar cells 470). For example, the angle θ_{SC} at which the solar cells 470 are oriented may be in the range of approximately 5° to 75° (e.g., approximately) 30°. The solar cells 470 may be oriented horizontally across the rear surface 473 of the plate 272. However, in some examples, the solar cells 470 may be oriented vertically (e.g., in parallel with the shade fabric).

The motorized window treatment 400 may further comprise an attachment member 486 that extends from the end portion 455 of the motor drive unit 450 to the solar-cell support structure 472. The attachment member 486 may comprise a plate 487 and an arm 488 that is oriented at an angle (e.g., approximately 90°) from the plate 487 (e.g., to bend the attachment member 486 behind the rear surface 434 of the covering material 430). The plate 487 may comprise openings 489 through which the respective fasteners 424 may extend for coupling the window treatment assembly 410 to the first mounting bracket 420 (e.g., extending through the openings 456 in the first mounting bracket 420 and the openings 456 in the end portion 455 of the motor drive unit 450). For example, the attachment member 486 (e.g., the plate 487) may be affixed to and/or formed as a part of (e.g., integral with) the enclosure 452 and/or the end portion 455 of the motor drive unit 450. In some examples, the attachment member 486 may be affixed to and/or formed as a part of the first mounting bracket 420.

The solar cells 470 one the plate 472 may be electrically connected to one or more energy storage elements (not shown) contained within the enclosure 452 of the motor drive unit 450, although the energy storage elements may also and/or alternatively be located external to the motor drive unit. The energy storage elements of the motor drive unit 450 may comprise, for example, one or more of batteries (e.g., rechargeable batteries) and/or capacitors (e.g., supercapacitors). The solar cells 470 may be configured to convert the received solar energy into a photovoltaic output voltage, which may be used to charge the energy storage elements located within the enclosure 452 of the motor drive unit 450 (e.g., to generate a storage voltage across the energy storage element). The energy storage elements of the motor drive unit 450 may be in electrical communication with (e.g., electrically coupled to) one or more electrical components of the motorized window treatment 400 (including for example, one or more control circuits, communication circuits, motor, etc.), for example, the motor drive unit 450, such that power from the energy storage elements is delivered to the electrical components.

The motorized window treatment 400 (e.g., the motor drive unit 460 or brackets 420 and/or 422) may comprise a dock 480 that is configured to facilitate charging of the energy storage elements 445 of the bottom bar 440 from the energy storage elements of the motor drive unit 450, for example, when the covering material 430 is in the raised position P_{RAISED} (e.g., when the bottom bar 440 is docked). The dock 480 may comprise a base portion 482 that may be located adjacent to the rear surface 434 of the covering material 430 (e.g., adjacent to the window) at the first end 411 of the roller tube 412. The bottom bar 440 may be configured to be positioned adjacent to the base portion 482 of the dock when the covering material 430 is in the raised position P_{RAISED}, such that the energy storage elements 405 of the motor drive unit 450, for example, may discharge through the base portion 482 of the dock into the energy storage elements 445 of the bottom bar 440. The base portion 482 of the dock may define a contact surface 484 that may be configured to abut against the rear surface 446 of the bottom bar 440 when the bottom bar 440 is docked (e.g., when the covering material 430 is in the raised position P_{RAISED}). The contact surface 484 of the base portion 482 may be oriented at approximately the angle θ_{SC} from the vertical axis V (e.g., to match the rear surface 446 of the bottom bar 440).

The dock 480 may also comprise two or more electrical contacts 485 (e.g., two horizontally-oriented electrical contacts as in FIG. 14) located on a contact surface 484 of the base portion 482. The base portion 482 of the dock (e.g., the electrical contacts 485) may be electrically coupled to the motor drive unit 450, for example. For example, the base portion 482 of the dock may be electrically coupled to the motor drive unit 450 via two or more electrical conductors (e.g., wires) extending between the base portion 482 of the dock and the end portion 455 of the motor drive unit 450. The dock may further comprise an attachment member 486 that extends from the end portion 455 of the motor drive unit 450 to the base portion 482. The attachment member 486 may comprise a plate 487 and an arm 488 that is oriented at an angle (e.g., approximately 90°) from the plate 487 (e.g., to bend the attachment member 486 behind the rear surface 434 of the covering material 430). The electrical conductors that extend between the base portion 482 of the dock and the end portion 455 of the motor drive unit 450 may be located internal to or external to the attachment member 486. The plate 487 may comprise openings 489 through which the respective fasteners 424 may extend for coupling the window treatment assembly 410 to the first mounting bracket 420 (e.g., extending through the openings 456 in the first mounting bracket 420 and the openings 456 in the end portion 455 of the motor drive unit 450). For example, the attachment member 486 (e.g., the plate 487) may be affixed to and/or formed as a part of (e.g., integral with) the enclosure 452 and/or the end portion 455 of the motor drive unit 450. In some examples, the attachment member 486 may be affixed to and/or formed as a part of the first mounting bracket 420. For example, the dock 480 may be supported by the first mounting bracket 420. In addition, the dock 480 may be, for example, integral with the first mounting bracket 420 (e.g., the first mounting bracket 420 may comprise the dock 480). One will appreciate other configurations of the dock are possible.

The electrical contacts 485 of the dock 480 may be configured to contact respective electrical contacts 475 of the bottom bar 440 when the bottom bar 440 is docked (e.g., when the covering material 430 is in the raised position P_{RAISED}). For example, the electrical contacts 475 (e.g., two vertically-oriented electrical contacts) may be on the rear surface 446 of the bottom bar 440 (e.g., at the first end 441 of the bottom bar 440). Each of the electrical contacts 475 of the bottom bar 440 and the electrical contacts 485 of the dock may be, for example, an elongated conductive element (e.g., an uninsulated wire). The electrical contacts 475 of the bottom bar 440 and the electrical contacts 485 of the dock may be located next to each other (e.g., horizontally spaced apart from each other). For example, the electrical contacts 475 of the bottom bar 440 may be oriented vertically and the electrical contacts 485 of the dock may be oriented horizontally to facilitate electrical connection between the respective electrical contacts 475, 485 when the bottom bar 440 is docked. The electrical contacts 475 of the bottom bar 440 may be electrically connected to the energy storage elements 445 in the bottom bar 440, and the electrical contacts 485 of the dock may be electrically connected to the energy storage elements of the motor drive unit 450 for example (e.g. as indicated herein, such energy storage elements may part of the motor drive unit and/or external to the motor drive unit), such that that the energy storage elements 445 of the bottom bar 440 may charge from the energy storage elements 405 of the motor drive unit 440 when the bottom bar 440 is docked. For example, the electrical contacts 475 of the bottom bar 440 may be biased (e.g., spring-loaded) away from the rear surface 446 and/or the electrical contacts 485 of the dock may be biased (e.g., spring-loaded) away from the contact surface 484 to help establish and/or maintain the electrical contacts between the electrical contacts 475 of the bottom bar 440 and the electrical contacts 485 of the dock.

Alternatively, or additionally, the electrical contacts 475 may be located on different surfaces of the bottom bar 440, such as on one of the end caps 444. In such examples, the dock 480 and the electrical contacts 485 of the dock 480 may be positioned such that the electrical contacts 485 of the dock are aligned with the end cap 444 of the bottom bar 440.

The motor drive unit 450, for example, may be configured to charge the energy storage elements 445 of the bottom bar 440 (e.g., using energy from the energy storage element of the motor drive unit 450). Additionally, or alternatively, the control circuit of the motor drive unit 450, for example, may be configured to determine when to dock the bottom bar 440 (e.g., to position the bottom bar 440 such that the electrical contacts 485 of the dock 480 are in electrical communication with the electrical contacts 475 of the bottom bar 440). The control circuit of the motor drive unit 450 may be configured to determine to dock the bottom bar 440 in response to determining to charge the energy storage elements 445 of the bottom bar 440, for example based on a storage voltage of the energy storage element of the motor drive unit 450. Additionally, or alternatively, the control circuit 492 of the bottom bar module 490 may be configured to determine to charge the energy storage element 445 of the bottom bar 440 in response to the motor drive unit 450 determining to dock the bottom bar 440. In some examples, the energy storage elements 445 of the bottom bar 440 may be configured to charge from a solar cell of the sensor circuit 494 of the bottom bar module 490.

Although described in context of the motorized window treatment 400 comprising the bottom bar 440 and the motor drive unit 450 is configured to charge the bottom bar 440, the motorized window treatment 400 is not always so limited. In some examples, the motor drive unit 450 may not be configured to charge the bottom bar 440. For example, the bottom bar 440 may be powered from an external source and/or changeable batteries. Alternatively, or additionally, the bottom bar 440 may include one or more solar cells 496, and the energy storage element 445 in the bottom bar 440 may be configured to charge from the solar cell 496 between docking events and/or when docking is not possible. In some examples, the bottom bar 440 may not include the solar cell 496 and the energy storage elements 445 in the bottom bar 440 may not be configured to charge via the dock 480 (e.g., when there is a wired connection between the bottom bar 440 and the motor drive unit 450, such as the wired bus 356). Finally, in some examples, the motor drive unit may be configured to move the covering material 430 to the raised position P_{RAISED} if the motor drive unit 460 detects that the window is open (e.g., based on feedback from one or more sensors).

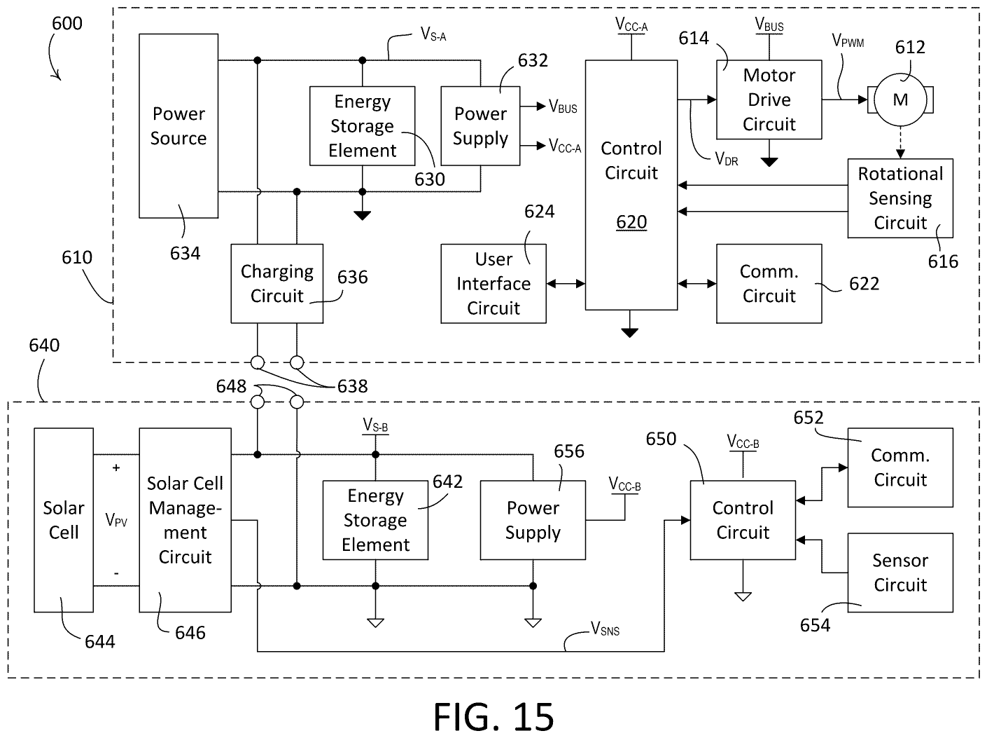

FIG. 15 is a simplified block diagram of a motorized window treatment control system 600 for controlling a motorized window treatment (e.g., the motorized window treatments 150 of the load control system 100, the motorized window treatment 200, and/or the motorized window treatment 400). The motorized window treatment may comprise a covering material (e.g., the covering material 152, 222, 430) that may be moved/raised and lowered for example, such as wound around a roller tube (e.g., the roller tubes 212, 412) and may extend to a bottom bar (e.g., the bottom bars 155, 226, 440). The motorized window treatment control system 600 may comprise a motor drive unit 610 (e.g., the motor drive units 156, the motor drive unit 218, and/or the motor drive unit 450) for moving/raising and lowering the covering material for example, such as rotating the roller tube for raising and lowering the covering material to adjust a present position P_{PRES} of the covering material (e.g., the bottom bar). The motor drive unit 610 may include a motor 612 (e.g., a direct-current motor) that may be coupled to the roller tube for rotating the roller tube. The motor drive unit 610 may include a motor drive circuit 614 (e.g., an H-bridge drive circuit) that receives a bus voltage V_{BUS} and may generate a pulse-width modulated (PWM) voltage V_{PWM} for driving the motor 612. For example, the motor drive circuit 614 may comprise an H-bridge drive circuit and/or an H-bridge controller (e.g., an integrated circuit) for controlling the H-bridge drive circuit to generate the PWM voltage V_{PWM} across the motor 612.

The motor drive unit 610 may include one or more control circuits 620 (e.g., a motor control circuit) for controlling the operation of the motor 612. The one or more control circuits 620 may include, for example, a microprocessor, a programmable logic device (PLD), a microcontroller, an application specific integrated circuit (ASIC), a field-programmable gate array (FPGA), or any suitable processing device or control circuit or combination thereof. The control circuit 620 may store and/or have access to instructions (e.g., software instructions) that configure the control circuit 620 to generate at least one drive signal VDR for controlling the motor drive circuit 614. The motor drive circuit 614 may be configured to control the rotational speed and the direction of rotation of the motor 612 in response to the drive signal VDR. The control circuit 620 may be configured to control the motor drive circuit 614 to rotate the motor 612 to adjust a present position P_{PRES} of the covering material (e.g., of the bottom bar). The motor drive unit 610 may be configured to control the covering material between a raised position P_{RAISED} (e.g., a fully-raised position and/or a fully-open position) and a lowered position P_{LOWERED} (e.g., a fully-lowered position and/or a fully-closed position). The covering material may be fully wound around the roller tube in the raised position P_{RAISED} and fully extended in the lowered position P_{LOWERED}. The control circuit 620 may be configured to set limits (e.g., an upper limit position PUP-LIMIT and a lower limit position PLO-LIMIT) for limiting a range across which the present position P_{PRES} of the covering material may be adjusted (e.g., to be less than a full range between the raised position P_{RAISED}) and lowered position P_{LOWERED}.

The motor drive unit 610 may comprise a memory (not shown), e.g., such as a non-volatile memory. The memory may be communicatively coupled to the control circuit 620 for the storage and/or retrieval of, for example, operational settings of the motor drive unit 610. In addition, the memory may be configured to store software for execution by the control circuit 620 to operate the motor drive unit 610 as described herein. The memory may be implemented as an internal circuit of the control circuit 620 or as an external integrated circuit (IC). The memory may comprise a computer-readable storage medium (e.g., a non-transitory computer readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit 620 may access the instructions from memory for being executed to cause the control circuit 620 to operate as described herein, or to operate one or more other devices as described herein. The memory may comprise computer-executable instructions for executing configuration software. In addition, the memory may have stored thereon one or more settings and/or control parameters associated with the motor drive unit 610. The control circuit 620 may store the present position of the covering material and/or limits for controlling the position of the covering material (e.g., the fully-raised position P_{RAISED} and/or the fully-lowered position P_{LOWERED}) in the memory. The control circuit 620 may be configured to store a record of a movement of the covering material each time that the control circuit 620 controls the motor 612 to adjust the present position P_{PRES} of the covering material.

The motor drive unit 610 may include a rotational position sensing circuit 616, such as, for example, a Hall effect sensor (HES) circuit, which may be configured to generate first and second rotational position sensing signals V_{S1}, V_{S2}. The first and second rotational position sensing signals V_{S1}, V_{S2} may indicate the rotational speed and/or the direction of rotation of the motor 612 to the control circuit 620. The rotational position sensing circuit 616 may include other suitable position sensors, such as, for example, magnetic, optical, and/or resistive sensors. The control circuit 620 may be configured to determine the rotational position of the motor 612 in response to the first and second rotational position sensing signals V_{S1}, V_{S2} generated by the rotational position sensing circuit 616. The control circuit 620 may be configured to determine the present position P_{PRES} of the covering material in response to the rotational position of the motor 612. The operation of a motor drive circuit and a rotational position sensing circuit of a motor drive unit is described in greater detail in U.S. Pat. No. 5,848,634, issued Dec. 15, 1998, entitled MOTORIZED WINDOW SHADE SYSTEM, and U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 610 may include one or more communication circuits 622 that may allow the control circuit 620 to transmit and receive messages (e.g., digital messages) via signals, e.g., wired signals and/or wireless signals, such as radio-frequency (RF) signals. For example, the control circuit 620 may be configured to communication messages via the RF signals using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WI-FI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). The communication circuit 622 may be implemented as an internal circuit of the control circuit 620 or as an external integrated circuit (IC).

The control circuit 620 may be configured to control the motor 612 to control the movement of the covering material in response to a shade movement command received in messages received via the communication circuit 622 from a remote control device. For example, the shade movement command may include a commanded position P_{CMD} to which the control circuit 620 will control the covering material. In addition, the control circuit 620 may be configured to receive messages from external devices. For example, the control circuit 620 may be configured to receive messages including indications of occupancy conditions and/or vacancy conditions in the space in which the motorized window treatment is installed from occupancy sensors and/or vacancy sensors, and messages including indications of an ambient light level in the space in which the motorized window treatment is installed form daylight sensors. Further, the control circuit 620 may be configured to transmit messages including a status of the motorized window treatment control system 600, such as the present position P_{PRES} of the covering material. During a configuration procedure (e.g., an association procedure), the motor drive unit 610 may be associated with a remote control device, such that the control circuit 620 may be responsive to the messages transmitted by the remote control device (e.g., via wireless signals).

The motor drive unit 610 may include a user interface 624 having one or more buttons, for example, that allow a user to provide inputs to the control circuit 620 during setup and/or configuration of the motorized window treatment. The control circuit 620 may be configured to control the motor 612 to control the movement of the covering material in response to a shade movement command received via the communication circuit 622 and/or the user inputs received via the buttons of the user interface 624. The user interface 624 may also include one or more light-emitting diodes (LEDs) that may be illuminated by the control circuit 620, for example, to provide feedback to a user of the motorized window treatment.

The motor drive unit 610 may include one or more sensor circuits (not shown) coupled to the control circuit 620. For example, the sensor circuit may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 620 may be configured to control the motor 612 to control the movement of the covering material in response to the daylight level L_{DL} and/or the ambient light level L_{AMB} indicated by the sensor circuit. In addition and/or alternatively, the sensor circuit may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 620 of the motor drive unit 610 may be configured to control the motor 612 to control the movement of the covering material in response to the occupancy condition and/or a vacancy condition detected by the occupancy detection circuit.

The electrical circuitry of the motor drive unit 610 may be powered from a first storage voltage V_{S-A} produced across an energy storage element 630 that may be part of the motor drive unit 610. For example, the energy storage element 630 may comprise one or more individual storage elements electrically coupled in parallel. The individual storage elements of the energy storage element 630 may comprise, for example, one or more one or more of batteries (e.g., rechargeable batteries) and/or capacitors (e.g., supercapacitors). In some examples, the energy storage element 630 may be external to the motor drive unit 610 (e.g., external to an enclosure of the motor drive unit 610, such as the enclosure 252 of the motor drive unit 218). The motor drive unit 610, for example, may comprise a power source 634 configured to receive the first storage voltage V_{S-A} and generate one or more supply voltages for powering the electrical circuitry of the motor drive unit 610. For example, the power source 634 may be configured to generate a low-voltage supply voltage V_{CC-A} for powering the control circuit 620, the memory, the communication circuit 622, and/or the user interface circuit 624 and/or other circuitry. In addition, the power source 634 may be configured to generate the bus voltage V_{BUS} for powering the motor drive circuit 614. In some examples, the motor drive circuit 614 may be configured to be powered directly from the first storage voltage V_{S-A} produced across the energy storage element 630.

The power source may also be external to the motor drive unit. For example, the power source 634 may comprise, for example, one or more solar cells (e.g., photovoltaic cells, such as the solar cells 390, 470). The solar cells of the power source 634 may be configured to convert received solar energy into a photovoltaic output voltage. The power source 634 may also comprise a solar cell management circuit (not shown) configured to charge the energy storage element 630 from the solar cells for producing the first storage voltage V_{S-A} across the energy storage element 630. The solar cell management circuit may be configured to control the charging of the energy storage element 630. For example, the solar cell management circuit may comprise a boost converter for generating the first storage voltage V_{S-A} from the photovoltaic output voltage. The solar cell management circuit may include, for example, a maximum power point tracking (MPPT) solar charge controller. In some examples, the power source 634 may comprise one or more batteries. In addition, the power source 634 may also be configured to receive power from an external power source, such as an external direct-current (DC) power source or an alternating-current (AC) power source. While the motor drive unit 610 is described as having one or more control circuits 620 and one or more communication circuits 622 that are configured to operate as described herein, the motorized window treatment control system 600 may include additional control circuits and/or communication circuits (other than those of bottom bar module 640) that are part of the motor drive unit 610 and/or external to the motor drive unit 610 (such as located on a dock, for example), that may communicate with control circuit 620 and/or communication circuit 622, and/or communicate with circuitry of bottom bar module 640, and that may execute instructions that configure these control circuits and communication circuits to execute procedures and/or routines as described herein, either separate from or in conjunction with control circuit(s) 620 and/or communication circuit(s) 622. For description purposes only, procedures and/or routines described herein may be described as control circuit(s) and communication circuit(s) of the motor drive unit performing such procedures and/or routines. In addition, for description purposes only, procedures and/or routines described herein may be described as performed by a single control circuit and/or single communication circuit of the motor drive unit but may be performed by multiple control circuits and/or communication circuits.

The motorized window treatment control system 600 may further comprise a bottom bar module 640 that may be located in or on and/or proximate to the bottom bar or any combination thereof (e.g., such as the bottom bar modules 350, 490). For example, the electrical circuitry of the bottom bar module 640 may be mounted to one or more printed circuit boards (e.g., the printed circuit board 272) that may be located in or on and/or proximate to the bottom bar or any combination thereof (i.e., control circuit(s) 650, communication circuit(s) 652, sensor circuit(s) 654, energy storage element 642, power supply 656, solar cell management circuit 646, and/or solar cell(s) 644 etc. as described herein may be located in or on and/or proximate to the bottom bar or any combination). The bottom bar module 640 may include one or more control circuits 650 (e.g., a bottom bar control circuit), which may include, for example, a microprocessor, a programmable logic device (PLD), a microcontroller, an application specific integrated circuit (ASIC), a field-programmable gate array (FPGA), or any suitable processing device or control circuit and/or combination thereof. For description purposes only, procedures and/or routines described herein may be described as performed by a single control circuit and/or single communication circuit of the bottom bar module but may be performed by multiple control circuits and/or communication circuits of the bottom bar module.

The bottom bar module 640 may include an energy storage element 642 that may store a second storage voltage V_{S-B}. The energy storage element 642 of the bottom bar module 640 may, for instance, comprise one or more individual storage elements electrically coupled in parallel. The individual storage elements of the energy storage element 642 may comprise, for example, one or more of batteries (e.g., rechargeable batteries) and/or capacitors (e.g., supercapacitors). The bottom bar module 640 may also comprise a power supply 656 configured to receive the second storage voltage V_{S-B} and generate a low-voltage supply voltage V_{CC-B} for powering the control circuit 650 and other low-voltage circuitry of the bottom bar module 640.

In some examples, the energy storage element 642 of the bottom bar module 640 may be configured to charge from the motor drive unit 610 for example (e.g., from the energy storage element 630 that may be part of the motor drive unit 610). For example, the bottom bar module 640 may comprise electrical connections 648 configured to be coupled to (e.g., electrically and/or inductively coupled to) electrical connections of a dock for example, and to electrical connections 638 of the motor drive unit 610, for example, via the dock. For example, the electrical connections 638 of the motor drive unit 610 may represent the electrical contacts 485 of the dock 480. In addition, the electrical connections 648 of the bottom bar module 640 may represent the electrical contacts 475 of the bottom bar 440. In some examples, the motor drive unit 610 and the bottom bar module 640 may not comprise the respective electrical connections 638, 648, but may alternatively comprise respective induction coils to facilitate inductive coupling (e.g., magnetic coupling) between the bottom bar module 640 and the motor drive unit 610. When the covering material is in the raised position P_{RAISED} (e.g., when the bottom bar is docked), the electrical connections 648 of the bottom bar module 640 may be coupled to (e.g., electrically and/or inductively coupled to) the electrical connections 638 of the motor drive unit 610 for example, such that the energy storage element 642 of the bottom bar module 640 is configured to charge from the energy storage element 630 of the motor drive unit 610, for example, via a charging circuit 636 of the motor drive unit 610. While the charging circuit 636 is shown in FIG. 15 as a part of the motor drive unit 610, the charging circuit 636 could alternatively or additionally be included in the bottom bar module 640, be included in the dock, etc.

In some examples, the energy storage element 642 of the bottom bar module 640 may additionally and/or alternatively be configured to charge from one or more solar cells 644 that are located on and/proximate to the bottom bar module 640 (e.g., such as the solar cell 496). The solar cell 644 may be configured to convert received solar energy into a photovoltaic output voltage V_{PV}. The bottom bar 640 may also comprise a solar cell management circuit 646 configured to charge the energy storage element 642 from the solar cell 644 for producing the second storage voltage V_{S-B} across the energy storage element 642. The solar cell management circuit 646 may be configured to control the charging of the energy storage element 642. For example, the solar cell management circuit 646 may comprise a boost converter for generating the second storage voltage V_{S-B} from the photovoltaic output voltage of the solar cell of the sensor circuit 654. The solar cell management circuit 646 may include, for example, a maximum power point tracking (MPPT) solar charge controller. The solar cell management circuit 646 may be characterized by a duty cycle DC_{SCM} for driving a transistor of the boost converter circuit to generate the second storage voltage V_{S-B} from the photovoltaic output voltage of the solar cell of the sensor circuit 654. The solar cell management circuit 646 may be configured to adjust the duty cycle DC_{SCM} to track a maximum power point for charging the energy storage element 642.

The control circuit 650 of the bottom bar module 640 may be configured to receive one or more sense signals V_{SNS} from the solar cell management circuit 646. The one or more sense signals V_{SNS} received from the solar cell management circuit 646 may indicate, for example, a magnitude of the photovoltaic output voltage V_{PV} generated by the solar cell 644 and/or a magnitude of the second storage voltage V_{S-B} generated across the energy storage element 642. For example, the one or more sense signals V_{SNS} generated by the solar cell management circuit 646 may comprise direct-current (DC) signals having magnitudes that indicate the magnitude of the photovoltaic output voltage V_{PV} and/or the magnitude of the second storage voltage V_{S-B} (e.g., the solar cell management circuit 646 may comprise one or more resistive divider circuits for generating the one or more sense signals V_{SNS}). In addition, the one or more sense signals V_{SS} generated by the solar cell management circuit 646 may comprise messages (e.g., digital messages) including indications of the magnitude of the photovoltaic output voltage V_{PV} and/or the magnitude of the second storage voltage V_{S-B}.

The bottom bar module 640 may comprise a memory (not shown), e.g., such as a non-volatile memory. The memory may be communicatively coupled to the one or more control circuits 650 for the storage and/or retrieval of, for example, operational settings of the bottom bar module 640. In addition, the memory may be configured to store software for execution by the one or more control circuits 650. The memory may be implemented as an internal circuit of the control circuit(s) 650 or as an external integrated circuit (IC). The memory may comprise a computer-readable storage medium (e.g., a non-transitory computer readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit(s) 650 may access the instructions from memory for being executed to cause the control circuit 650 to operate as described herein, or to operate one or more other devices as described herein. The memory may comprise computer-executable instructions for executing configuration software. In addition, the memory may have stored thereon one or more settings and/or control parameters associated with the motor drive unit 610. The control circuit(s) 650 may store measurements (e.g., the magnitude of the photovoltaic output voltage V_{PV} and/or the magnitude of the second storage voltage V_{S-B}) in the memory.

The bottom bar module 640 may include one or more communication circuits 652 that may allow the control circuit 650 to communicate messages (e.g., digital messages) with the communication circuit 622 of the motor drive unit 610, for example, via a communication link, such as a wired communication link and/or a wireless communication link, e.g., a radio-frequency (RF) communication link. The control circuit 650 of the bottom bar module 640 may be configured to communicate messages with the control circuit 620 of the motor drive unit 610, for example, via RF signals using a short-range wireless communication protocol (e.g., the BLUETOOTH LOW ENERGY (BLE) protocol, the Thread wireless communication protocol, etc.). In addition, the communication circuit 622 of the motor drive unit 610 and the communication circuit 652 of the bottom bar module 640 may be coupled together via a wired communication link, for example, when the bottom bar is docked. For example, the communication circuit 622 of the motor drive unit 610 may be coupled to the electrical connections 638 and the communication circuit 652 of the bottom bar module 640 may be coupled to the electrical connections 648, such that the communication circuits 622, 652 are configured to communicate with each other via the electrical connections 638, 648 when the bottom bar is docked. In addition, the motor drive unit 610 and/or the bottom bar module 640 may comprise additional electrical connections to allow the communication circuits 622, 652 to communicate with each other via the wired communication link.

The control circuit 650 of the bottom bar module 640 may be configured to transmit messages including measurements recorded by the bottom bar module 640 and/or one or more operational characteristics of the bottom bar module 640 via the communication circuit 652. For example, the control circuit 650 of the bottom bar module 640 may be configured to transmit a message including an indication of a measurement of the magnitude of the photovoltaic output voltage V_{PV} generated by the solar cell 644 and/or an indication of a measurement of the magnitude of the second storage voltage V_{S-B} generated across the energy storage element 642 to the control circuit 620 of the motor drive unit 610 via the communication circuit 622. In addition, the control circuit 650 of the bottom bar module 640 may be configured to transmit a message that includes an indication of an operational characteristic of the solar cell management circuit 646, such as the duty cycle DC_{SCM} of the solar cell management circuit 646.

The bottom bar module 640 may include one or more sensor circuits 654 communicatively coupled to the control circuit 650. For example, the sensor circuit 654 may comprise a photosensor and/or a solar cell (e.g., a photovoltaic cell) configured to generate a signal that indicates a light level, such as a daylight level L_{DL} outside the window that the motorized window treatment is covering and/or an ambient light level L_{AMB} inside the space in which the motorized window treatment is located. The control circuit 650 of the bottom bar module 640 may be configured to transmit a message including the daylight level L_{DL} and/or the ambient light level L_{AMB} indicated by the sensor circuit 654 to the motor drive unit 610.

In some additional or alternative examples, the solar cell of the sensor circuit 654 may be the solar cell 644 of the bottom bar module 640, such that the energy storage element 642 is able to charge from the solar cell 644 and the sensor circuit 654 is able to generate the signal that indicates the daylight level L_{DL} outside the window that the motorized window treatment is covering in response to the solar cell 644 of the bottom bar module 640. For example, the sensor circuit 654 may not include an additional photosensor and/or a solar cell (e.g., a photovoltaic cell). The solar cell 644 of the sensor circuit 654 may generate the signal that indicates the light level, such as a daylight level L_{DL} outside the window that the motorized window treatment is covering and/or an ambient light level L_{AMB} inside the space in which the motorized window treatment is located. Additionally or alternatively, the solar cell management circuit 646 may be configured to charge the energy storage element 642 from the solar cell 644 of the sensor circuit 654 to produce the second storage voltage V_{S-B} across the energy storage element 642.

In addition or alternatively, the one or more sensor circuits 654 may comprise one or more orientation detection sensors, such as an accelerometer and/or a gyroscope. For example, the control circuit 650 of the bottom bar module 640 may be configured to determine when the motor drive unit 610 is adjusting the present position P_{PRES} (e.g., the bottom bar is moving) in response to the accelerometer and/or the gyroscope of the sensor circuit 654. The control circuit 650 may be configured to determine to transmit a message, for example via communication circuit 652, that indicates one or more of the (e.g., first) position of the (e.g., first) end of the bottom bar, the (e.g., second) position of the (e.g., second) end of the bottom bar, and/or the threshold distance. The control circuit 650 may be configured to transmit the message, for example via the communication circuit 652, to the motor drive unit 610 (e.g., communication circuit 622 of the motor drive unit 610). The control circuit 620 of the motor drive unit 610 may be configured to determine whether the (e.g., first) position of the (e.g., first) end of the bottom bar exceeds the threshold distance from the (e.g., second) position of the (e.g., second) end of the bottom bar, for example based at least partially on the message.

In addition or alternatively, the one or more sensor circuits 654 may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 650 of the bottom bar module 640 may be configured to transmit a message including an indication of an occupancy condition and/or a vacancy condition to the motor drive unit 610.

The control circuit 620 of the motor drive unit 610 may be configured to control the motor drive 614 to move the covering material to the raised position P_{RAISED}, such that the bottom bar is docked and the electrical connections 648 of the bottom bar module 640 may be coupled to (e.g., electrically and/or inductively coupled to) the electrical connections 638 of the motor drive unit 610. When the control circuit 620 is moving the covering material to dock the bottom bar, the control circuit 620 may control the covering material through a docking movement (e.g., a docking sequence) as the bottom bar nears the dock. For example, the control circuit 620 may ramp down a rotational speed at which the motor is rotating as the bottom bar nears the dock.

The control circuit 620 of the motor drive unit 610 and/or the control circuit 650 of the bottom bar module 640 may be configured to determine that the bottom bar is docked by determining if the electrical connections 638 of the motor drive unit 610 are electrically connected to the electrical connections 648 of the bottom bar module 640. For example, the control circuit 620 of the motor drive unit 610 may be configured to determine that the bottom bar is docked by detecting that the second supply voltage V_{S-B} is present at the electrical connections 638. In addition, the control circuit 650 of the bottom bar module 640 may be configured to determine that the bottom bar is docked by detecting that the motor drive unit 610 is sourcing current to the energy storage element 642 of the bottom bar module 640 via the electrical connections 648. Further, the control circuit 610 of the motor drive unit 610 may be configured to determine that the bottom bar is docked in response to receiving a message from the control circuit 650 of the bottom bar module 640, and/or the control circuit 650 of the bottom bar module 640 may be configured to determine that the bottom bar is docked in response to receiving a message from the control circuit 620 of the motor drive unit 610. The control circuit 620 of the motor drive unit 610 may be configured to transmit a query message to the control circuit 650 of the bottom bar module 640, and the control circuit 650 of the bottom bar module 650 may be configured to transmit a response to the query message to the control circuit 620 of the motor drive unit 610. For example, the control circuit 620 of the motor drive unit 610 may be configured to transmit the query message to the bottom bar module 650 via a wired communication link (e.g., via the electrical connections 626, 648 and/or via separate electrical connections on the dock) and/or via a wireless communication link (e.g., where the query message may indicate that the bottom bar is docked).

The control circuit 620 of the motor drive unit 610 may be configured to determine when to charge the energy storage element 642 of the bottom bar 640. For example, the control circuit 620 of the motor drive unit 610 may be configured to determine (e.g., automatically determine) when the motor drive unit 610 should dock the bottom bar (e.g., move the covering material to the raised position P_{RAISED}) to charge the energy storage element 642 of the bottom bar module 640 from the energy storage element 630 of the motor drive unit 620. When the control circuit 620 of the motor drive unit 610 determines to charge the energy storage element, the control circuit 620 may adjust the covering material to the raised position to locate the bottom bar adjacent to the dock. For example, the control circuit 620 of the motor drive unit 610 may be configured to determine that the bottom bar should be docked when the magnitude of the second storage voltage V_{S-B} produced across the energy storage element 642 drops too low (e.g., is less than a low-charge threshold V_{TH-LC}). The control circuit 620 of the motor drive unit 610 may move (e.g., automatically move) the covering material to the raised position P_{RAISED} when the magnitude of the second storage voltage V_{S-B} drops below the low-charge threshold V_{TH-LC}. For example, the control circuit 620 may be configured to receive a message (e.g., via communication circuit 622) comprising an indication of the magnitude of the second storage voltage V_{S-B} from the control circuit 650 via communication circuit 652 of the bottom bar module 640. Although described in context of storage voltages, the control circuit 620 of the motor drive unit 610 may be configured to determine whether or not the bottom bar should be docked (e.g., whether to charge the energy storage element 642 of the bottom bar module 640) based on the state of charge of the energy storage elements of the motorized window treatment, for instance, when the state of charge of the energy storage element 642 falls below a threshold. The control circuit 620 may be configured to determine the state of charge of the energy storage element 642 of the bottom bar 640 based on the second storage voltage V_{S-B}. For example, the control circuit 620 may be configured to receive a message (e.g., via communication circuit 622) comprising an indication of the magnitude of the second storage voltage V_{S-B} as an indication of the state of charge of the energy storage element 642 from the control circuit 650 and communication circuit 652 of the bottom bar module 640. The control circuit determining to charge the energy storage element may be based on the control circuit determining to dock the bottom bar as described herein.

In addition, the control circuit 650 of the bottom bar module 640 may be configured to determine that the bottom bar should be docked when the magnitude of the first storage voltage V_{S-A} produced across the energy storage element 630 is greater than a high-charge threshold V_{TH-HC}. The control circuit 620 of the motor drive unit 610 may be configured to move the covering material to the raised position P_{RAISED} in response to determining that the magnitude of the first storage voltage V_{S-A} produced across the energy storage element 630 is greater than a high-charge threshold V_{TH-HC}.

The control circuit 620 of the motor drive unit 610 may be configured to determine when to dock the bottom bar to charge the energy storage element 642 of the bottom bar 640 in response to occupancy conditions or vacancy conditions in the space in which the motorized window treatment is located. The control circuit 620 may receive messages including indications of occupancy conditions and/or vacancy conditions in the space from control circuit 650 of the bottom bar module 650 (e.g., as determined by the sensor circuit 654) and/or from external occupancy sensors. For example, the control circuit 620 may be configured to dock the bottom bar when the control circuit 620 has determined that the bottom bar should be docked (e.g., when the magnitude of the first storage voltage V_{S-A} has risen below the high-charge threshold V_{TH-HC}) and when (e.g., only when) the space is vacant. In addition, the control circuit 620 may be configured to dock the bottom bar when the control circuit 620 has determined that the bottom bar should be docked (e.g., when the magnitude of the second storage voltage V_{S-B} has dropped below the low-charge threshold V_{TH-LC}) and when (e.g., only when) the space is vacant. In some examples, the control circuit 620 may be configured to dock the bottom bar when the space is occupied, but the magnitude of the second storage voltage V_{S-B} has dropped below a critical-charge threshold V_{TH-CRIT} (e.g., which may be smaller than the low-charge threshold V_{TH-LC}). Further, in some examples, the control circuit 620 may use the status of one or more lighting loads as a proxy or indicator that the space is occupied or vacant. For instance, the control circuit may determine that the space is occupied when the lighting loads are on, and determine that the space is vacant when the lighting loads are off. Alternatively or additionally, the control circuit 620 may determine that the space is occupied or vacant based on external feedback, such as indications as to whether a meeting is scheduled for the space. For instance, the control circuit 620 may receive data from one or more calendar programs (e.g., such as Microsoft® Outlook®), and may determine that the space is vacant based on there not being a meeting scheduled for the space at a particular day and time.

The control circuit 620 of the motor drive unit 610 may be configured to determine when to dock the bottom bar to charge the energy storage element 642 of the bottom bar 640 in response to the present day of the week and/or the time of the day. For example, the control circuit 620 may be configured to not dock the bottom bar during a nighttime period (e.g., during a privacy mode, which may be between sunset and sunrise), for example, to maintain the covering material at a lowered position P_{LOWER} to provide privacy for occupants of the space. In addition, the control circuit 620 may be configured to dock the bottom bar at a predetermined docking time. For example, the motor drive unit 610 (e.g., the control circuit 620) may comprise a timeclock for keeping track of the day of the week and/or the time of the day. In addition, the control circuit 620 may be configured to determine the present day of the week and/or the time of the day from messages received via the communication circuit 622 (e.g., from the Internet). Further, the control circuit 650 of the bottom bar 640 may be configured to estimate the time of the day in response to the sensor circuit 654. For example, the control circuit 650 may be configured to determine that the present time of the day is during the nighttime period when the ambient light level L_{AMB} indicated by the sensor circuit 654 is less than a nighttime threshold LTH-NIGHT, and may transmit a message indicating that the present time of the day is during the nighttime period to the motor drive unit 610. The control circuit 620 may be configured to dock the bottom bar 640 weekly (e.g., based on a weekly schedule).

The control circuit 620 of the motor drive unit 610 may be configured to determine when to charge the energy storage element 642 of the bottom bar 640 based on a light level, such as the daylight level L_{DL} outside the window that the motorized window treatment is covering and/or an ambient light level L_{AMB} inside the space in which the motorized window treatment is located. The control circuit 620 may be configured to control the motor 612 to dock the bottom bar 640 to charge the energy storage element 642 of the bottom bar 640 in response to the daylight level L_{DL} and/or the ambient light level L_{AMB} indicated by the sensor circuit 654. The control circuit 620 may receive an indication of the light level, via the communication circuit 622, for example from the control circuit 650 via the communication circuit 652 of the bottom bar 640.

Further, in some examples, the control circuit 620 of the motor drive unit 610 may be configured to schedule one or more docking events (e.g., period and/or reoccurring docking events) based on occupancy and/or vacancy information for the space. The control circuit 620 may be configured to determine the occupancy and vacancy of the space over time, for instance, based on the occupancy or vacant messages received from one or more occupancy or vacancy sensors. As noted herein, the control circuit 620 may receive messages including indications of occupancy conditions and/or vacancy conditions in the space from the control circuit 650 of the bottom bar module 650 (e.g., as determined by the sensor circuit 654) and/or from external occupancy sensors. For instance, the control circuit 620 may determine, over time, that the space is vacant at certain days and/or times (e.g., Sundays from 8-10 am), and may schedule a docking event for those days/times. Further, in some examples, the control circuit 620 may use the status of one or more lighting loads as a proxy or indicator that the space is occupied or vacant. For instance, the control circuit 620 may determine that the space is occupied when the lighting loads are on, and determine that the space is vacant when the lighting loads are off. In some examples, the control circuit 620 may determine that the space is vacant on certain days and/or times (e.g., Sundays from 8-10 AM) based on the lighting loads within the space consistently being off during those days and/or times, and may schedule a docking event for those days/times. Alternatively or additionally, the control circuit 620 may determine that the space is occupied or vacant based on external feedback, such as indications as to whether a meeting is scheduled for the space. For instance, the control circuit 620 may receive data from one or more calendar programs (e.g., such as Microsoft® Outlook®), and may determine that the space is vacant based on there not being a meeting scheduled for the space at a particular day and time.

The control circuit 620 of the motor drive unit 610 may be configured to schedule one or more charging events (e.g., period and/or reoccurring charging events) based on occupancy and/or vacancy information for the space. A charging event may include the control circuit 620 determining to charge the energy storage element 642 of the bottom bar 640 and/or commanding a charging circuit 636 of the motor drive unit 610 to charge the energy storage element 642 of the bottom bar 640. The control circuit 620 may be configured to determine the occupancy and vacancy of the space over time, for instance, based on the occupancy or vacant messages received from one or more occupancy or vacancy sensors. As noted herein, the control circuit 620 may receive messages including indications of occupancy conditions and/or vacancy conditions in the space from the control circuit 650 of the bottom bar module 650 (e.g., as determined by the sensor circuit 654) and/or from external occupancy sensors. For instance, the control circuit 620 may determine, over time, that the space is vacant at certain days and/or times (e.g., Sundays from 8-10 AM), and may schedule a charging event for those days/times. Further, in some examples, the control circuit 620 may use the status of one or more lighting loads as a proxy or indicator that the space is occupied or vacant. For instance, the control circuit 620 may determine that the space is occupied when the lighting loads are on, and determine that the space is vacant when the lighting loads are off. In some examples, the control circuit 620 may determine that the space is vacant on certain days and/or times (e.g., Sundays from 8-10 am) based on the lighting loads within the space consistently being off during those days and/or times, and may schedule a charging event for those days/times. Alternatively, or additionally, the control circuit 620 may determine that the space is occupied or vacant based on external feedback, such as indications as to whether a meeting is scheduled for the space. For instance, the control circuit 620 may receive data from one or more calendar programs (e.g., such as Microsoft® Outlook®), and may determine that the space is vacant based on there not being a meeting scheduled for the space at a particular day and time.

In addition, the control circuit 620 of the motor drive unit 610 may be configured to determine when to dock the bottom bar to charge the energy storage element 642 of the bottom bar 640 in response to one or more other factors. For example, after determining the control circuit 620 should dock the bottom bar (e.g., based on the magnitude of the first storage voltage V_{S-A}, the magnitude of the second storage voltage V_{S-B}, the occupancy or vacancy status of the space, and/or the present day of the week and/or the time of the day), the control circuit 620 may also consider one or more factors to determine if the control circuit 620 should dock the bottom bar. For example, the control circuit 620 may determine whether or not to dock the bottom bar based on the position of the sun, for example, if the sun is not shining on a façade on which the motorized window treatment 600 is installed, for instance, to take advance of instances where the motorized window treatment 600 does not need to block direct sunlight from entering the space in which the motorized window treatment is installed. In addition, the control circuit 620 may determine whether or not to dock the bottom bar based on weather information (e.g., temperature, cloud coverage, precipitation, barometric pressure, etc.). For example, the control circuit 620 may determine to dock the bottom bar if it is cloudy, for instance, to take advance of instances where the motorized window treatment 600 does not need to block direct sunlight from entering the space in which the motorized window treatment is installed. The control circuit may determine whether or not to dock the bottom bar based on feedback from a photosensor of the sensor circuits of the motor drive unit 610. For example, the control circuit 620 may determine to dock the bottom bar if there is less daylight as indicated by the sensor circuit 654 of the bottom bar module 610 and/or a photosensor of the motor drive unit 610, for instance, to take advance of instances where the motorized window treatment 600 does not need to block direct sunlight from entering the space in which the motorized window treatment is installed.

The control circuit 620 of the motor drive unit 610 and/or the control circuit 650 of the bottom bar module 640 may be configured to measure and/or collect solar data regarding the operation of the motorized window treatment control system 600. For example, the control circuit 620 of the motor drive unit 610 and/or the control circuit 650 of the bottom bar module 640 may be configured to measure and/or collect solar data. The solar data may comprise one or more measurements recorded by the motor drive unit 610 and/or the bottom bar module 640, and/or one or more operational characteristics of the motor drive unit 610 and/or the bottom bar module 640. For example, the control circuit 650 of the bottom bar module 640 may be configured to measure and/or collect the solar data using the solar cell 644 of the bottom bar module 640 and/or the solar cell of the sensor circuit 654. The measurements included in the solar data may comprise, for example, measurements of the magnitude of the photovoltaic output voltage V_{PV} of the solar cell 644 and/or a photovoltaic output voltage of the solar cell of the sensor circuit 654 of the bottom bar module 640, the magnitude of the first storage voltage V_{S-A}, the magnitude of the second storage voltage V_{S-B}, and/or the daylight level L_{DL} as measured by a photosensor of the sensor circuit 654. For example, the operational characteristics included in the solar data may comprise the duty cycle DC_{SCM} and/or other operational characteristics of the solar cell management circuit 646 for charging the energy storage element 642 from the solar cell 644 of the bottom bar module 640. The solar data may also comprise tracking information associated with each of the measurements and/or operational characteristics. For example, the tracking information may include timing information (e.g., a time stamp indicating a time at which the respective measurement and/or operational characteristic was recorded) and/or position information (e.g., the present position P_{PRES} of the covering material at the time at which the respective measurement and/or operational characteristic was recorded).

The control circuit 620 of the motor drive unit 610 and/or the control circuit 650 of the bottom bar module 640 may be configured to determine a solar power P_{SOLAR} (e.g., as received by the solar cell 644 of the bottom bar module 640 and/or the solar cell of the sensor circuit 654). For example, the control circuit 620 of the motor drive unit 610 and/or the control circuit 650 of the bottom bar module 640 may be configured to determine the solar power P_{SOLAR} with respect to the position P_{CM} of the covering material (e.g., determine a relationship between the solar power P_{SOLAR} and the position Pc of the covering material). The control circuit 620 of the motor drive unit 610 and/or the control circuit 650 of the bottom bar module 640 may be configured to calculate the solar power P_{SOLAR} using the solar data. For example, the control circuit 620 of the motor drive unit 610 and/or the control circuit 650 of the bottom bar module 640 may be configured to calculate the solar power P_{SOLAR} as a function of the magnitude of the photovoltaic output voltage V_{PV} of the solar cell 644 of the bottom bar module 640 and/or the photovoltaic output voltage of the solar cell of the sensor circuit 654, the magnitude of the second storage voltage V_{S-B}, and/or the duty cycle DC_{SCM} of the solar cell management circuit of the bottom bar module 640. In some examples, the control circuit 620 of the motor drive unit 610 may be configured to calculate the solar power P_{SOLAR} as a function of the daylight level L_{DL} indicated by the sensor circuit 654 to the motor drive unit 610 (e.g., as indicated by a photosensor of the sensor circuit 654). The control circuit 620 of the motor drive unit 610 and/or the control circuit 650 of the bottom bar module 640 may be configured to determine the solar power P_{SOLAR} at each of a plurality of intermediate positions between the raised position P_{RAISED} and the lowered position P_{LOWERED}. The control circuit 620 of the motor drive unit 610 and/or the control circuit 650 of the bottom bar module 640 may be configured to store data defining the relationship between the solar power P_{SOLAR} and the position P_{CM} of the covering material in the solar data.

When the communication circuit 652 of the bottom bar module 640 is configured to communicate with the communication circuit 622 of the motor drive unit 610 via a communication link (e.g., via RF signals using a short-range wireless communication protocol), the control circuit 650 of the bottom bar module 650 may be configured to periodically transmit the solar data (e.g., one or more measurements and/or operational characteristics) to the control circuit 620 of the motor drive unit 610 at a transmission rate T_{TX}. In some examples, the communication link between the control circuit 620 of the motor drive unit 610 and the control circuit 650 of the bottom bar module 650 may be a one-way communication link (e.g., from the control circuit 650 of the bottom bar module 650 to the control circuit 620 of the motor drive unit 610) to facilitate reporting of the solar data to the control circuit 620 of the motor drive unit 610. In some examples, the communication circuit 652 of the bottom bar module 640 may be configured to communicate with the communication circuit 622 of the motor drive unit 610 via a wired or wireless communication link (e.g., as described herein). The control circuit 620 of the motor drive unit 610 may be configured to store the solar data received from the control circuit 650 of the bottom bar module 650 in the memory of the motor drive unit 610. For each of the measurements and/or operational characteristics of the solar data, the control circuit 620 of the motor drive unit 610 may be configured to add to the solar data a respective position P_{DATA} of the covering material at the time at which the solar data was received. In some examples, the control circuit 650 may be configured to adjust the transmission rate T_{TX} of the communication circuit 652 based on the magnitude of the second storage voltage V_{S-B} across the energy storage element 642. For example, the control circuit 650 may be configured to decrease the transmission rate T_{TX} when the magnitude of the second storage voltage V_{S-B} is high, such that the control circuit 650 transmits the solar data at a higher rate when the magnitude of the second storage voltage V_{S-B} is high than when the magnitude of the second storage voltage V_{S-B} is low.

When the communication circuit 622 of the motor drive unit 610 is configured to communicate with the communication circuit 652 of the bottom bar module 610 via a wired communication link (e.g., via the electrical connections 648, 638 when the bottom bar is docked), the control circuit 650 of the bottom bar module 640 may be configured to collect and store the solar data in the memory of the bottom bar module 640, and then transmit the solar data to the communication circuit 622 and control circuit 620 of the motor drive unit 610 via the wired communication link when the bottom bar is docked. Since the control circuit 650 of the bottom bar module 640 may not have access to the present position P_{PRES} of the covering material (e.g., which is maintained by the control circuit 620 of the motor drive unit 610), the control circuit 650 may be configured to store in the solar data timing information (e.g., a time stamp indicating a time at which the respective measurement and/or operational characteristic was recorded). After receiving the solar data from the control circuit 650 of the bottom bar module 640, the control circuit 620 of the motor drive unit 610 may determine a respective position P_{DATA} of the covering material for each of the measurements and/or operational characteristics of the solar data by comparing the respective time stamp with the record of movements of the covering material that are stored in the memory of the motor drive unit 610. In some examples, the control circuit 650 of the bottom bar module 640 may be configured to estimate the present position P_{PRES} of the covering material in response to the accelerometer and/or the gyroscope of the sensor circuit 654 and add to the solar data a respective position P_{DATA} of the covering material at the time at which the measurement and/or operational characteristic was recorded.

The control circuit 650 of the bottom bar module 640 may be configured to record the measurements and/or operational characteristics of the solar data at a timing interval T_{TIM}. For example, the transmission rate T_{TX} of the communication circuit communication circuit 652 may be equal to the timing interval T_{TIM}, such the control circuit 650 is configured to record the measurements and/or operational characteristics of the solar data and/or transmit the measurements and/or operational characteristics of the solar data at the same time (e.g., at the timing interval T_{TIM}). The control circuit 650 may be configured to set the timing interval T_{TIM} based on whether the covering material is moving or not. For example, the control circuit 650 may be configured to increase the timing interval T_{TIM} when the covering material is not moving and decrease the timing interval T_{TIM} when the covering material is moving. The control circuit 650 may be configured to set the timing interval T_{TIM} to an inactive interval value T_{INACTIVE} when the covering material is not moving and to an active interval value T_{ACTIVE} when the covering material is moving, where the inactive interval value T_{INACTIVE} is longer than the active interval value T_{ACTIVE}. For example, the control circuit 650 of the bottom bar module 640 may be configured to determine that the covering material is moving in response to the accelerometer and/or the gyroscope of the sensor circuit 654. In addition, the control circuit 650 may be configured to determine that the covering material is moving in response to a message received from the control circuit 620 of the motor drive unit 610 (e.g., which may include an indication that the control circuit 620 is presently moving the covering material).

One will also appreciate that while motorized window treatments 150 of the load control system 100, motorized window treatment 200, motorized window treatment 400, and/or motorized window treatment control system 600 have been described as roller shades, other window treatment configurations are applicable to structures and processes described herein including roman shades, venetian blinds, outdoor blinds, etc.

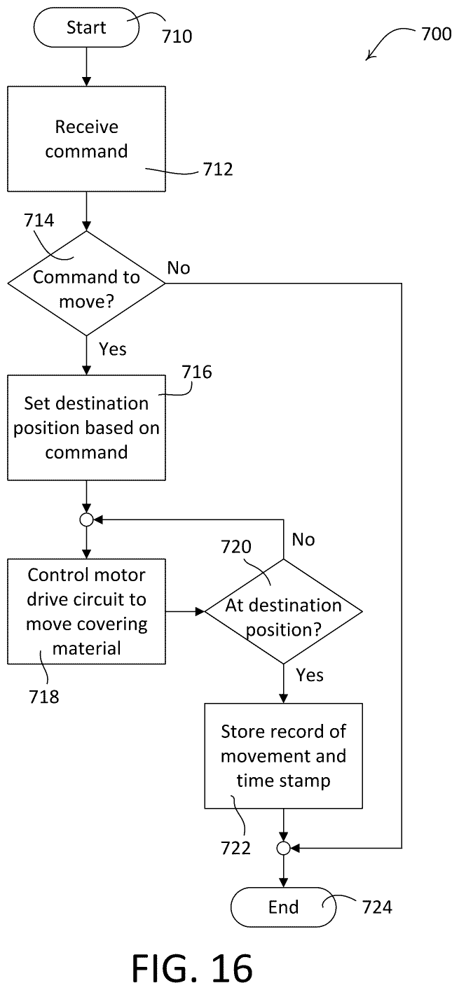

Reference will now be made to FIGS. 16-25 which show several example procedures. For description purposes, these example procedures may be described as performed by a control circuit and communication circuit of a motor drive unit and a control circuit and a communication circuit of a bottom bar module, for example. Nonetheless, as described above, these procedures may be performed by multiple control circuits and/or communication circuits, including control circuits and/or communication circuits separate from a motor drive unit and separate from a bottom bar module. The control circuits may execute instructions, such as software instruction, stored in memory, including one or more computer-readable storage medium, including non-transitory computer-readable storage medium. Such software instructions may be stored on one or more computer-readable storage medium, including non-transitory computer readable storage medium, and downloaded to/loaded onto/programmed onto a motorized window treatment.

FIG. 16 is a flowchart of an example procedure 700 for adjusting a present position P_{PRES} of a covering material of a motorized window treatment (e.g., the motorized window treatments of the embodiments shown in FIGS. 1-15). The procedure 700 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). For example, the control circuit(s) may execute the procedure 700 periodically starting at 710. In addition, the control circuit(s) may execute the procedure 700 in response to receiving a message via a communication circuit at 710.

At 712, the control circuit of the motor drive unit may receive a command. For example, the control circuit may receive a message including a command via a communication circuit (e.g., the communication circuit 622). The command may be, for example, a command to move the covering material (e.g., a shade movement command to adjust the present position P_{PRES} of the covering material). For example, the command may include a commanded position P_{CMD} to which the control circuit of the motor drive unit should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 712 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 624). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 714, the control circuit of the motor drive unit may be configured to determine if the command received at 712 is a command to move the covering material (e.g., a shade movement command). When the command is not a command to move the covering material at 714, the procedure 700 may end at 724. When the command is a command to move the covering material at 714, the control circuit may at 716 set a destination position P_{DEST} for the covering material based on the command in the message received at 712. For example, when the message includes a commanded position P_{CMD}, the control circuit may set the destination position P_{DEST} equal to the commanded position P_{CMD} at 716. In addition, when the message includes a raise command or a lower command, the control circuit may set the destination position P_{DEST} to be a predetermined amount ΔP from the present position P_{PRES} before movement of the covering material starts at 716 (e.g., P_{DEST}=P_{PRES}+ΔP when the command is a raise command or P_{DEST}=P_{PRES}−ΔP when the command is a lower command).

At 718, the control circuit may control the motor drive circuit to rotate the motor to move the covering material. For example, the control circuit may be configured to generate at least one drive signal (e.g., the at least one drive signal VDR) for controlling the motor drive circuit to control the rotational speed and the direction of rotation of the motor. At 720, the control circuit of the motor drive unit may be configured to determine if the covering material is at the destination position P_{DEST}. When the control circuit determines that the covering material is not at the destination position P_{DEST} at 720, the control circuit may continue to control the motor drive circuit to move the covering material towards the destination position P_{DEST} at 718. When the control circuit determines that the covering material is the destination position P_{DEST} at 720, the control circuit may stop controlling the motor drive circuit to move the covering material and store a record of the movement of the covering material along with timing information (e.g., a time stamp indicating a time at which the movement occurred) at 722, before the procedure 700 ends at 724.

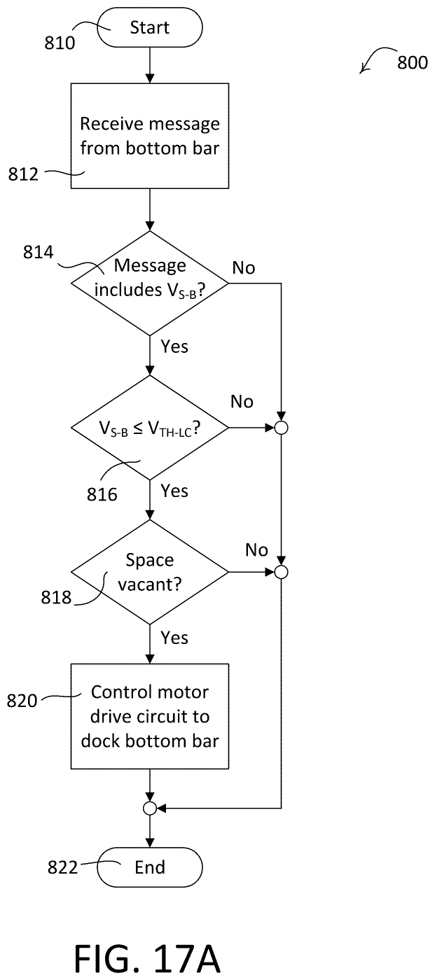

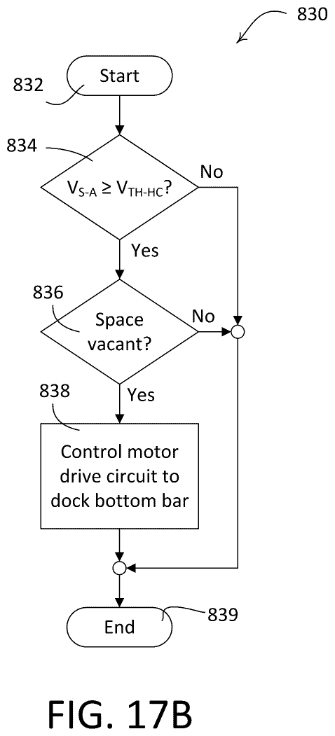

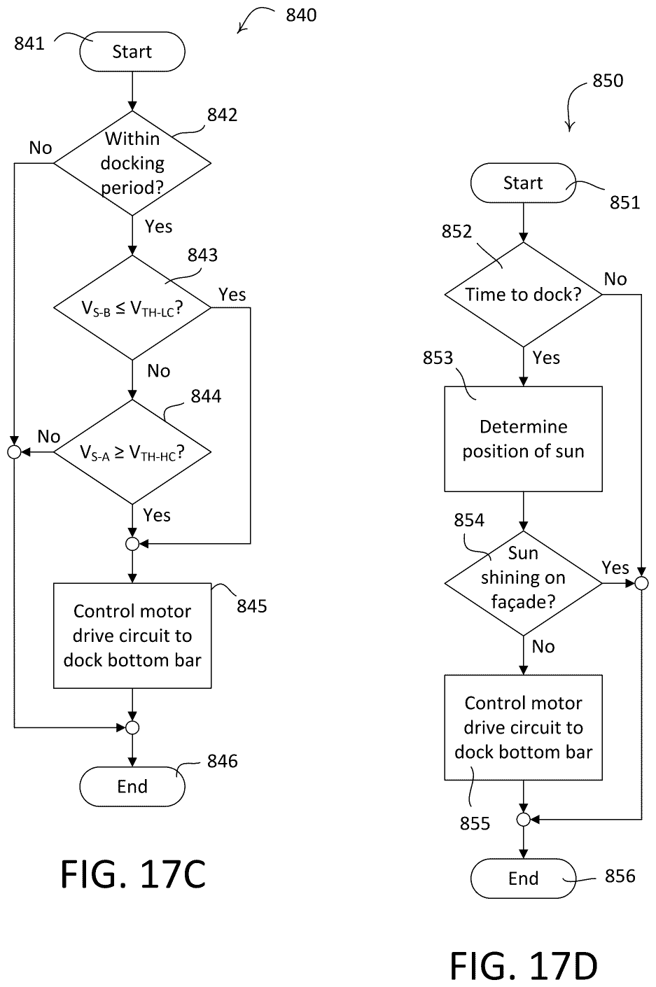

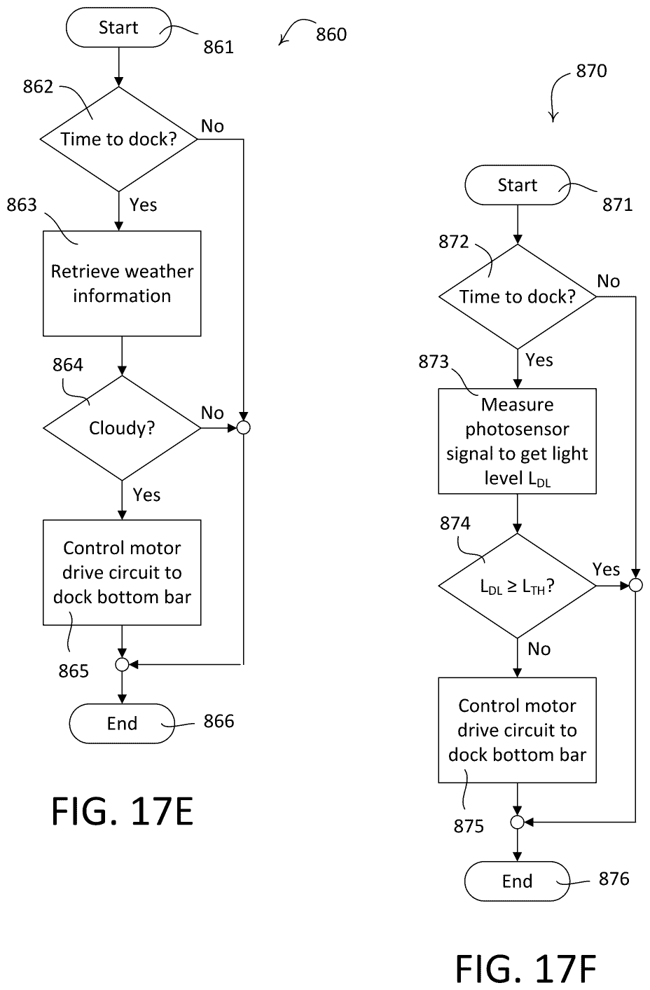

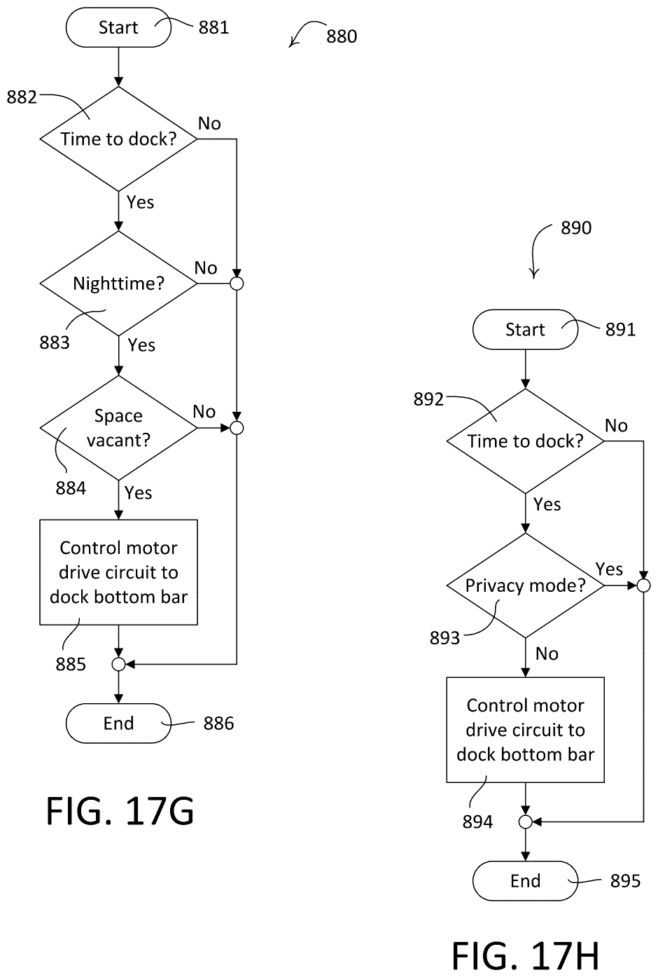

FIG. 17A is a flowchart of an example procedure 800 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 800 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 800, the control circuit(s) may determine whether or not to dock the bottom bar in response to a magnitude of a supply voltage generated across the one or more storage elements of the bottom bar (e.g., the second storage voltage V_{S-B} produced across the energy storage element 642 of the bottom bar module 640). The control circuit(s) may be configured to determine to dock the bottom bar when the magnitude of the second storage voltage V_{S-B} is less than (e.g., is less than or equal to) a low-charge threshold V_{TH-LC} and when (e.g., only when) the space is vacant. The bottom bar module may be configured to transmit a message including an indication of the magnitude of the second storage voltage V_{S-B} to the motor drive unit. For example, the control circuit(s) may execute the procedure 800 periodically at 810 to monitor the magnitude of the second storage voltage V_{S-B}. In addition, the control circuit(s) may execute the procedure 800 in response to receiving a message from the bottom bar module at 810.

At 812, the control circuit of the motor drive unit may receive a message from the bottom bar module. For example, the message may include an indication of the magnitude of the second storage voltage V_{S-B}. At 814, the control circuit may determine if the message includes the magnitude of the second storage voltage V_{S-B}. If the control circuit determines that the message includes the magnitude of the second storage voltage V_{S-B} at 814, the control circuit may determine if the magnitude of the second storage voltage V_{S-B} is less than (e.g., less than or equal to) the low-charge threshold V_{TH-LC} at 816. If the control circuit determines that the message does not include the magnitude of the second storage voltage V_{S-B} at 814 or if the magnitude of the second storage voltage V_{S-B} is greater than the low-charge threshold V_{TH-LC} at 816, the procedure 800 may end at 822.

If the control circuit determines that the magnitude of the second storage voltage V_{S-B} is less than (e.g., less than or equal to) the low-charge threshold V_{TH-LC} at 816, the control circuit may determine if the space is vacant at 818. For example, the control circuit may be configured to determine whether the space is occupied or vacant in response to receiving a message indicating an occupancy condition or a vacancy condition in the space and/or in response to a sensor circuit of the motorized window treatment (e.g., the sensor circuit 654 of the bottom bar module 640). If the control circuit determines that the space is not vacant at 818, the procedure 800 may end at 822 (e.g., without docking the bottom bar). However, if the control circuit determines that the space is vacant at 818, the control circuit may control a motor drive circuit of the motor drive unit (e.g., the motor drive circuit 612) to dock the bottom bar (e.g., to adjust the present position P_{PRES} of the covering material to the raised position P_{RAISED}) at 820, and the procedure 800 may end at 822. For example, after the bottom bar is docked at 820, the motor drive unit may charge the one or more energy storage elements of the bottom bar through the electrical connections of the dock of the motor drive unit and the electrical connections of the bottom bar module.

In some examples, rather than transmitting a message that indicates the magnitude of the second storage voltage V_{S-B}, a control circuit of the bottom bar module may be configured to determine if the magnitude of the second storage voltage V_{S-B} is less than (e.g., less than or equal to) the low-charge threshold V_{TH-LC} and transmit a message indicating that the motor drive unit should dock the bottom bar when the magnitude of the second storage voltage V_{S-B} is less than (e.g., less than or equal to) the low-charge threshold V_{TH-LC}. In such examples, the control circuit of the motor drive unit may determine if the message includes an indication to dock the bottom bar at 812 and steps 814 and/or 816 may be omitted (e.g., the control circuit may not determine whether the message includes the second storage voltage V_{S-B} at 814 and/or the control circuit may not determine whether the magnitude of the second storage voltage V_{S-B} is less than (e.g., less than or equal to) the low-charge threshold V_{TH-LC} at 816).

FIG. 17B is a flowchart of an example procedure 830 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 830 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14) . . . . The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 830, the control circuit(s) may determine whether or not to dock the bottom bar in response to a magnitude of a supply voltage generated across the one or more storage elements of the motor drive unit (e.g., the first storage voltage V_{S-A} produced across the energy storage element 630 of the motor drive unit 620). The control circuit(s) may be configured to determine to dock the bottom bar when the magnitude of the first storage voltage V_{S-A} is greater than (e.g., is greater than or equal to) a high-charge threshold V_{TH-HC} and when (e.g., only when) the space is vacant. For example, the control circuit(s) may execute the procedure 830 periodically at 832 to monitor the magnitude of the first storage voltage V_{S-A}.

At 834, the control circuit of the motor drive unit may determine if the magnitude of the first storage voltage V_{S-A} is greater than (e.g., greater than or equal to) the high-charge threshold V_{TH-HC}. If the magnitude of the first storage voltage V_{S-A} is greater than (e.g., greater than or equal to) the high-charge threshold V_{TH-HC} at 834, the control circuit may determine if the space is vacant at 836. For example, the control circuit may be configured to determine whether the space is occupied or vacant in response to receiving a message indicating an occupancy condition or a vacancy condition in the space and/or in response to a sensor circuit of the motorized window treatment (e.g., the sensor circuit 654 of the bottom bar module 640). If the control circuit determines that the space is vacant at 836, the control circuit may control a motor drive circuit of the motor drive unit (e.g., the motor drive circuit 612) to dock the bottom bar (e.g., to adjust the present position P_{PRES} of the covering material to the raised position P_{RAISED}) at 838, and the procedure 830 may end at 839. For example, after the bottom bar is docked at 838, the motor drive unit may charge the one or more energy storage elements of the bottom bar through the electrical connections of the dock of the motor drive unit and the electrical connections of the bottom bar module. If the magnitude of the first storage voltage V_{S-A} is less than the high-charge threshold V_{TH-HC} at 834 or if the control circuit determines that the space is not vacant at 836, the procedure 830 may end at 839 (e.g., without docking the bottom bar).

FIG. 17C is a flowchart of an example procedure 840 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 840 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 840, the control circuit(s) may determine whether or not to dock the bottom bar in response to a docking window (e.g., a docking time period), a magnitude of a supply voltage generated across the one or more energy storage elements of the motor drive unit (e.g., the first storage voltage V_{S-A} produced across the energy storage element 630 of the motor drive unit 610), and/or a magnitude of a supply voltage generated across the one or more storage elements of the bottom bar (e.g., the second storage voltage V_{S-B} produced across the energy storage element 642 of the bottom bar module 640). The docking window may be a scheduled time that, for example, may be configured by the user. The docking window may occur periodically (e.g., at a docking interval), such as every day (e.g., every night at 3:00 am). The control circuit of the motor drive unit may be configured to determine to dock the bottom bar during the docking window when the magnitude of the second storage voltage V_{S-B} is less than (e.g., is less than or equal to) the low-charge threshold V_{TH-LC} or the magnitude of the first storage voltage V_{S-A} is greater than (e.g., is greater than or equal to) the high-charge threshold V_{TH-HC}. The control circuit of the bottom bar module may be configured to transmit a message including an indication of the magnitude of the second storage voltage V_{S-B} to the motor drive unit. For example, the control circuit of the motor drive unit may periodically receive a message that indicates the magnitude of the second storage voltage V_{S-B}. The control circuit(s) may start the procedure 840 at 841. The control circuit(s) may execute the procedure 840 periodically. In some examples, the control circuit may execute the procedure 840 at a particular time of day (e.g., at the beginning of the docking time period and/or in response to receiving a message (e.g., a message indicating the beginning of the docking time period).

At 842, the control circuit of the motor drive unit may determine whether the motorized window treatment is within the docking window (e.g., based on a timeclock of the control circuit and/or receiving a message indicating the beginning of the docking window). If the control circuit determines that the present time is not within the docking window, the procedure 840 may end at 846. However, if the control circuit determines that the present time is within the docking window, the control circuit may determine whether the magnitude of the second storage voltage V_{S-B} of the energy storage elements in the bottom bar is less than (e.g., is less than or equal to) the low-charge threshold V_{TH-LC} at 843. If the control circuit determines that the magnitude of the second storage voltage V_{S-B} is less than or equal to the low-charge threshold V_{TH-LC} at 843, the control circuit may control the motor drive circuit of the motor drive unit to dock the bottom bar (e.g., to adjust the present position P_{PRES} of the covering material to the raised position P_{RAISED}) at 845, before the procedure 840 ends at 846. As such, if the control circuit determines that the magnitude of the second storage voltage V_{S-B} is less than or equal to the low-charge threshold V_{TH-LC} during the docking window, the control circuit may dock the bottom bar (e.g., to charge the storage elements of the bottom bar during the scheduled docking window).

However, if the control circuit determines that the magnitude of the second storage voltage V_{S-B} is not less than or equal to (e.g., is greater than) the low-charge threshold V_{TH-LC} at 843, the control circuit may determine whether the first storage voltage V_{S-A} of the energy storage elements in the motor drive unit is greater than (e.g., is greater than or equal to) the high-charge threshold V_{TH-HC} at 844. If the control circuit determines that the first storage voltage V_{S-A} is greater than or equal to the high-charge threshold V_{TH-HC} at 844, the control circuit may control the motor drive circuit of the motor drive unit to dock the bottom bar (e.g., to adjust the present position P_{PRES} of the covering material to the raised position P_{RAISED}) at 845, before the procedure 840 ends at 846. As such, if the control circuit determines that the first storage voltage V_{S-A} is greater than the high-charge threshold V_{TH-HC} during the docking window, the control circuit may dock the bottom bar (e.g., to charge the storage elements of the bottom bar and discharge the storage elements of the motor drive unit when the first storage voltage level _{VS-A} is high during the scheduled docking window). After the bottom bar is docked at 845, the one or more energy storage elements of the bottom bar may charge through the electrical connections of the dock of the motor drive unit and the electrical connections of the bottom bar module. If the control circuit determines that the first storage voltage V_{S-A} is not greater than or equal to (e.g., is less than) the high-charge threshold V_{TH-HC} at 844, the procedure 840 may end at 846 (e.g., without docking the bottom bar), for example, because there is little benefit to the docking the bottom bar if the first storage voltage V_{S-A} is less than the high-charge threshold V_{TH-HC} and the second storage voltage V_{S-B} is greater than the low-charge threshold V_{TH-LC}.

In some examples, the determination of whether the first storage voltage V_{S-A} is greater than the high-charge threshold V_{TH-HC} at 844 may be omitted. For example, if the power source (e.g., power source 634) of the motor drive unit receives power from an external power source, such as an external direct-current (DC) power source or an alternating-current (AC) power source the determination of whether the first storage voltage V_{S-A} is greater than the high-charge threshold V_{TH-HC} at 844 may be omitted. If the control circuit determines that the magnitude of the second storage voltage V_{S-B} is greater than the low-charge threshold V_{TH-LC} at 843 and the determination of whether the first storage voltage V_{S-A} is greater than the high-charge threshold V_{TH-HC} at 844 is omitted, the procedure 840 may end at 846 (e.g., without docking the bottom bar).

In some examples, steps 844 and 843 may be reversed. For example, the control circuit may determine whether the first storage voltage V_{S-A} is greater than the high-charge threshold V_{TH-HC} before determining whether the magnitude of the second storage voltage V_{S-B} of the energy storage elements in the bottom bar is less than (e.g., is less than or equal to) the low-charge threshold V_{TH-LC}. If the control circuit determines that the first storage voltage V_{S-A} is greater than the high-charge threshold V_{TH-HC}, the control circuit may control the motor drive circuit to dock the bottom bar without determining whether the magnitude of the second storage voltage V_{S-B} of the energy storage elements in the bottom bar is less than (e.g., is less than or equal to) the low-charge threshold V_{TH-LC} and the procedure may end. If the control circuit determines that the first storage voltage V_{S-A} is not greater than or equal to (e.g., is less than) the high-charge threshold V_{TH-HC}, the control circuit may (e.g., then) determine whether the magnitude of the second storage voltage V_{S-B} of the energy storage elements in the bottom bar is less than (e.g., is less than or equal to) the low-charge threshold V_{TH-LC}. If the magnitude of the second storage voltage V_{S-B} of the energy storage elements in the bottom bar is less than (e.g., is less than or equal to) the low-charge threshold V_{TH-LC}, the control circuit may control the motor drive circuit to dock the bottom bar and the procedure may end. If the control circuit determines that the magnitude of the second storage voltage V_{S-B} is not less than or equal to (e.g., is greater than) the low-charge threshold V_{TH-LC}, the procedure may end (e.g., without docking the bottom bar).

FIG. 17D is a flowchart of an example procedure 850 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 850 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14) . . . . The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 850, the control circuit(s) may determine whether or not to dock the bottom bar based on the position of the sun. For example, the control circuit(s) may determine to dock the bottom bar if the sun is not shining on a façade on which the motorized window treatment is installed, for instance, to take advance of instances where the solar cells are less likely to be missing out on collecting a relatively large amount of solar energy. The control circuit(s) (e.g., and/or a system controller that is in communication with the control circuit(s)) may be configured to calculate a predicted position of the sun at a plurality of discrete times in a day. The position of the sun in the sky may be defined by a solar altitude angle aₛ and a solar azimuth angle a_{z}. The control circuit may determine the solar altitude angle aₛ and the solar azimuth angle a_{z} as functions of the date (e.g., a Julian date) and time (e.g., a standard time tₛ), as well as the position (e.g., longitude λ and latitude Φ) of the building in which the window and/or motorized window treatment is located.

For example, the system controller and/or the control circuit of the motor drive unit may be configured to calculate the solar altitude angle aₛ and the solar azimuth angle a_{z} using the following equations. The difference in a solar time tₛₒₗₐᵣ (e.g., a time as given by a sundial) and the standard time tₛ (e.g., a time as given by a clock) due to the obliquity of the Earth's axis of rotation may be defined by an equation of time ET. The equation of time ET can be determined as a function of the present Julian date J using, for example, the equation:

$$ET = 0.1644 \cdot sin ( A ) - 0.1273 \cdot cos ( B ) , \qquad ( Equation 1 )$$

where A=[4π·(J−81.6)]/365.25 and B=[2π·(J−2.5)]/365.25. The Julian date J may be a decimal number representing the present day in the year. For example, the Julian date J may equal one for January 1, two for January 2, three for January 3, and so on. The solar time tₛₒₗₐᵣ may be calculated as a function of the standard time tₛ, the equation of time ET, a standard meridian SM of the time zone of the location of the building, and the longitude λ, for example, using the equation:

$${t}_{solar} = {t}_{s} + ET + [ 12 \cdot ( SM - λ ) ] / π . \qquad ( Equation 2 )$$

The standard meridian SM may be determined from the time zone of the location of the building. Each time zone may have a unique standard meridian, which may define a particular line of latitude within the time zone. There may be approximately 15° between the standard meridians of adjacent time zones. The solar altitude angle aₛ and the solar azimuth angle a_{z} may be determined from a solar declination δ. The solar declination δ may define an angle of incidence of the rays of the sun on the equatorial plane of the Earth. The solar declination δ may be determined using, for example, the equation:

$$δ = 0.4093 \cdot sin [ 2 π \cdot ( J - 81 ) / 368 ] . \qquad ( Equation 3 )$$

The solar altitude angle aₛ at the standard time is may be calculated as a function of the solar time tₛₒₗₐᵣ, the solar declination δ, and the local latitude Φ using, for example, the equation:

$${a}_{s} = arc sin [ sin ( Φ ) \cdot sin ( δ ) - cos ( Φ ) \cdot cos ( δ ) \cdot cos ( π \cdot {t}_{solar} / 12 ) ] . \qquad ( Equation 4 )$$

The solar azimuth angle a_{z} at the standard time is may be calculated as a function of the solar time tₛₒₗₐᵣ, the solar declination δ, and the local latitude Φ using, for example, the equation:

$${a}_{z} = arc tan [ - cos ( δ ) \cdot sin ( π \cdot {t}_{solar} / 12 ) / C ] , \qquad ( Equation 5 )$$

where C=−[cos(Φ)·sin(δ)+sin(Φ)·cos(δ)·cos(π·tₛₒₗₐᵣ/12)]. An example of a motorized window treatment that is configured to determine the position of the sun is described in U.S. Patent Publication No. 2021/0180399, which is hereby incorporated by reference in its entirety.

The procedure 850 may start at 851. At 852, the control circuit of the motor drive unit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 850 may end at 856.

If the control circuit determines that it is time to dock, the control circuit may determine the position of the sun at 853. For example, the control circuit may calculate the position of the sun based on a predicted position of the sun (e.g., using Equations 1-5 shown above). Alternatively, the control circuit may receive an indication of the predicted position of the sun from a system controller. At 854, the control circuit may determine whether the sun may be shining on a façade of the building of which the motorized window treatment is installed. Since there may be cloud cover or another obstruction between the façade and the sun, the predicted position of the sun may indicate whether there is potentially sun shining on the façade of the building of which the motorized window treatment is installed. For example, the control circuit may be configured to determine whether the sun may be shining on the façade of which the motorized window treatment is installed at 853 by comparing the calculated solar altitude angle aₛ and/or the calculated solar azimuth angle a_{z} to one or more thresholds to determine if the calculated solar altitude angle aₛ and/or the calculated solar azimuth angle a_{z} are within ranges that indicate that the sun may be shining on the façade. If the control circuit determines that the sun may be shining on the façade, the procedure 850 may end at 856.

If the control circuit determines that the sun is not shining on the façade at 854, the control circuit may control the motor drive circuit to dock the bottom bar at 855, before the procedure 850 ends at 856. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 855, before the procedure 850 ends at 856. After the bottom bar is docked at 855, the motor drive unit may charge the one or more energy storage elements of the bottom bar through the electrical connections of the dock of the motor drive unit and the electrical connections of the bottom bar module.

FIG. 17E is a flowchart of an example procedure 860 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 860 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 860, the control circuit(s) may determine whether or not to dock the bottom bar based on weather information (e.g., temperature, cloud coverage, precipitation, barometric pressure, etc.). For example, the control circuit(s) may determine to dock the bottom bar if it is cloudy, for instance, to take advance of instances where the solar cells are less likely to be missing out on collecting a relatively large amount of solar energy. The control circuit(s) (e.g., and/or a system controller that is in communication with the control circuit(s)) may be configured to determine the weather in the location of the motorized window treatment from an external source, such as a weather service (e.g., via the Internet), a weather application, and/or a weather application programming interface (API).

The procedure 860 may start at 861. At 862, the control circuit of the motor drive unit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 860 may end at 866. In some examples, the determination of whether or not to dock at 862 may be omitted.

If the control circuit determines that it is time to dock, the control circuit may retrieve weather information at 863. For example, the control circuit may retrieve the weather information (e.g., directly or indirectly, via a system controller) from a weather application. At 864, the control circuit may determine whether it is cloudy at the location of the motorized window treatment. If the control circuit determines that it is not cloudy, the procedure 860 may end at 866.

If the control circuit determines that it is cloudy at 864, the control circuit may control the motor drive circuit to dock the bottom bar at 865, before the procedure 860 ends at 866. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 865, before the procedure 860 ends at 866. After the bottom bar is docked at 866, the motor drive unit may charge the one or more energy storage elements of the bottom bar through the electrical connections of the dock of the motor drive unit and the electrical connections of the bottom bar module.

FIG. 17F is a flowchart of an example procedure 870 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 870 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 870, the control circuit(s) may determine whether or not to dock the bottom bar based on feedback from a photosensor. For instance, in some examples, the motorized window treatment (e.g., the motor drive unit and/or the bottom bar) may include a photosensor that is configured to measure light and generate a signal indicating the amount of light. For example, the photosensor may be included in a sensing circuit (e.g., the sensing circuit 654 of the bottom bar module 640). As such, the control circuit(s) may receive an indication of the amount of light from the photosensor and determine a light level L_{DL}. The photosensor may be oriented such that it faces towards the window to measure the amount of light (e.g., sunlight) hitting the window (e.g., which may be an indicator of the amount of light directed towards the solar cells of the motorized window treatment). For example, the control circuit(s) may determine to dock the bottom bar if there is less light, for instance, to take advance of instances where the solar cells are less likely to be missing out on collecting a relatively large amount of solar energy.

The procedure 870 may start at 871. At 872, the control circuit of the motor drive unit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 870 may end at 876. In some examples, the determination of whether or not to dock at 872 may be omitted.

If the control circuit determines that it is time to dock, the control circuit may measure the signal from the photosensor to determine the light level L_{DL} at 873. For example, the photosensor may be oriented such that it faces towards the window, and as such, the light level L_{DL} may indicate the amount of light (e.g., sunlight) hitting the window (e.g., which may be an indicator of the amount of light directed towards the solar cells of the motorized window treatment). At 874, the control circuit may determine whether the light level L_{DL} is greater than or equal to a threshold light level LTH. If the control circuit determines that the light level L_{DL} is greater than or equal to the threshold light level LTH, the procedure 870 may end at 876.

If the control circuit determines that the light level L_{DL} is less than the threshold light level LTH at 874, the control circuit may control the motor drive circuit to dock the bottom bar at 875, before the procedure 870 ends at 876. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 875, before the procedure 870 ends at 876. After the bottom bar is docked at 876, the motor drive unit may charge the one or more energy storage elements of the bottom bar through the electrical connections of the dock of the motor drive unit and the electrical connections of the bottom bar module.

FIG. 17G is a flowchart of an example procedure 880 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 880 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 880, the control circuit(s) may determine whether or not to dock the bottom bar based on whether it is nighttime and/or the space is vacant. The control circuit(s) may determine it is nighttime based on a timeclock (e.g., nighttime may be defined as between an hour range, such as between 9 μm and 5 am). The control circuit(s) may determine the space is vacant based on feedback from one or more occupancy and/or vacancy sensors (e.g., directly or indirectly by way of a system controller). The control circuit(s) may determine to dock the bottom bar if it is nighttime and the space is vacant, for instance, because nobody is in the space (e.g., it will cause less disruption to the user) and to take advance of instances where the solar cells are less likely to be missing out on collecting a relatively large amount of solar energy.

The procedure 880 may start at 881. At 882, the control circuit of the motor drive unit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 880 may end at 886. In some examples, the determination of whether or not to dock at 882 may be omitted.

If the control circuit determines that it is time to dock, the control circuit may determine whether it is nighttime at 883. For example, the control circuit may determine that it is nighttime based on a timeclock and/or based on a message received from a system controller. In some examples, the control circuit may determine that it is nighttime when it is between an hour range, such as between 9 μm and 5 am, and/or based on times of sunset and sunrise for the location of the motorized window treatment and at the particular time of the year (e.g., when the timeclock is an astronomical timeclock). If the control circuit determines that it is not nighttime, the procedure 880 may end at 886.

If the control circuit determines that it is nighttime at 883, the control circuit may determine whether the space is vacant at 884. For example, the control circuit may receive an occupied command and/or a vacant command from an occupancy sensor (e.g., directly, or indirectly via a system controller). In some examples, the occupancy sensor may be located on the bottom bar. Alternatively or additionally, the control circuit may be configured to determine that the space is vacant based on data received from one or more calendar programs (e.g., no meeting is scheduled in the space at that time). If the control circuit determines that the space is not vacant, the procedure 880 may end at 886.

If the control circuit determines that the space is vacant at 884, the control circuit may control the motor drive circuit to dock the bottom bar at 885, before the procedure 880 ends at 886. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 885, before the procedure 880 ends at 886. After the bottom bar is docked at 885, the motor drive unit may charge the one or more energy storage elements of the bottom bar through the electrical connections of the dock of the motor drive unit and the electrical connections of the bottom bar module.

FIG. 17H is a flowchart of an example procedure 890 for determining when to dock and charge a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 890 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}).

During the procedure 890, the control circuit(s) may determine whether or not to dock the bottom bar based on whether the motorized window treatment is in privacy mode. The motorized window treatment may be configured to enter a privacy mode where, for example, the covering material will remain in the lowered position P_{LOWERED}. The privacy mode may be defined by a timeclock schedule (e.g., the privacy mode may be activated and deactivated based on the timeclock schedule). For example, the control circuit(s) may determine that it is nighttime based on a timeclock and/or based on a message received from a system controller. For instance, privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via an astronomical timeclock). When in the privacy mode, the control circuit of the motor drive unit may ensure that the covering material is in the lowered position P_{LOWERED} to ensure that the user has privacy. In some examples, during the privacy mode, the control circuit(s) may disable certain docking movements and/or procedures to ensure that the covering material does not move from the lowered position P_{LOWERED} (e.g., unless a direct command from the user is received). The control circuit(s) may determine not to dock the bottom bar if the motorized window treatment is in privacy mode to, for example, ensure that the covering material remains in the lowered position P_{LOWERED}.

The procedure 890 may start at 891. At 892, the control circuit of the motor drive unit may determine whether it is time to dock the bottom bar of the motorized window treatment. For example, the control circuit may determine whether it is time to dock the bottom bar using one or more of the methods described herein, such as based on a timeclock, a docking window or interval, the charge of the energy storage elements of the motor drive unit and/or the bottom bar, etc. If the control circuit determines that it is not time to dock, the procedure 890 may end at 895. In some examples, the determination of whether or not to dock at 892 may be omitted.

If the control circuit determines that it is time to dock, the control circuit may determine whether it is in privacy mode at 893. The privacy mode may be defined by a timeclock schedule. For instance, privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via astronomical timeclock).

If the control circuit determines that it is not in privacy mode at 893, the control the motor drive circuit to dock the bottom bar at 894 (e.g., to charge the storage elements of the bottom bar), before the procedure 890 ends at 895. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 894, before the procedure 890 ends at 895. If the control circuit determines that it is in privacy mode at 893, the procedure 890 may end at 895. As such, even though the control circuit determines that it is time to dock at 892, the control circuit will not dock if the control circuit determines that it is in privacy mode at 893. After the bottom bar is docked at 894, the motor drive unit may charge the one or more energy storage elements of the bottom bar through the electrical connections of the dock of the motor drive unit and the electrical connections of the bottom bar module.

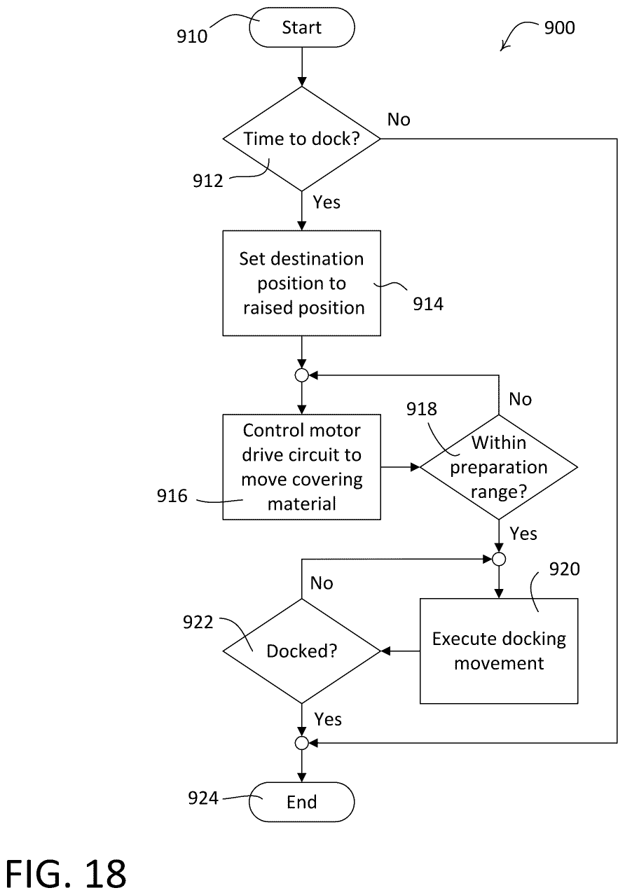

FIG. 18 is a flowchart of an example procedure 900 for docking and charging a bottom bar (e.g., the bottom bars 155, 440) of a motorized window treatment (e.g., the motorized window treatments of the embodiments shown in FIGS. 1-15). For example, the bottom bar may be connected to a bottom end of a covering material of the motorized window treatment and may comprise a bottom bar module (e.g., the bottom bar modules 490, 640). The procedure 900 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motor drive unit may be configured to control a present position P_{PRES} of the covering material. The motor drive unit may comprise a dock that is configured to facilitate discharging of one or more energy storage elements of the motor drive unit into one or more energy storage elements of the bottom bar, for example, when the bottom bar is located adjacent to the dock (e.g., when the covering material is in the raised position P_{RAISED}). For example, the control circuit(s) may execute the procedure 900 periodically at 910 to determine if the bottom bar should be docked (e.g., should control the present position P_{PRES} of the covering material to the raised position P_{RAISED}).

At 912, the control circuit of the motor drive unit may be configured to determine if the motor drive unit should presently dock the bottom bar. For example, the control circuit may be configured to determine that the bottom bar should be docked when the space in which the motorized window treatment is installed is vacant and the magnitude of a second storage voltage V_{S-B} produced across the one or more energy storage elements of the bottom bar is less than (e.g., less than or equal to) a low-charge threshold V_{TH-LC} (e.g., as shown in FIG. 17A). In addition, the control circuit may determine to that the bottom bar should be docked when the magnitude of a first storage voltage V_{S-A} produced across the one or more energy storage elements of the motor drive unit is greater than (e.g., greater than or equal to) a high-charge threshold V_{TH-HC} (e.g., as shown in FIG. 17B). Further, the control circuit of the motor may be configured to determine that the bottom bar should be docked in response to the present day of the week and/or the time of the day. When the control circuit determines that the motor drive unit should not presently dock the bottom bar at 912, the procedure 900 may end at 924.

When the control circuit determines that the motor drive unit should presently dock the bottom bar at 912, the control circuit may set a destination position P_{DEST} to the raised position P_{RAISED} at 914 and control the motor drive circuit to rotate the motor to move the covering material at 916. For example, the control circuit may be configured to generate at least one drive signal (e.g., the at least one drive signal VDR) for controlling the motor drive circuit to control the rotational speed and the direction of rotation of the motor at 916.

In some examples, even if the control circuit determines that the motor drive unit should dock the bottom bar at 912, the control circuit may skip the docking event. For example, the control circuit may skip the docking event if the magnitude of the second storage voltage V_{S-B} produced across the energy storage element of the bottom bar is above a charge threshold (e.g., the energy storage element of the bottom bar has sufficient charge). Further, in some examples, even if the control circuit determines that the motor drive unit should dock the bottom bar at 912, the control circuit may send a message (e.g., via email, text, an alert via a mobile app, etc.) to a user, and wait to dock until a confirmation is received from the user that the motor drive unit should dock the bottom bar.

At 918, the control circuit of the motor drive unit may determine if the present position P_{PRES} of is within a docking preparation range. For example, the docking preparation range may extend a predetermined distance from the raised position PRAISE. When the covering material is not within the docking preparation range 918, the control circuit may continue to control the motor drive circuit to rotate the motor to move the covering material at 916. When the covering material is within the docking preparation range at 918, the control circuit may control the motor through a docking movement (e.g., a docking sequence) at 920. For example, the control circuit may ramp down the rotational speed at which the motor is rotating as the bottom bar nears the dock as part of the docking movement.

At 922, the control circuit of the motor drive unit may determine if the bottom bar is docked. For example, the control circuit may be configured to determine if the bottom bar is docked by determining if electrical connections of the dock of the motor drive unit are electrically connected to the electrical connections of the bottom bar module at 922. For example, the control circuit may be configured to determine that the bottom bar is docked by detecting that the second supply voltage V_{S-B} is present at the electrical connection of the dock (e.g., the electrical connections 638). When the control circuit determines that the bottom bar is not presently docked at 922, the control circuit may continue to control the motor through the docking movement at 920. When the control circuit determines that the bottom bar is presently docked at 922, the procedure 900 may end at 924 when the bottom bar is charged.

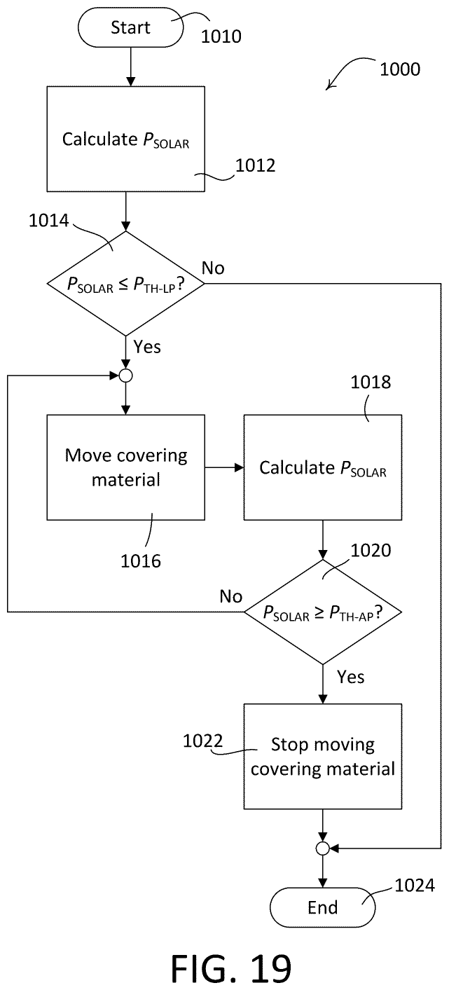

FIG. 19 is a flowchart of an example procedure 1000 for adjusting a present position P_{PRES} of a covering material of a motorized window treatment (e.g., the motorized window treatments of the embodiments shown in FIGS. 1-15) in response to a solar power P_{SOLAR} being received by one or more solar cells (e.g., the solar cell of the sensor circuit 654) of the motorized window treatment. For example, the one or more solar cells may be located on a bottom bar (e.g., the bottom bars 155, 226, 440) of the motorized window treatment. For example, the bottom bar may be connected to a bottom end of the covering material of the motorized window treatment and may comprise a bottom bar module (e.g., the bottom bar modules 350, 490, 640). The bottom bar may comprise a bottom bar module having a solar cell management circuit configured to charge an energy storage element of the bottom bar (e.g., the energy storage element 642) from the one or more solar cells (e.g., the solar cell of the sensor circuit 654). The procedure 1000 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). For example, the control circuit(s) may execute the procedure 1000 periodically at 1010 to monitor the solar power P_{SOLAR} being received by the solar cells of the bottom bar.

At 1012, the control circuit of the motor drive unit may be configured to calculate the solar power P_{SOLAR} being received by the one or more solar cells. For example, the control circuit may be configured to calculate the solar power P_{SOLAR} as a function of a magnitude of a photovoltaic output voltage of the one or more solar cell, a magnitude of a storage voltage of an energy storage element of the bottom bar (e.g., the second storage voltage V_{S-B}), and/or a duty cycle DC_{SCM} of the solar cell management circuit of the bottom bar module (e.g., which may be received in one or more message from the bottom bar module). At 1014, the control circuit may determine if the magnitude of the solar power P_{SOLAR} is less than (e.g., less than or equal to) a low-power threshold PTH-LP. When the magnitude of the solar power P_{SOLAR} is greater than the low-power threshold PTH-LP at 1014, the procedure 1000 may end at 1024.

When the magnitude of the solar power P_{SOLAR} is less than (e.g., less than or equal to) the low-power threshold PTH-LP at 1014, the control circuit may start moving the covering material at 1016 to adjust the present position P_{PRES} of the covering material. For example, the control circuit may be configured to adjust the present position P_{PRES} of the covering material in a direction (e.g., either raise or lower) that may move the bottom bar into direct sunlight, which may be determined from the solar data. At 1018, the control circuit may be configured to calculate the solar power P_{SOLAR} being received by one or more solar cells at the new present position P_{PRES} of the covering material (e.g., an adjusted position of the covering material as compared to when the solar power P_{SOLAR} was calculated at 1012). At 1020, the control circuit may determine if the magnitude of the solar power P_{SOLAR} is greater than (e.g., greater than or equal to) an acceptable-power threshold PTH-AP. When the magnitude of the solar power P_{SOLAR} is less than the acceptable-power threshold PTH-AP at 1020, the control circuit may continue to move the covering material at 1016 to adjust the present position P_{PRES} of the covering material and to calculate the solar power P_{SOLAR} being received by one or more solar cells at 1018. When the magnitude of the solar power P_{SOLAR} is greater than (e.g., greater than or equal to) the acceptable-power threshold PTH-AP at 1020, the control circuit may stop moving the covering material at 1022 and the procedure 1000 may end at 1024.

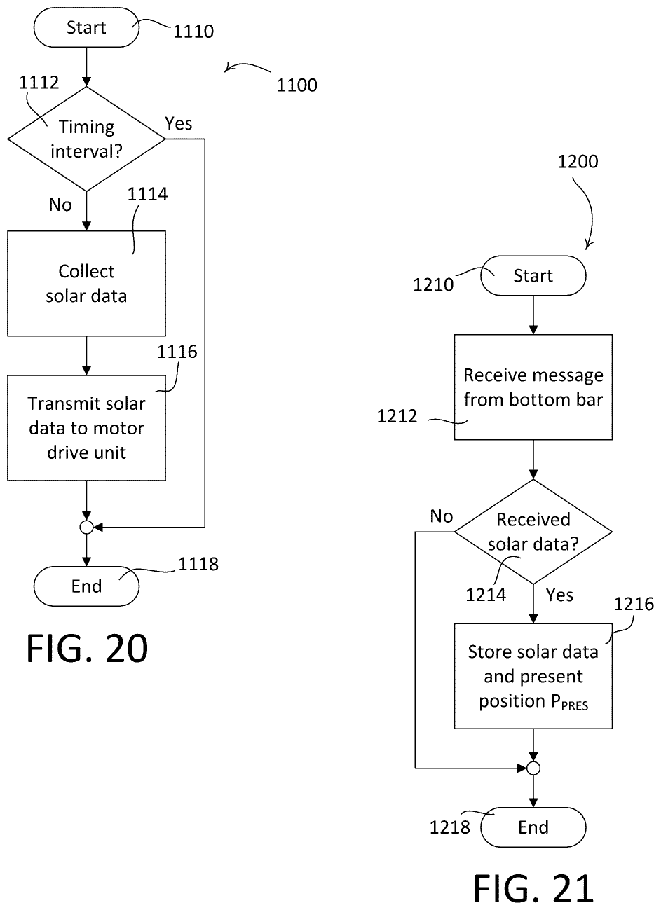

FIG. 20 is a flowchart of an example procedure 1100 for collecting solar data for a motorized window treatment (e.g., the motorized window treatments of the embodiments shown in FIGS. 1-15). The procedure 1100 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motorized window treatment may comprise a bottom bar and may also comprise a motor drive unit for adjusting a present position P_{PRES} of a covering material and the bottom bar. The bottom bar may be connected to a bottom end of the covering material of the motorized window treatment and may comprise a bottom bar module (e.g., the bottom bar modules 350, 490, 640). For example, the control circuit of the bottom bar module may execute the procedure 1200 to collect solar data, such as one or more measurements and/or operational characteristics of the bottom bar module of the bottom bar, at a plurality of intermediate positions of the covering material between a raised position P_{RAISED} and a lowered position P_{LOWERED}. The bottom bar module may be configured to communicate with the control circuit of the motor drive unit via a communication link (e.g., via RF signals using a short-range wireless communication protocol). The control circuit of the bottom bar module may be configured to periodically collect and transmit the solar data to the motor drive unit (e.g., at the timing interval T_{TIM} set in the procedure 1200). For example, the control circuit of the bottom bar module may execute the procedure 1100 periodically at 1110.

The control circuit of the bottom bar module may be configured to collect the solar data at the timing interval T_{TIM} (e.g., at the active interval value T_{ACTIVE} or the inactive interval value T_{INACTIVE} as set in the procedure 1200). When the control circuit detects the end of the timing interval T_{TIM} at 1112, the control circuit may collect the solar data at 1114, before the procedure 1100 ends at 1118. For example, the solar data may comprise measurements, such as a magnitude of a photovoltaic output voltage of one or more solar cells (e.g., a solar cell of the sensor circuit 654), magnitude of a storage voltage of an energy storage element of the bottom bar module (e.g., the second storage voltage V_{S-B}). In addition, the solar data may comprise operational characteristics of the bottom bar module, such as a duty cycle of solar cell management circuit (e.g., the solar cell management circuit of the bottom bar module 640). For example, the control circuit may collect the solar data by sampling one or more sense signals of the bottom bar module (e.g., sense signals generated by the solar cell management circuit of the bottom bar module 640) and/or receiving one or more messages including measurements and/or operational characteristics of the bottom bar module (e.g., messages from the solar cell management circuit of the bottom bar module 640). At 1116, the control circuit of the bottom bar may transmit messages including collected solar data of the bottom bar to the motor drive unit in one or more signals (e.g., via the communication circuit 652), before the procedure 1100 ends at 1118.

FIG. 21 is an example procedure 1200 for collecting solar data for a motorized window treatment (e.g., the motorized window treatments of the embodiments shown in FIGS. 1-15). The procedure 1200 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motorized window treatment may comprise a covering material, and a bottom bar connected to a bottom end of the covering material. The bottom bar may comprise a bottom bar module (e.g., the bottom bar modules 350, 490, 640). The motor drive unit may be configured to control a present position P_{PRES} of the covering material and the bottom bar. For example, the control circuit may execute the procedure 1200 to store solar data, such as one or more measurements and/or operational characteristics of the bottom bar module, at a plurality of intermediate positions of the covering material between a raised position P_{RAISED} and a lowered position P_{LOWERED}. A control circuit of the bottom bar module may be configured to communicate with a control circuit of the motor drive unit via a communication link (e.g., via RF signals using a short-range wireless communication protocol). Accordingly, the motor drive unit is able to collect solar data from the bottom bar (e.g., from a sensor circuit of the bottom bar). The bottom bar module may be configured to periodically collect and transmit the solar data to the motor drive unit (e.g., at the timing interval T_{TIM} set in the procedure 1200). For example, the control circuit of the motor drive unit may execute the procedure 1200 periodically at 1210. In addition, the control circuit may execute the procedure 1200 in response to receiving a message from the bottom bar module at 1210.

At 1212, the control circuit of the motor drive unit may receive a message from the control circuit of the bottom bar module. For example, the message may include solar data (e.g., one or more measurements and/or operational characteristics of the bottom bar module). If the received message does not include solar data at 1214, the procedure 1200 may end at 1218. When the received message includes solar data at 1214, the control circuit of the motor drive unit may at 1216 store the solar data in memory of the motor drive unit along with the present position P_{PRES} of the covering material at the time that the message was received. In some examples, the control circuit may also store the present time in memory along with the present position P_{PRES} of the covering material at 1216. For example, the control circuit may store the present position P_{PRES} of the covering material (e.g., and/or the present time) for each of the one or more measurements and/or operational characteristics of the solar data received from the bottom bar module. After the control circuit stores the solar data at 1216, the procedure 1200 may end at 1218.

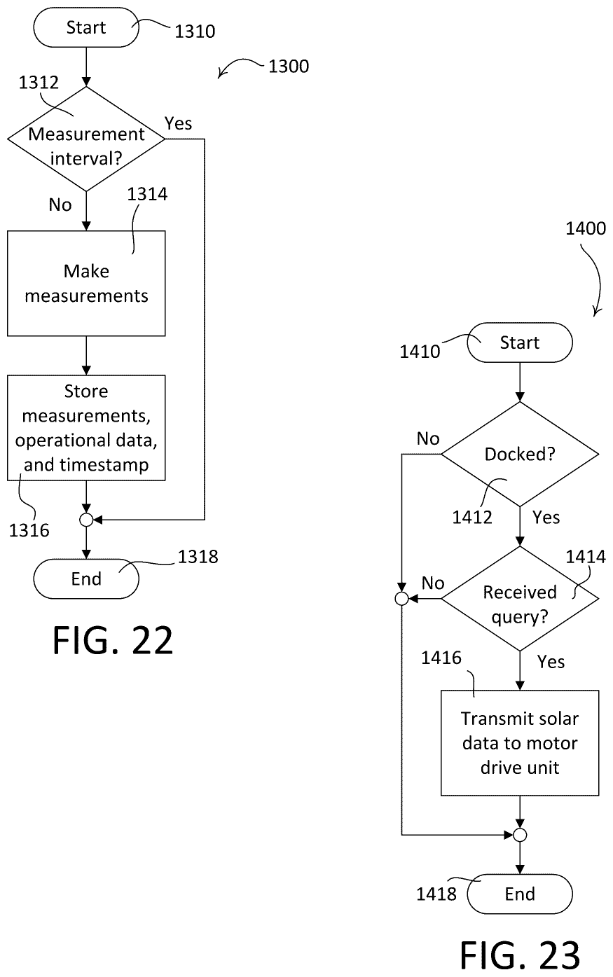

FIG. 22 is an example procedure 1300 for collecting solar data for a motorized window treatment (e.g., the motorized window treatments of the embodiments shown in FIGS. 1-15). The procedure 1300 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14).). The motorized window treatment may comprise a bottom bar and a motor drive unit for adjusting a present position P_{PRES} of a covering material. The bottom bar may be connected to a bottom end of the covering material of the motorized window treatment and may comprise a bottom bar module (e.g., the bottom bar modules 490, 640). For example, the control circuit of the bottom bar module may execute the procedure 1200 to collect solar data, such as one or more measurements and/or operational characteristics of a bottom bar module of the bottom bar, at a plurality of intermediate positions of the covering material between a raised position P_{RAISED} and a lowered position P_{LOWERED}. The bottom bar module may be configured to communicate with a control circuit of the motor drive unit via a communication link (e.g., via the electrical connections 638, 648) when the bottom bar is docked. Accordingly, the motor drive unit is able to collect solar data from the bottom bar (e.g., from a sensor circuit of the bottom bar). The control circuit of the bottom bar module may be configured to collect and store the solar data in memory of the bottom bar module (e.g., at the timing interval T_{TIM} set in the procedure 1200), and then transmit the solar data to the motor drive unit via the communication link when the bottom bar is docked. For example, the control circuit(s) may execute the procedure 1300 periodically at 1310.

The control circuit of the bottom bar module may be configured to collect the solar data at the timing interval T_{TIM} (e.g., at the active interval value T_{ACTIVE} or the inactive interval value T_{INACTIVE} as set in the procedure 1200). When the control circuit detects the end of the timing interval T_{TIM} at 1312, the control circuit may collect the solar data at 1314. For example, the solar data may comprise measurements, such as a magnitude of a photovoltaic output voltage of one or more solar cells (e.g., the solar cell of the sensor circuit 654) and/or a magnitude of a storage voltage of an energy storage element of the bottom bar module (e.g., the second storage voltage V_{S-B}). In addition, the solar data may comprise operational characteristics of the bottom bar module, such as a duty cycle of solar cell management circuit (e.g., the solar cell management circuit of the bottom bar module 640). For example, the control circuit may collect the solar data by sampling one or more sense signals of the bottom bar module (e.g., sense signals from the solar cell management circuit of the bottom bar module 640) and/or receiving one or more messages including measurements and/or operational characteristics of the bottom bar module (e.g., messages from the solar cell management circuit of the bottom bar module 640). At 1316, the control circuit may store the collected solar data in memory of the bottom bar module, before the procedure 1300 ends at 1318. For example, the control circuit may store each of the measurements and/or operational characteristics of the solar data in memory at 1316 along with timing information (e.g., a time stamp indicating a time at which the respective measurement and/or operational characteristic was recorded).

FIG. 23 is an example procedure 1400 for transmitting solar data of a motorized window treatment (e.g., the motorized window treatments of the embodiments shown in FIGS. 1-15). The procedure 1400 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motorized window treatment may comprise a bottom bar and may also comprise a motor drive unit for adjusting a present position P_{PRES} of a covering material and the bottom bar. The bottom bar may be connected to a bottom end of the covering material of the motorized window treatment and may comprise a bottom bar module (e.g., the bottom bar modules 490, 640). For example, the control circuit of the bottom bar module may execute the procedure 1300 to collect solar data, such as one or more measurements and/or operational characteristics of a bottom bar module of the bottom bar, at a plurality of intermediate positions of the covering material between a raised position P_{RAISED} and a lowered position P_{LOWERED}. The motor drive unit may comprise a dock (e.g., dock 480) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). The control circuit of the bottom bar module may be configured to communicate with the control circuit of the motor drive unit via a communication link (e.g., via the electrical connections 638, 648) when the bottom bar is docked. Accordingly, the motor drive unit is able to collect solar data from the bottom bar (e.g., from a sensor circuit of the bottom bar). The control circuit of the bottom bar module may be configured to collect and store the solar data in memory of the bottom bar module at a timing interval (e.g., during the procedure 1300 shown in FIG. 22), and then transmit the solar data to the motor drive unit via the communication link when the bottom bar is docked. For example, the control circuit(s) may execute the procedure 1400 periodically at 1410.

At 1412, the control circuit of the bottom bar module may determine if the bottom bar is docked. For example, the control circuit may be configured to determine that the bottom bar is docked by detecting that the motor drive unit is drawing current from an energy storage element of the bottom bar module (e.g., from the energy storage element 642 via the electrical connections 638, 648). Additionally, and/or alternatively, the control circuit may be configured to determine that the bottom bar is docked in response to receiving a message from the control circuit of the motor drive unit. For example, the control circuit of the bottom bar module may be configured to determine that the bottom bar is docked in response to receiving a query message, at 1414, from the motor drive unit via a wired communication link (e.g., via the electrical connections 638, 648 and/or via separate electrical connections on the dock) and/or via a wireless communication link (e.g., where the message may indicate that the bottom bar is docked). At 1416, the control circuit may transmit solar data to the motor drive unit. The procedure 1400 may end at 1418.

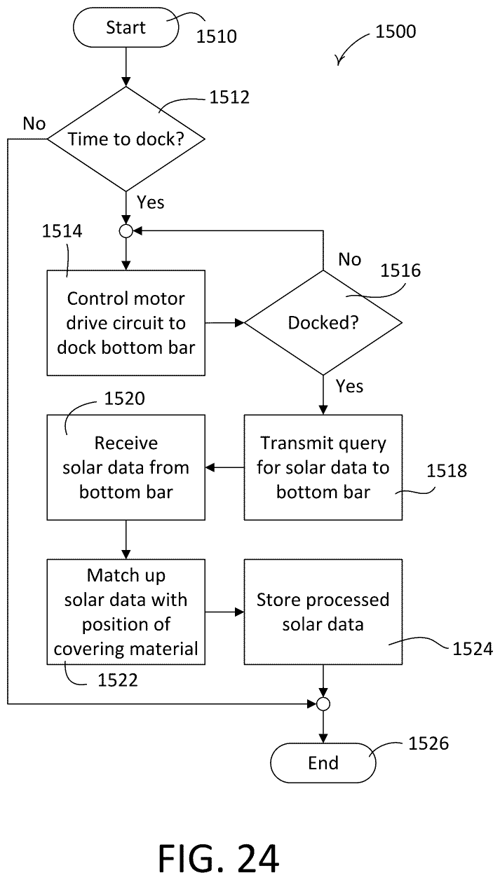

FIG. 24 is an example procedure 1500 for collecting solar data for a motorized window treatment (e.g., the motorized window treatments of the embodiments shown in FIGS. 1-15). The procedure 1500 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motorized window treatment may comprise a covering material and a bottom bar connected to a bottom end of the covering material. The bottom bar may comprise a bottom bar module (e.g., the bottom bar modules 490, 640). The motor drive unit may be configured to control a present position P_{PRES} of the covering material. For example, the control circuit(s) may execute the procedure 1500 to store solar data, such as one or more measurements and/or operational characteristics of the bottom bar module, at a plurality of intermediate positions of the covering material between a raised position P_{RAISED} and a lowered position P_{LOWERED}. The motor drive unit may comprise a dock (e.g., dock 480) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). A control circuit of the bottom bar module may be configured to communicate with a control circuit of the motor drive unit via a communication link (e.g., via the electrical connections 638, 648) when the bottom bar is docked. Accordingly, the motor drive unit is able to collect solar data from the bottom bar (e.g., from a sensor circuit of the bottom bar). The control circuit of the bottom bar module may be configured to collect and store the solar data in memory of the bottom bar module at a timing interval (e.g., during the procedure 1300 shown in FIG. 22), and then transmit the solar data to the control circuit of the motor drive unit via the communication link when the bottom bar is docked (e.g., during the procedure 1400 shown in FIG. 23). For example, the control circuit(s) may execute the procedure 1500 periodically at 1510.

At 1512, the control circuit of the motor drive unit may be configured to determine if the motor drive unit should presently dock the bottom bar. For example, the control circuit may be configured to determine that the bottom bar should be docked when the space in which the motorized window treatment is installed is vacant and the magnitude of a second storage voltage V_{S-B} produced across an energy storage element of the bottom bar is less than (e.g., less than or equal to) a low-charge threshold V_{TH-LC} (e.g., as shown in FIG. 17A). In addition, the control circuit may determine to that the bottom bar should be docked when the magnitude of a first storage voltage V_{S-A} produced across an energy storage element of the motor drive unit is greater than (e.g., greater than or equal to) a high-charge threshold V_{TH-HC} (e.g., as shown in FIG. 17B). Further, the control circuit of the motor may be configured to determine that the bottom bar should be docked in response to the present day of the week and/or the time of the day. When the control circuit determines that the motor drive unit should not presently dock the bottom bar at 1512, the procedure 1500 may end at 1526.

When the control circuit determines that the motor drive unit should presently dock the bottom bar at 1512, the control circuit may control a motor drive circuit to control a motor of the motor drive unit to dock the bottom bar at 1514. For example, the control circuit may control the motor to adjust the present position P_{PRES} of the covering material to the raised position P_{RAISED} at 1514. In addition, the control circuit may control the covering material through a docking movement (e.g., a docking sequence) as the bottom bar nears the dock at 1514 (e.g., as shown in FIG. 18). At 1516, the control circuit may be configured to determine if the bottom bar is docked. For example, the control circuit may be configured to determine if the bottom bar is docked by determining if electrical connections of the dock of the motor drive unit are electrically connected to the electrical connections of the bottom bar module at 1516. When the control circuit determines that the bottom bar is not presently docked at 1516, the control circuit may continue to control the motor to dock the bottom bar at 1514.

When the control circuit of the motor drive unit determines that the bottom bar is docked at 1516, the control circuit may transmit to the bottom bar module a query message that includes a request for solar data at 1518. At 1520, the control circuit of the motor drive unit may receive the solar data from the control circuit of the bottom bar module (e.g., as transmitted in response to the bottom bar module receiving the query message transmitted by the motor drive unit at 1518). At 1522, the control circuit of the motor drive unit may be configured to match up each of the measurements and/or operational characteristics of the solar data with a respective position P_{DATA} of the covering material at the time that the measurement was made. For example, the solar data received from the bottom bar may include timing information (e.g., a time stamp indicating a time at which the respective measurement and/or operational characteristic was recorded) for each of the measurements and/or operational characteristics. The control circuit may be configured to determine the respective position P_{DATA} of the covering material for each of the measurements and/or operational characteristics of the solar data at 1522 by comparing the respective time stamp with the record of movements of the covering material that are stored in the memory of the motor drive unit. Alternatively or additionally, the control circuit of the bottom bar module may be configured to wirelessly communicate the solar data while the covering material is moving (e.g., using a wireless communication link, such as an IR communication link) to the control circuit of the motor drive unit. At 1524, the control circuit of the motor drive unit may store the processed solar data by storing the respective position P_{DATA} of the covering material (e.g., as determined at 1522) along with each of the measurements and/or operational characteristics in the solar data, before the procedure 1500 ends.

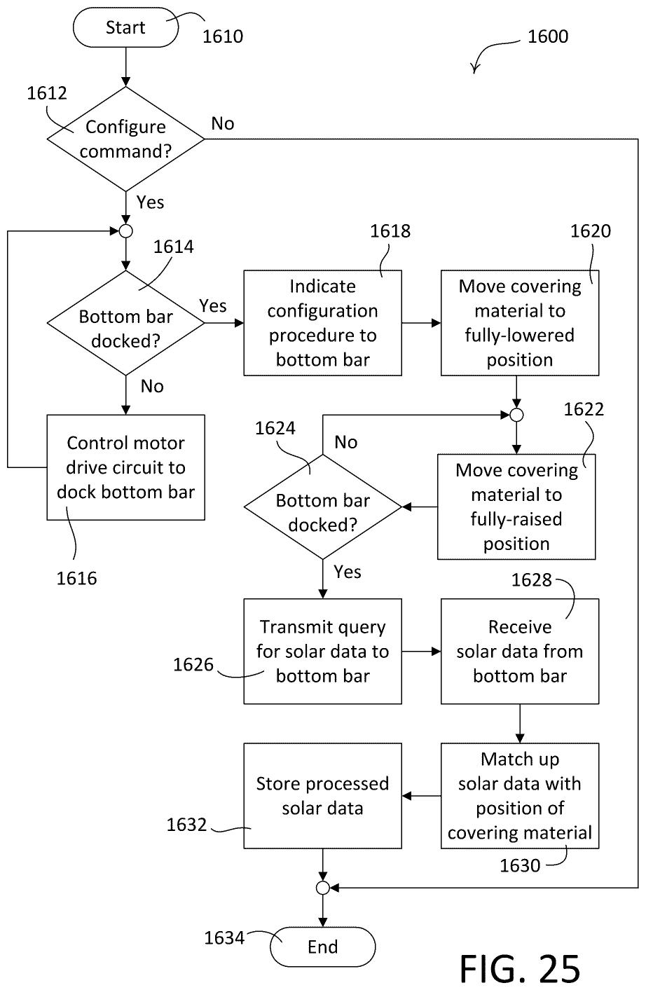

FIG. 25 is an example procedure 1600 for collecting solar data for a motorized window treatment (e.g., the motorized window treatments of the embodiments shown in FIGS. 1-15). The procedure 1600 may be executed by a control circuit of a motor drive unit and/or by a control circuit of a bottom bar module of the motorized window treatment (e.g., the control circuits 620/650 of the motor drive unit 610/bottom bar module 640 shown in FIG. 15 and/or control circuits of the motorized window treatments shown in FIGS. 1-14). The motorized window treatment may comprise a covering material and a bottom bar connected to a bottom end of the covering material. The bottom bar may comprise a bottom bar module (e.g., the bottom bar modules 490, 640). The motor drive unit may be configured to control a present position P_{PRES} of the covering material.

The control circuit(s) may be configured to execute the procedure 1600 as part of a configuration procedure of the motorized window treatment (e.g., at the time of installation of the motorized window treatment). For example, the control circuit(s) may execute the procedure 1600 to store solar data, such as one or more measurements and/or operational characteristics of the bottom bar module, at a plurality of intermediate positions of the covering material between a raised position P_{RAISED} and a lowered position P_{LOWERED}. A control circuit of the bottom bar module may be configured to communicate with a control circuit of the motor drive unit via a communication link (e.g., via the electrical connections 638, 648) when the bottom bar is docked. Accordingly, the motor drive unit is able to collect solar data from the bottom bar (e.g., from a sensor circuit of the bottom bar). The control circuit of the bottom bar module may be configured to collect and store the solar data in memory of the bottom bar module (e.g., at the timing interval T_{TIM} set in the procedure 1200), and then transmit the solar data to the motor drive unit via the communication link when the bottom bar is docked. For example, the control circuit(s) may execute the procedure 1600 periodically at 1610. For example, the control circuit of the motor drive unit may execute the procedure 1600 at 1610 in response to receiving a message from the bottom bar module and/or in response to detecting an actuation of a button of the motor drive unit.

At 1612, the control circuit of the motor drive unit may determine if a command to configure the motor drive unit has been received. For example, the control circuit may receive the command to configure the motor drive unit in a message received via the communication circuit and/or in response to an actuation of a button of the motor drive unit. When the control circuit determines that a command to configure the motor drive unit has not been received at 1612, the procedure 1600 may end at 1634. When the control circuit determines that a command to configure the motor drive unit has been received at 1612, the control circuit may be configured to determine if the bottom bar is docked at 1614. For example, the control circuit may be configured to determine if the bottom bar is docked by determining if electrical connections of the dock of the motor drive unit are electrically connected to the electrical connections of the bottom bar module at 1614. When the control circuit determines that the bottom bar is not presently docked at 1614, the control circuit may control a motor drive circuit to control a motor of the motor drive unit to dock the bottom bar at 1616. For example, the control circuit may control the motor to adjust the present position P_{PRES} of the covering material to the raised position P_{RAISED} at 1616. In addition, the control circuit may control the covering material through a docking movement (e.g., a docking sequence) as the bottom bar nears the dock at 1616 (e.g., as shown in FIG. 18).

When the control circuit of the motor drive unit determines that the bottom bar is presently docked at 1614, the control circuit may indicate to the bottom bar module that the control circuit is going to be executing the configuration procedure at 1618. For example, the control circuit may transmit a message to the bottom bar module indicating the execution of the configuration procedure. At 1620, the control circuit may initialize the present position P_{PRES} of the covering material for the configuration procedure by adjusting the present position P_{PRES} of the covering material to the lowered position P_{LOWERED}. At 1622, the control circuit may control the motor drive circuit to adjust the present position P_{PRES} of the covering material from the raised position P_{RAISED} to the lowered position P_{LOWERED} so that the bottom bar module is able to record one or more measurements and/or operational characteristics of the bottom bar at the raised position P_{RAISED}, the lowered position P_{LOWERED}, and/or multiple intermediate positions between the raised position P_{RAISED} and the lowered position P_{LOWERED}. For example, the bottom bar module may be configured to record the one or more measurements and/or operational characteristics of the bottom bar in response to receiving the indication of the configuration procedure transmitted by the control circuit of the motor dive unit at 1618.

At 1624, the control circuit of the motor drive unit may determine if the bottom bar is docked. When the bottom bar is not docked at 1624, the control circuit may control the motor drive circuit at 1622 to adjust the present position P_{PRES} of the covering material from the lowered position P_{LOWERED} to the raised position P_{RAISED}, for example, to dock the bottom bar. In some examples, the bottom bar module may also record one or more measurements and/or operational characteristics of the bottom bar multiple intermediate positions between the lowered position P_{LOWERED} and the raised position P_{RAISED} while the control circuit is adjusting the present position P_{PRES} of the covering material from the lowered position P_{LOWERED} to the raised position P_{RAISED} at 1622.

When the control circuit determines that the bottom bar is docked at 1624, the control circuit may transmit to the bottom bar module a query message that includes a request for solar data at 1626. At 1628, the control circuit of the motor drive unit may receive the solar data from the bottom bar module (e.g., as transmitted in response to the bottom bar module receiving the query message transmitted by the motor drive unit at 1626). At 1630, the control circuit of the motor drive unit may be configured to match up each of the measurements and/or operational characteristics of the solar data with a respective position P_{DATA} of the covering material at the time that the measurement was made. For example, the solar data received from the bottom bar may include timing information (e.g., a time stamp indicating a time at which the respective measurement and/or operational characteristic was recorded) for each of the measurements and/or operational characteristics. The control circuit may be configured to determine the respective position P_{DATA} of the covering material for each of the measurements and/or operational characteristics of the solar data at 1630 by comparing the respective time stamp with the record of movements of the covering material that are stored in the memory of the motor drive unit. At 1632, the control circuit of the motor drive unit may store the processed solar data by storing the respective position P_{DATA} of the covering material (e.g., as determined at 1630) along with each of the measurements and/or operational characteristics in the solar data, before the procedure 1600 ends at 1624.

One will appreciate that while the procedures of FIGS. 16-25 may be described with respect to roller shades, other window treatment configurations are applicable to these procedures including roman shades, venetian blinds, outdoor blinds, etc.

What is claimed is:

1. A motorized treatment configured to be mounted to a structure, the motorized treatment comprising:
a treatment assembly comprising a covering material that extends from a top end to a bottom end and is operable between a raised position and a lowered position, the treatment assembly further comprising a bottom bar attached to the bottom end of the covering material, the bottom bar comprising a first energy storage element;
a motor drive unit comprising a motor configured to adjust the covering material between the raised position and the lowered position;
a second energy storage element configured to power the motor drive unit; and
a dock configured to be electrically coupled to the second energy storage element;
wherein the bottom bar is configured to be located adjacent to the dock when the covering material is in the raised position, such that the first energy storage element of the bottom bar is configured to charge through the dock from the second energy storage element.

2. The motorized treatment of claim 1, wherein the motor drive unit comprises an enclosure and the second energy storage element is contained within the enclosure of the motor drive unit.

3. The motorized treatment of claim 1, wherein the dock comprises a first pair of electrical contacts and the bottom bar comprises a second pair of electrical contacts, the first pair of electrical contacts configured to be electrically connected to the second pair of electrical contacts when the covering material is in the raised position.

4. The motorized treatment of claim 1, further comprising at least one control circuit configured to determine to charge the first energy storage element, and to control the motor to adjust the covering material to the raised position to locate the bottom bar adjacent to the dock based on the determination to charge the first energy storage element.

5. (canceled)

6. The motorized treatment of claim 4, wherein the at least one control circuit is further configured to determine to charge the first energy storage element based on a predetermined schedule.

7. (canceled)

8. The motorized treatment of claim 6, wherein the bottom bar comprises a first wireless communication circuit, wherein the motor drive unit comprises a second wireless communication circuit, and wherein the bottom bar is configured to send a message via the first wireless communication circuit to the second wireless communication circuit based on the predetermined schedule, the message comprising an indication of a storage voltage of the first energy storage element.

9. (canceled)

10. The motorized treatment of claim 8, wherein the at least one control circuit is configured to adjust the schedule based on the message.

11. The motorized treatment of claim 4, wherein the at least one control circuit is further configured to determine to charge the first energy storage element when a magnitude of a storage voltage of the first energy storage element is less than a threshold.

12. The motorized treatment of claim 11, wherein the bottom bar comprises a first wireless communication circuit, wherein motor drive unit further comprises a second wireless communication circuit, and wherein the bottom bar is configured to send a message via the first wireless communication circuit to the second wireless communication circuit, the message indicating that the magnitude of the storage voltage of the first energy storage element is less than the threshold.

13. (canceled)

14. The motorized treatment of claim 4, wherein the at least one control circuit is configured to determine to charge the first energy storage element from the second energy storage element comprises the at least one control circuit configured to determine to charge the first energy storage element from the second energy storage element when a magnitude of a storage voltage stored in the second energy storage element is greater than a magnitude of energy stored in the first energy storage element.

15. The motorized treatment of claim 4, wherein the at least one control circuit is further configured to determine to charge the first energy storage element when a magnitude of a storage voltage of the second energy storage element is greater than a threshold.

16. The motorized treatment of claim 4, further comprising a sensor circuit, the sensor circuit configured to measure a light level, the at least one control circuit further configured to receive the measured light level via a received message that indicates the measured light level;
wherein the least one control circuit is further configured to determine to control the motor to adjust the covering material to the raised position to locate the bottom bar adjacent to the dock based on the message indicating the measured light level.

17. (canceled)

18. The motorized treatment of claim 16, wherein the at least one control circuit is further configured to control the motor to adjust a present position of the covering material to the raised position to locate the bottom bar adjacent to a base portion of the dock based on the measured light level being less than a threshold light level.

19. The motorized treatment of claim 4, wherein the at least one control circuit is further configured to determine whether sunlight is shining on a façade on which the motorized treatment is installed.

20. The motorized treatment of claim 19, wherein the at least one control circuit is further configured to determine to charge the first energy storage element based on a determination that sunlight is not shining on the façade on which the motorized treatment is installed.

21. The motorized treatment of claim 19, wherein the at least one control circuit is further configured to determine, based on a time of day, that sunlight is not shining on the façade on which the motorized treatment is installed.

22. (canceled)

23. (canceled)

24. The motorized treatment of claim 4, further comprising a communication circuit, and wherein the at least one control circuit is further configured to receive weather information via the communication circuit;
wherein the at least one control circuit is further configured to determine to charge the first energy storage element based on the weather information indicating that it is cloudy.

25. (canceled)

26. (canceled)

27. (canceled)

28. (canceled)

29. The motorized treatment of claim 4, wherein the at least one control circuit comprises a first control circuit and a second control circuit, wherein the motor drive unit or the dock comprises the first control circuit, wherein the motor drive unit or the dock comprises a first communication circuit configured to communication with the first control circuit, and wherein the bottom bar comprises the second control circuit, a second communication circuit configured to communicate with the second control circuit, and a sensor configured to detect an occupancy condition or a vacancy condition.

30. The motorized treatment of claim 29, wherein the second communication circuit is configured to transmit, to the first communication circuit, an indication of the occupancy condition or the vacancy condition, and wherein the first control circuit is configured to determine to charge the first energy storage element based on the indication of the occupancy condition or the vacancy condition.

31. (canceled)

32. The motorized treatment of claim 1, further comprising at least one control circuit configured to determine to position the bottom bar adjacent to the dock when a space in which the motorized window treatment is located is vacant.

33. (canceled)

34. The motorized treatment of claim 1, wherein further comprising at least one control circuit configured to determine to position the bottom bar adjacent to the dock when a magnitude of a storage voltage of the first energy storage element of the bottom bar is less than a first threshold and a space in which the motorized treatment is located is vacant.

35. The motorized treatment of claim 34, wherein the at least one control circuit is further configured to determine to position the bottom bar adjacent to the dock when a magnitude of a storage voltage of the second energy storage element is greater than a second threshold.

36. (canceled)

37. The motorized treatment of claim 1, further comprising at least one control circuit that is configured to:
determine whether the sun is shining on a façade on which the motorized treatment is installed; and
position the bottom bar adjacent to the dock based on a determination that sun is not shining on the façade on which the motorized treatment is installed.

38. (canceled)

39. (canceled)

40. (canceled)

41. (canceled)

42. The motorized treatment of claim 1, further comprising at least one control circuit that is configured to:
receive an indication of a light level from a sensor circuit; and
determine whether to position the bottom bar adjacent to the dock based on the indication of the light level.

43. The motorized treatment of claim 42, wherein the at least one control circuit is further configured to position the bottom bar adjacent to the dock based on the indication of the light level being less than a threshold.

44. The motorized treatment of claim 42, wherein the bottom bar comprises the sensor circuit and a communication circuit; and
wherein the communication circuit is configured to send the indication of the light level to the at least one control circuit.

45. The motorized treatment of claim 44, wherein the indication of the light level comprises an indication of a nighttime period, and wherein the at least one control circuit is further configured to determine not to position the bottom bar adjacent to the dock during the nighttime period in a privacy mode.

46.-109. (canceled)
